(19) United States
(12) Patent Application Publication
(10) Pub. No.: US 2025/0261228 A1
(43) Pub. Date: Aug. 14, 2025

(54) METHOD AND APPARATUS FOR DETERMINING PATHLOSS REFERENCE SIGNAL IN A WIRELESS COMMUNICATION SYSTEM

(71) Applicant: SAMSUNG ELECTRONICS CO., LTD., Suwon-si (KR)

(72) Inventors: Youngrok JANG, Suwon-si (KR); Ameha Tsegaye ABEBE, Suwon-si (KR); Seongmok LIM, Suwon-si (KR); Hyoungju JI, Suwon-si (KR); Kyungjun CHOI, Suwon-si (KR)

(21) Appl. No.: 19/051,521

(22) Filed: Feb. 12, 2025

(30) Foreign Application Priority Data
Feb. 14, 2024 (KR) 10-2024-0021149

(51) Int. Cl. H04W 74/00; H04W 74/0833

(52) U.S. Cl. CPC H04W 74/006; H04W 74/0833

(57) ABSTRACT

The disclosure relates to a 5G or 6G communication system for supporting a higher data transmission rate. The present disclosure relates to a method for determining a real number based on path loss in a wireless communication system and an apparatus capable of performing the same. The method provides receiving, from a first base station, downlink control information (DCI) indicating an application of a pathloss (PL) offset; and transmitting, to a second base station, a physical random access channel (PRACH) based on the DCI, wherein the second base station includes an uplink (UL) transmission and reception point (TRP).

### CROSS-REFERENCE TO RELATED APPLICATION

This application is based on and claims priority under 35 U.S.C. § 119 to Korean Patent Application No. 10-2024-0021149, filed on Feb. 14, 2024, in the Korean Intellectual Property Office, the disclosure of which is herein incorporated by reference in its entirety.

### BACKGROUND

### 1. Field

The disclosure relates to an operation of a terminal and a base station in a wireless communication system. Specifically, the disclosure relates to a method of determining a pathloss amount reference signal in network cooperative communication, and an apparatus capable of performing same.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Embodiments set forth herein are to provide a device and a method capable of effectively providing services in a mobile communication system.

According to an embodiment of the disclosure, a method performed by a terminal in a wireless communication system may include reporting a first message including information on a terminal capability to a base station, receiving higher layer signaling based on the terminal capability from the base station, transmitting an uplink signal to the base station, based on the higher layer signaling, and receiving a second message for indicating update of information on a pathloss from the base station, wherein the terminal capability is related to a transmission power parameter or a unified TCI state of the uplink signal.

Embodiments set forth herein provide a device and a method capable of effectively providing services in a mobile communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a basic structure of a time-frequency domain in a wireless communication system according to an embodiment of the disclosure;

FIG. 2 illustrates an example of a structure of a frame, a subframe, and a slot in a wireless communication system according to an embodiment of the disclosure;

FIG. 3 illustrates an example of a bandwidth part configuration in a wireless communication system according to an embodiment of the disclosure;

FIG. 4 illustrates an example of radio protocol structures of a base station and a UE in single cell, carrier aggregation, and dual connectivity situations in a wireless communication system according to an embodiment of the disclosure;

FIG. 5 illustrates an example of a beam application time which may be considered in a case where a unified TCI scheme is used in a wireless communication system according to an embodiment of the disclosure;

FIG. 6 illustrates an example of an MAC-CE structure for activation and indication of a joint TCI state or a separate DL or UL TCI state in a wireless communication system according to an embodiment of the disclosure;

FIG. 7 illustrates an example of a control resource set configuration of a downlink control channel in a wireless communication system according to an embodiment of the disclosure;

FIG. 8 illustrates an example of a downlink control channel in a wireless communication system according to an embodiment of the disclosure;

FIG. 9 illustrates an example of a process for beam configuration and activation with regard to a PDSCH in a wireless communication system according to an embodiment of the disclosure;

FIG. 10 illustrates an example of an antenna port configuration and resource allocation for cooperative communication in a wireless communication system according to an embodiment of the disclosure;

FIG. 11 illustrates an example of a DCI configuration for cooperative communication in a wireless communication system according to an embodiment of the disclosure;

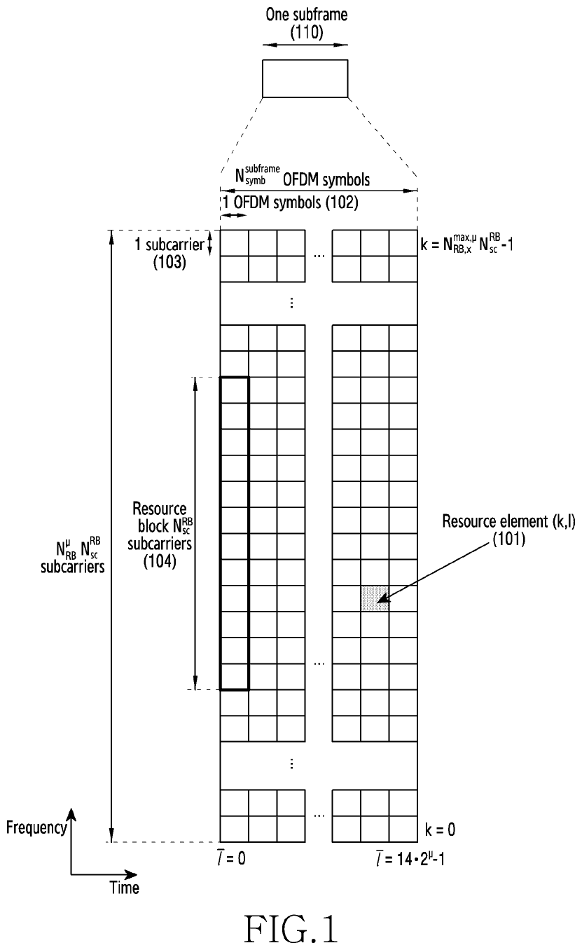

FIG. 1 illustrates an example of enhanced PDSCH TCI state activation/deactivation MAC-CE structure in a wireless communication system according to an embodiment of the disclosure;

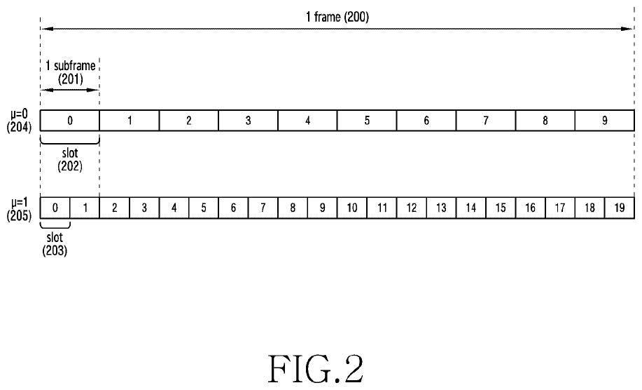

FIG. 2 illustrates an example of an operation of a terminal and a base station operating as multiple TRPs including a TRP supporting only an uplink reception function according to an embodiment of the disclosure;

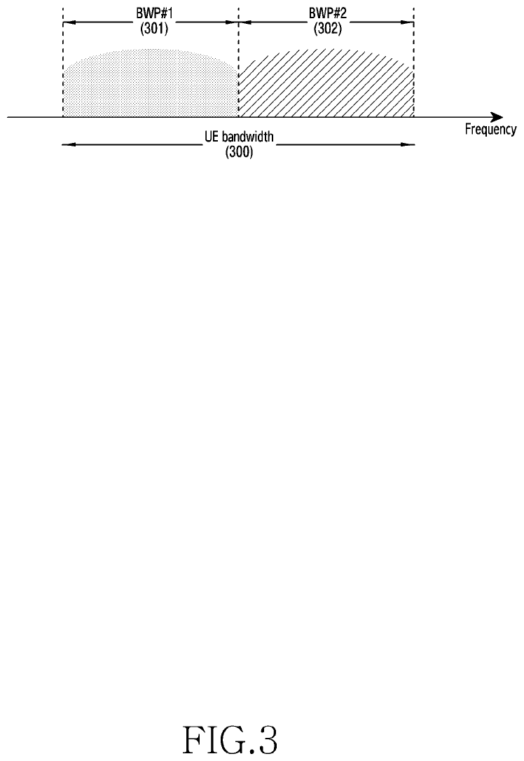

FIG. 3 illustrates an example of a method of calculating and updating a pathloss amount difference value according to an embodiment of the disclosure;

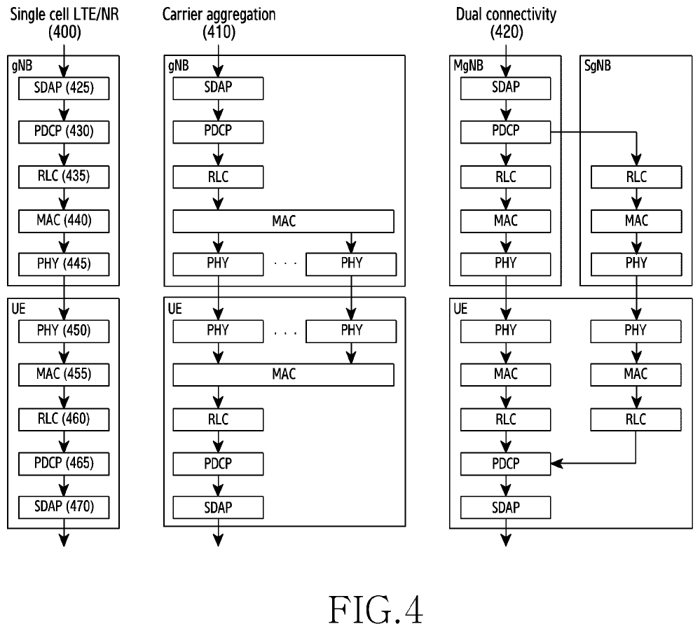

FIG. 4 illustrates an example of a method of calculating and updating a pathloss amount difference value according to an embodiment of the disclosure;

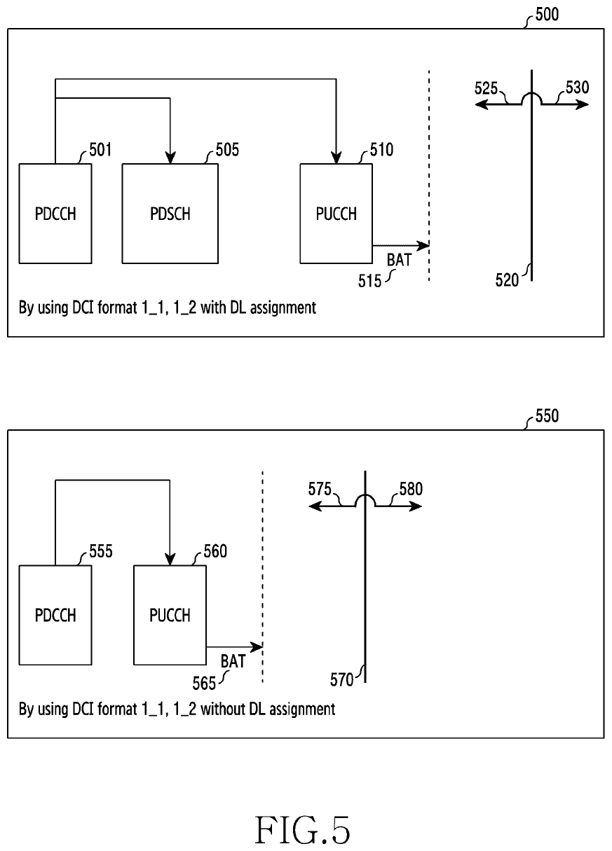

FIG. 5 illustrates an example of an operation of a terminal for controlling uplink transmission power according to an embodiment of the disclosure;

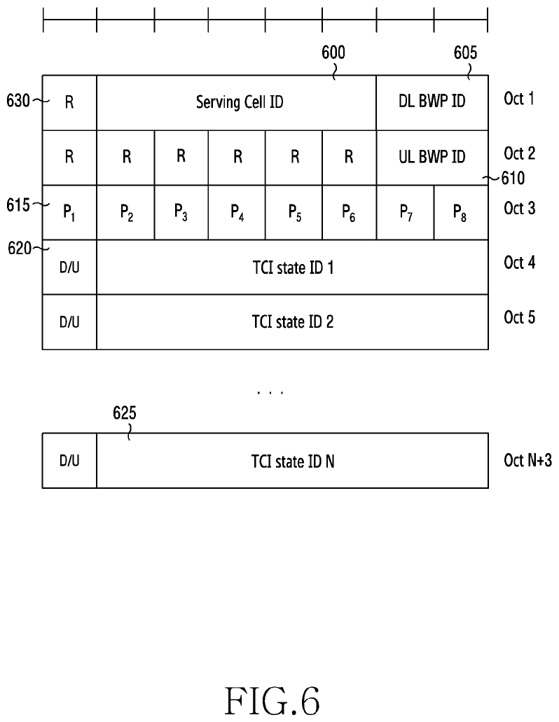

FIG. 6 illustrates an example of an operation of a base station for controlling uplink transmission power according to an embodiment of the disclosure;

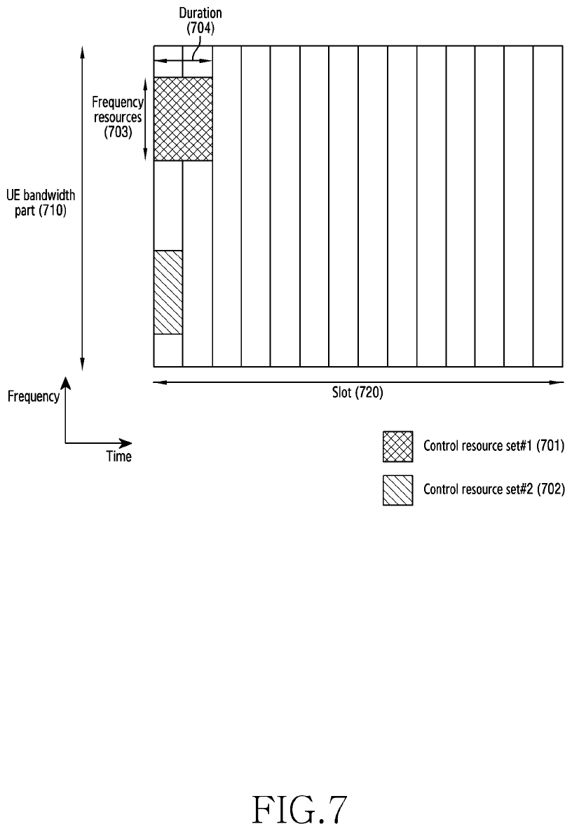

FIG. 7 illustrates an example of an operation of a terminal for determining an uplink transmission method according to an embodiment of the disclosure;

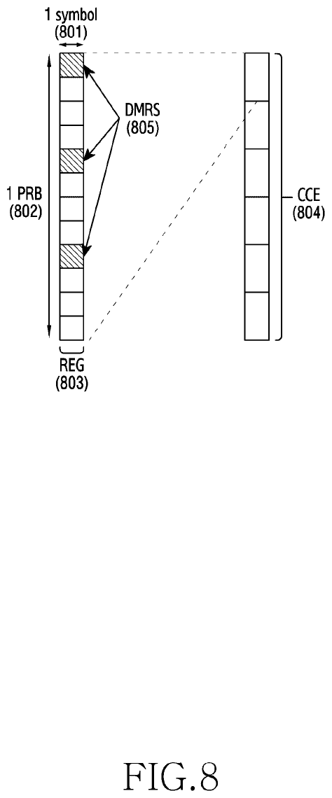

FIG. 8 illustrates an example of an operation of a base station for determining an uplink transmission method according to an embodiment of the disclosure;

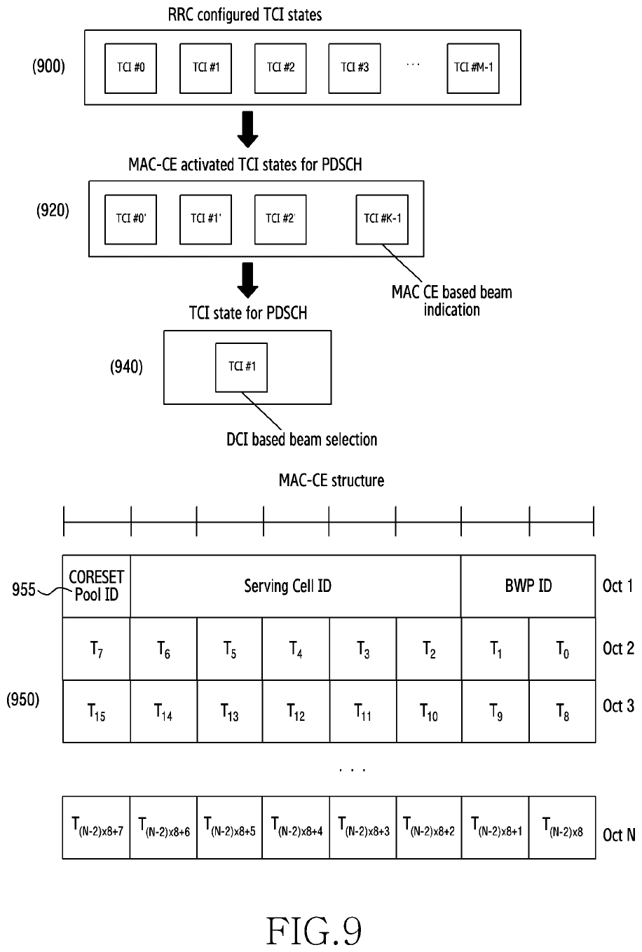

FIG. 9 illustrates an example of an operation of a terminal for selecting a pathloss amount reference signal at the time of transmission of a PRACH according to an embodiment of the disclosure;

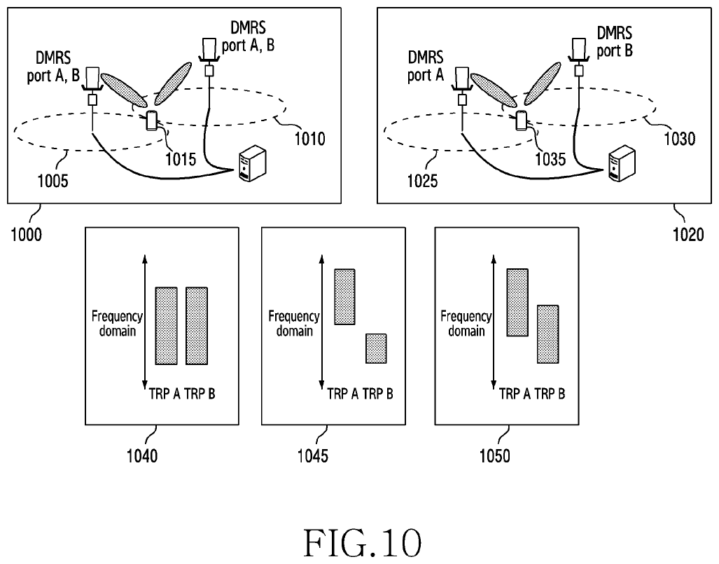

FIG. 10 illustrates an example of an operation of a base station for selecting a pathloss amount reference signal at the time of PRACH transmission according to an embodiment of the disclosure;

FIG. 22 illustrates an example of a UE in a wireless communication system according to an embodiment of the disclosure; and

FIG. 23 illustrates an example of a base station in a wireless communication system according to an embodiment of the disclosure.

### DETAILED DESCRIPTION

FIGS. 1 through 23, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure. The contents of the disclosure may be applied to FDD and TDD systems.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more CPUs within a device or a security multimedia card. Furthermore, the “unit” in the embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, various transmission/reception technologies including a further enhanced multi-input multi-output (MIMO) transmission technique may be required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery lifetime such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also requires a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

### [NR Time-Frequency Resources]

Hereinafter, a frame structure of a 5G system will be described in more detail with reference to the accompanying drawings.

FIG. 1 illustrates an example of a time-frequency domain, which is a radio resource domain used to transmit data or control channels, in a 5G system.

The horizontal axis in FIG. 1 represents a time domain, and the vertical axis in FIG. 1 represents a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain, N_{SC}^{RB} (for example, 12) consecutive REs may constitute one resource block (RB) 104. In the time domain, one subframe 110 may include multiple OFDM symbols 102. For example, the length of one subframe may be 1 ms.

FIG. 2 illustrates an example of a structure of a frame, a subframe, and a slot in a wireless communication system according to an embodiment of the disclosure.

FIG. 2 illustrates an example of a structure of a frame 200, a subframe 201, and a slot 202. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbols per one slot N_{symb}^{slot}=14). One subframe 201 may include one or multiple slots 202 and 203, and the number of slots 202 and 203 per one subframe 201 may vary depending on configuration values 204 or 205 for the subcarrier spacing. The example of FIG. 2 shows the case of =0 (204) and the case of =1 (205) as a configuration value for a subcarrier spacing. In the case of =0 (204), one subframe 201 may include one slot 202, and in the case of μ=1 (205), one subframe 201 may include two slots 203. That is, the number of slots per one subframe Nₛₗₒₜ^{subframe,μ} may differ depending on the subcarrier spacing configuration value μ, and the number of slots per one frame Nₛₗₒₜ^{frame,μ}, may differ accordingly. Nₛₗₒₜ^{subframe,μ}, and Nₛₗₒₜ^{subframe,μ}, may be defined according to each subcarrier spacing configuration μ as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, a bandwidth part (BWP) configuration in a 5G communication system will be described in detail with reference to the accompanying drawings.

FIG. 3 illustrates an example of a bandwidth part configuration in a wireless communication system according to an embodiment of the disclosure.

FIG. 3 illustrates an example in which a UE bandwidth 300 is configured to include two bandwidth parts, that is, bandwidth part #1 (BWP #1) 301 and bandwidth part #2 (BWP #2) 302. A base station may configure one or multiple bandwidth parts for a UE, and may configure the following pieces of information with regard to each bandwidth part as given in Table 2 below.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, n5}, |

(subcarrier spacing)

| | |
|---|---|
| cyclicPrefix | ENUMERATED { extended } |

(cyclic prefix)
}

Obviously, the above example is not limiting, and various parameters related to the bandwidth part may be configured for the UE, in addition to the above configuration information. The base station may transfer the configuration information in Table 2 to the UE through upper layer signaling (for example, radio resource control (RRC) message). One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI).

According to an embodiment, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered identity (ID) 0. The base station may notify (transmit or deliver) the UE of configuration information, such as frequency allocation information regarding control resource set #0, time allocation information, and numerology, through the MIB. In addition, the base station may notify the UE of configuration information regarding the monitoring cycle and occasion with regard to control resource set #0, that is, configuration information regarding search space #0, through the MIB. The UE may consider that a frequency domain configured by CORESET #0 acquired from the MIB is an initial bandwidth part for initial access. The ID of the initial bandwidth part may be considered to be 0.

Obviously, the above embodiment is not limiting, and the bandwidth part configuration supported by the 5G communication system, may be used for various purposes.

According to an embodiment, if the bandwidth supported by the UE is smaller than the system bandwidth, this may be supported through the bandwidth part configuration. For example, the base station may configure the frequency location (configuration information 2) of the bandwidth part for the UE, so that the UE can transmit/receive data at a specific frequency location within the system bandwidth.

In addition, according to an embodiment, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

In addition, according to an embodiment, the base station may configure bandwidth parts having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

In connection with the bandwidth part configuring method, UEs, before being RRC-connected, may receive configuration information regarding the initial bandwidth part through an MIB in the initial access step. To be more specific, a UE may have a control region (for example, CORESET) configured for a downlink control channel which may be used to transmit downlink control information (DCI) for scheduling a system information block (SIB) from the MIB of a physical broadcast channel (PBCH). The bandwidth of the control resource set configured by the MIB may be considered (or configured) as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### [Bandwidth Part (BWP) Change]

If a UE has one or more bandwidth parts configured therefor, the base station may indicate, to the UE, to change (or switch or transition) the bandwidth parts by using a bandwidth part indicator field inside DCI. For example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside the received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (T_{BWP}) required during a bandwidth part change are specified in standards, and may be defined as given in Table 3 below, for example.

TABLE 3

| | |
|---|---|
| NR Slot | BWP switch delay T_{BWP} (slots) |

| μ | length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
^{Note 2}
If the BWP switch involves changing of SCS, the BWP switch delay is determined by the larger one between the SCS before BWP switch and the SCS after BWP switch.

The requirements for the bandwidth part change delay time may support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}, and may transmit/receive a data channel scheduled by the corresponding DCI in the newly changed bandwidth part. If the base station wants to schedule a data channel by using the new bandwidth part, the base station may determine time domain resource allocation regarding the data channel, based on the UE's bandwidth part change delay time (T_{BWP}). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI indicating a bandwidth part change may indicate a slot offset (K0 or K2) value smaller than the bandwidth part change delay time (T_{BWP}).

If the UE has received DCI (for example, DCI format 11 or 0_1) indicating a bandwidth part change, the UE may perform no transmission or reception during a time interval from the third symbol of the slot used to receive a PDCCH including the corresponding DCI to the start point of the slot indicated by a slot offset (for example, K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K−1).

### [Regarding CA/DC]

FIG. 4 illustrates an example of radio protocol structures of a base station and a UE in single cell, carrier aggregation, and dual connectivity situations according to an embodiment of the disclosure.

Referring to FIG. 4, a radio protocol of a next-generation mobile communication system includes an NR service data adaptation protocol (SDAP) 425 or 470, an NR packet data convergence protocol (PDCP) 430 or 465, an NR radio link control (RLC) 435 or 460, and an NR medium access controls (MAC) 440 or 455, on each of UE and NR base station sides.

The main functions of the NR SDAP 425 or 470 may include some of functions below:
Transfer of user plane data;
Mapping between a QoS flow and a DRB for both DL and UL;
Marking QoS flow ID in both DL and UL packets; and/or
Reflective QoS flow to DRB mapping for the UL SDAP PDUs.

With regard to the SDAP layer device, whether to use the header of the SDAP layer device or whether to use functions of the SDAP layer device may be configured for the UE through an RRC message according to PDCP layer devices or according to bearers or according to logical channels. If an SDAP header is configured, the non-access stratum (NAS) quality of service (QoS) reflection configuration 1-bit indicator (NAS reflective QoS) of the SDAP header and the access stratum (AS) QoS reflection configuration 1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 430 or 465 may include some of functions below:
Header compression and decompression: ROHC only;
Transfer of user data;
In-sequence delivery of upper layer PDUs;
Out-of-sequence delivery of upper layer PDUs;
PDCP PDU reordering for reception;
Duplicate detection of lower layer SDUs;
Retransmission of PDCP SDUs;
Ciphering and deciphering; and/or
Timer-based SDU discard in uplink.

The above-mentioned reordering of the NR PDCP device refers to a function of reordering PDCP PDUs received from a lower layer in an order based on the PDCP sequence number (SN), and may include a function of transferring data to an upper layer in the reordered sequence. Alternatively, the reordering of the NR PDCP device may include a function of instantly transferring data without considering the order, may include a function of recording PDCP PDUs lost as a result of reordering, may include a function of reporting the state of the lost PDCP PDUs to the transmitting side, and may include a function of requesting retransmission of the lost PDCP PDUs.

The main functions of the NR RLC 435 or 460 may include some of functions below:
Transfer of upper layer PDUs;
In-sequence delivery of upper layer PDUs;
Out-of-sequence delivery of upper layer PDUs;
Error Correction through ARQ;
Concatenation, segmentation and reassembly of RLC SDUs;
Re-segmentation of RLC data PDUs;
Reordering of RLC data PDUs;
Duplicate detection;
Protocol error detection;
RLC SDU discard; and/or
RLC re-establishment.

Among the above-described functions, the in-sequence delivery of the NR RLC device may refer to a function of delivering RLC SDUs, received from the lower layer, to the upper layer in sequence. The in-sequence delivery of the NR RLC device may include at least one of a function of, if one original RLC SDU is segmented into multiple RLC SDUs and the segmented RLC SDUs are received, reassembling the RLC SDUs and delivering the reassembled RLC SDUs, a function of reordering the received RLC PDUs with reference to the RLC sequence number (SN) or PDCP sequence number (SN), a function of recording RLC PDUs lost as a result of reordering, a function of reporting the state of the lost RLC PDUs to the transmitting side, and a function of requesting retransmission of the lost RLC PDUs. The in-sequence delivery of the NR RLC device may include a function of, if there is a lost RLC SDU, successively delivering only RLC SDUs before the lost RLC SDU to the upper layer, and may include a function of, if a predetermined timer has expired although there is a lost RLC SDU, successively delivering all RLC SDUs received before the timer was started to the upper layer. Alternatively, the in-sequence delivery of the NR RLC device may include a function of, if a predetermined timer has expired although there is a lost RLC SDU, successively delivering all currently received RLC SDUs to the upper layer. In addition, the in-sequence delivery of the NR RLC device may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The out-of-sequence delivery function of the NR RLC device may refer to a function of instantly delivering RLC SDUs received from the lower layer to the upper layer regardless of the order, may include a function of reassembling and delivering multiple RLC SDUs received, into which one original RLC SDU has been segmented, and may include a function of storing the RLC SN or PDCP SN of received RLC PDUs, and recording RLC PDUs lost as a result of reordering.

The NR MAC 440 or 455 may be connected to multiple NR RLC layer devices configured in one UE, and the main functions of the NR MAC may include some of functions below:
Mapping between logical channels and transport channels;
Multiplexing/demultiplexing of MAC SDUs;
Scheduling information reporting;
Error correction through HARQ;
Priority handling between logical channels of one UE;
Priority handling between UEs by means of dynamic scheduling;
MBMS service identification;
Transport format selection; and/or
Padding.

An NR PHY layer 445 or 450 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

The detailed structure of the radio protocol structure may be variously changed according to the carrier (or cell) operating scheme. For example, in case that the base station transmits data to the UE, based on a single carrier (or cell), the base station and the UE may use a protocol structure having a single structure with regard to each layer, such as 400. On the other hand, in case that the base station transmits data to the UE, based on carrier aggregation (CA) which uses multiple carriers in a single TRP, the base station and the UE may use a protocol structure which has a single structure up to the RLC, but multiplexes the PHY layer through a MAC layer, such as 410. As another example, in case that the base station transmits data to the UE, based on dual connectivity (DC) which uses multiple carriers in multiple TRPs, the base station and the UE may use a protocol structure which has a single structure up to the RLC, but multiplexes the PHY layer through a MAC layer, such as 420.

### [Unified TCI State]

Hereinafter, a single TCI state indication and activation method based on a unified TCI scheme is described. The unified TCI scheme may mean a scheme of integrating and managing, through a TCI state, a transmission and/or reception beam management scheme, which has been classified as a TCI state scheme used in downlink reception of a UE and a spatial relation info scheme used in uplink transmission in conventional Rel-15 and 16. Therefore, in a case where a UE receives an indication from a base station, based on the unified TCI scheme, the UE may perform beam management even for uplink transmission by using a TCI state. If the higher layer signaling TCI-State having the higher layer signaling tci-stateld-r17 is configured for a UE by a base station, the UE may perform an operation based on the unified TCI scheme by using the TCI-State. TCI-State may exist in two types including a joint TCI state and a separate TCI state.

The first type is a joint TCI state, and all TCI states to be applied to uplink transmission and downlink reception may be indicated to a UE by a base station through one value of TCI-State. If joint TCI state-based TCI-state is indicated to the UE, a parameter to be used in downlink channel estimation may be indicated to the UE by the base station by using an RS corresponding to qcl-Type1 in the joint TCI state-based TCI-state, and a parameter to be used as a downlink reception beam or reception filter may be indicated thereto by using an RS corresponding to qcl-Type2. If joint TCI state-based TCI-state is indicated to the UE by the base station, a parameter to be used as an uplink transmission beam or transmission filter may be indicated to the UE by the base station by using an RS corresponding to qcl-Type2 in joint DL/UL TCI state-based TCI-state. If a joint TCI state is indicated to the UE by the base station, the UE may apply the same beam to uplink transmission and downlink reception.

The second type is a separate TCI state, and a UL TCI state to be applied to uplink transmission and a DL TCI state to be applied to downlink reception may be individually indicated to a UE by a base station. If a UL TCI state is indicated to the UE by the base station, a parameter to be used as an uplink transmission beam or transmission filter may be indicated to the UE by the base station by using a reference RS or a source RS configured in the indicated UL TCI state. If a DL TCI state is indicated to the UE by the base station, a parameter to be used in downlink channel estimation may be indicated to the UE by the base station by using an RS corresponding to qcl-Type1 configured in the DL TCI state, and a parameter to be used as a downlink reception beam or reception filter may be indicated thereto by using an RS corresponding to qcl-Type2.

If a DL TCI state and a UL TCI state are indicated together to the UE, a parameter to be used as an uplink transmission beam or transmission filter may be indicated to the UE by the base station by using a reference RS or a source RS configured in the UL TCI state. Then, a parameter to be used in downlink channel estimation may be indicated to the UE by the base station by using an RS corresponding to qcl-Type1 configured in the DL TCI state, and a parameter to be used as a downlink reception beam or reception filter may be indicated thereto by using an RS corresponding to qcl-Type2. If the reference RSs or source RSs configured in the DL TCI state and UL TCI state indicated to the UE are different from each other, the UE may apply individual beams to uplink transmission and downlink reception, based on the UL TCI state and DL TCI state indicated by the base station.

A maximum of 128 values of joint TCI state may be configured for a UE by a base station through higher layer signaling by each particular bandwidth part in a particular cell. A maximum of 64 or 128 DL TCI states, each of which is one among separate TCI states, may be configured for the UE by the base station through higher layer signaling, based on a UE capability report by each particular bandwidth part in a particular cell. The UE may use the same higher layer signaling structure for a DL TCI state among separate TCI states and a joint TCI state. For example, if 128 joint TCI states are configured and 64 DL TCI states, each of which is one among separate TCI states, are configured, the 64 DL TCI states may be included in the 128 joint TCI states.

A maximum of 32 or 64 UL TCI states, each of which is one among separate TCI states, may be configured for the UE through higher layer signaling, based on a UE capability report by each particular bandwidth part in a particular cell. A UL TCI state among separate TCI states and a joint TCI state may also use the same higher layer signaling structure like the relation between a DL TCI state among separate TCI states and a joint TCI state, or a UL TCI state among separate TCI states may also use a higher layer signaling structure different from that of a joint TCI state and a DL TCI state among separate TCI states.

As described above, using different or identical higher layer signaling structures may be defined in a specification. Alternatively, using different or identical higher layer signaling structures may be distinguished through another higher layer signaling that is configured by the base station, based on a UE capability report including information on a usage scheme supportable by the UE among two types of usage schemes.

A transmission and/or reception beam-related indication may be received by the UE in a unified TCI scheme by using one scheme among a joint TCI state and a separate TCI state configured by the base station. Whether to use one of a joint TCI state and a separate TCI state may be configured for the UE by the base station through higher layer signaling.

The UE may receive a transmission and/or reception beam-related indication through higher layer signaling by using one scheme selected from among a joint TCI state and a separate TCI state, and a method of indicating a transmission and/or reception beam by the base station may be classified as two types of methods including a MAC-CE-based indication method and a MAC-CE-based activation and DCI-based indication method.

In a case where the UE receives a transmission and/or reception beam-related indication through higher layer signaling by using a joint TCI state scheme, the UE may receive a MAC-CE indicating a joint TCI state from the base station to perform a transmission and/or reception beam application operation. The base station may schedule reception of a PDSCH including the MAC-CE indicating the joint TCI state to the UE through a PDCCH. If a MAC-CE includes one joint TCI state, the UE may determine an uplink transmission beam or transmission filter and a downlink reception beam or reception filter by using the indicated joint TCI state after 3 ms after transmission of a PUCCH including HARQ-ACK information indicating whether reception of a PDSCH including the MAC-CE including the one joint TCI state is successful. If a MAC-CE includes two or more joint TCI states, the UE may identify that the multiple joint TCI states indicated by the MAC-CE correspond to respective codepoints of a TCI state field of DCI format 1_1 or 1_2 after 3 ms after the transmission of a PUCCH including HARQ-ACK information indicating whether reception of a PDSCH including the MAC-CE including the two or more joint TCI states is successful, and activate the indicated joint TCI states. Thereafter, the UE may receive DCI format 1_1 or 12 to apply one joint TCI state indicated by a TCI state field in the received DCI to uplink transmission and downlink reception beams. DCI format 1_1 or 1_2 may include downlink data channel scheduling information (with DL assignment) or not include same (without DL assignment).

In a case where the UE receives a transmission and/or reception beam-related indication through higher layer signaling by using a separate TCI state scheme, the UE may receive a MAC-CE indicating a separate TCI state from the base station to perform a transmission and/or reception beam application operation. The base station may schedule reception of a PDSCH including the MAC-CE indicating the separate TCI state to the UE through a PDCCH. If a MAC-CE includes one separate TCI state set, the UE may determine an uplink transmission beam or transmission filter by using separate TCI states included in the indicated separate TCI state set after 3 ms after PUCCH transmission including HARQ-ACK information meaning whether a PDSCH has been successfully received. In addition, the UE may determine a downlink reception beam or reception filter by using separate TCI states included in the indicated separate TCI state set after 3 ms after PUCCH transmission including HARQ-ACK information meaning whether a PDSCH has been successfully received. The separate TCI state set may be referred to as single or multiple separate TCI states which one codepoint of a TCI state field in DCI format 1_1 or 1_2 may have. One separate TCI state set may include one DL TCI state, include one UL TCI state, or include one DL TCI state and one UL TCI state. If a MAC-CE includes two or more separate TCI state sets, the UE may identify that the multiple separate TCI state sets indicated by the MAC-CE correspond to respective codepoints of a TCI state field of DCI format 1_1 or 1_2 after 3 ms from transmission of a PUCCH including HARQ-ACK information indicating whether reception of a PDSCH is successful, and may activate the indicated separate TCI state sets. Each codepoint of the TCI state field of DCI format 1_1 or 1_2 may indicate one DL TCI state, indicate one UL TCI state, or indicate one DL TCI state and one UL TCI state. The UE may receive DCI format 1_1 or 1_2 to apply a separate TCI state set indicated by a TCI state field in the DCI to uplink transmission and downlink reception beams. DCI format 1_1 or 12 may include downlink data channel scheduling information (with DL assignment) or not include same (without DL assignment).

FIG. 5 illustrates an example of a beam application time which may be considered when a unified TCI scheme is used in a wireless communication system according to an embodiment of the disclosure.

Referring to FIG. 5, as described above, a UE may receive, from a base station, DCI format 1_1 or 1_2 including or not including downlink data channel scheduling information (with DL assignment or without DL assignment), and apply one joint TCI state or one separate TCI state set indicated by a TCI state field in the DCI to uplink transmission and downlink reception beams.

DCI format 1_1 or 1_2 with DL assignment (500): If a UE receives, from a base station, DCI format 1_1 or 1_2 including downlink data channel scheduling information (501) so that one joint TCI state or one separate TCI state set based on a unified TCI scheme is indicated, the UE may receive a PDSCH scheduled based on the received DCI (505), and transmit a PUCCH including a HARQ-ACK indicating whether reception of the DCI and the PDSCH is successful (510). The HARQ-ACK may include whether reception is successful, for both the DCI and the PDSCH. If the UE fails to receive at least one of the DCI and the PDSCH, the UE may transmit a NACK, and if the UE succeeds in receiving both of them, the UE may transmit an ACK.
DCI format 1_1 or 1_2 without DL assignment (550): If a UE receives, from a base station, DCI format 1_1 or 1_2 not including downlink data channel scheduling information (555) so that one joint TCI state or one separate TCI state set based on a unified TCI scheme is indicated, the UE may assume at least one combination of the following items for the DCI. However, the disclosure is not limited thereto.
The DCI includes a CRC scrambled using a CS-RNTI.
The values of all bits assigned to all fields used as redundancy version (RV) fields are 1.
The values of all bits assigned to all fields used as modulation and coding scheme (MCS) fields are 1.
The values of all bits assigned to all fields used as new data indication (NDI) fields are 0.
In a case of frequency domain resource allocation (FDRA) type 0, the values of all bits assigned to an FDRA field are 0, in a case of FDRA type 1, the values of all bits assigned to an FDRA field are 1, and in a case of an FDRA scheme being dynamicSwitch, the values of all bits assigned to an FDRA field are 0.

The UE may transmit, to the base station, a PUCCH including a HARQ-ACK indicating whether DCI format 1_1 or 1_2 on which the items described above are assumed is successfully received (560).
With respect to DCI format 1_1 or 1_2 both with DL assignment (500) and without DL assignment (550), if a new TCI state indicated through DCI 501 or 555 is the same as a TCI state having been previously indicated and thus having been being applied to uplink transmission and downlink reception beams, the UE may maintain the previously applied TCI state. If the new TCI state is different from the previously indicated TCI state, the UE may determine, as a time point for application of a joint TCI state or separate TCI state set, which is indicatable by a TCI state field included in the DCI, a time point 530 or 580 after the first slot 520 or 570 after passage of a time interval as long as a beam application time (BAT) 515 or 565 after PUCCH transmission, and may use the previously indicated TCI-state at a time point 525 or 575 before the corresponding slot 520 or 570.
With respect to DCI format 1_1 or 1_2 both with DL assignment (500) and without DL assignment (550), the BAT is a particular number of OFDM symbols, and may be configured through higher layer signaling, based on UE capability report information. Numerologies of the BAT and the first slot after the BAT may be determined based on the smallest numerology among all cells to which a joint TCI state or separate TCI set indicated through DCI is applied.

The UE may apply one joint TCI state indicated through a MAC-CE or DCI to reception for control resource sets connected to all UE-specific search spaces, reception of a PDSCH scheduled by a PDCCH transmitted from the control resource sets and transmission of a PUSCH, and transmission of all PUCCH resources.

If one separate TCI state set indicated through a MAC-CE or DCI includes one DL TCI state, a UE may apply the one separate TCI state set to reception for control resource sets connected to all UE-specific search spaces, and reception of a PDSCH scheduled by a PDCCH transmitted from control resource sets connected to all UE-specific search spaces. In addition, the UE may apply a previously indicated UL TCI state to all PUSCH and PUCCH resources.

If one separate TCI state set indicated through a MAC-CE or DCI includes one UL TCI state, the UE may apply the UL TCI state to all PUSCH and PUCCH resources. The UE may apply a previously indicated DL TCI state to reception for control resource sets connected to all UE-specific search spaces, and reception of a PDSCH scheduled by a PDCCH transmitted from control resource sets connected to all UE-specific search spaces.

If one separate TCI state set indicated through a MAC-CE or DCI includes one DL TCI state and one UL TCI state, the UE may apply the DL TCI state to reception for control resource sets connected to all UE-specific search spaces, and reception of a PDSCH scheduled by a PDCCH transmitted from control resource sets connected to all UE-specific search spaces. The UE may apply the UL TCI state to all PUSCH and PUCCH resources.

### [Unified TCI State MAC-CE]

Hereinafter, a single TCI state indication and activation method based on a unified TCI scheme is described. A PDSCH including a MAC-CE may be scheduled to a UE by a base station, and the UE may interpret each codepoint of a TCI state field in DCI format 1_1 or 1_2, based on information in the MAC-CE received from the base station, after 3 slots from transmission of a HARQ-ACK for the PDSCH to the base station. For example, the UE may activate each entry of the MAC-CE received from the base station in each codepoint of the TCI state field in DCI format 1_1 or 1_2.

FIG. 6 illustrates an example of a MAC-CE structure for activation and indication of a joint TCI state or a separate DL or UL TCI state in a wireless communication system according to an embodiment of the disclosure.

Referring to FIG. 6, each field in the MAC-CE structure may have the following meaning.
Serving Cell ID 600: A serving cell ID field may indicate a serving cell to which a MAC-CE is to be applied. The length of the serving cell ID field may be 5 bits. If a serving cell indicated by the serving cell ID field may be included in at least one of the higher layer signaling simultaneousU-TCI-UpdateList1, simultaneousU-TCI-UpdateList2, simultaneousU-TCI-UpdateList3, or simultaneousU-TCI-UpdateList4, the MAC-CE may be applied to all serving cells included in at least one list among simultaneousU-TCI-UpdateList1, simultaneousU-TCI-UpdateList2, simultaneousU-TCI-UpdateList3, or simultaneousU-TCI-UpdateList4, in which the serving cell indicated by the serving cell ID field is included.
DL BWP ID 605: A DL BWP ID field may indicate a DL BWP to which a MAC-CE is to be applied. The meaning of each codepoint of the DL BWP ID field may correspond to each codepoint of a bandwidth part indicator in DCI. The length of the DL BWP ID field may be 2 bits.
UL BWP ID 610: A UL BWP ID field may indicate a UL BWP to which a corresponding MAC-CE is to be applied. The meaning of each codepoint of the UL BWP ID field may correspond to each codepoint of a bandwidth part indicator in DCI. The length of the UL BWP ID field may be 2 bits.
P_i 615: A P_i field may indicate whether each codepoint of a TCI state field in DCI format 1_1 or 1_2 has multiple TCI states or one TCI state. If the value of P_i is 1, this may indicate that the i-th codepoint has multiple TCI states. In addition, if the value of P_i is 1, this may imply that the i-th codepoint may include a separate DL TCI state and a separate UL TCI state. If the value of P_i is 0, this may indicate that the i-th codepoint has a single TCI state. If the value of P_i is 0, this may imply that the i-th codepoint may include one type among a joint TCI state, a separate DL TCI state, or a separate UL TCI state.
D/U 620: A D/U field may indicate whether a TCI state ID field in the same octet is a joint TCI state, a separate DL TCI state, or a separate UL TCI state. If the D/U field is 1, the TCI state ID field in the same octet is a joint TCI state or a separate DL TCI state. In addition, if the D/U field is 0, the TCI state ID field in the same octet is a separate UL TCI state.
TCI state ID 625: A TCI state ID field may indicate a TCI state identifiable by the higher layer signaling TCI-StateId. If the D/U field is configured to be 1, the TCI state ID field may be used to represent TCI-StateId expressible by 7 bits. If the D/U field is configured to be 0, a most significant bit (MSB) of the TCI state ID field may be considered as a reserved bit, and the remaining 6 bits may be used to represent the higher layer signaling UL-TCIState-Id. The number of maximally activatable TCI states may be 8 in a case of joint TCI states, and may be 16 in a case of separate DL or UL TCI states.
R: R means a reserved bit and may be configured to be 0.

With respect to the MAC-CE structure of FIG. 6, a UE may include, in the MAC-CE structure, a third octet including P_1, P_2, . . . , and P_8 fields in FIG. 6 regardless of unifiedTCI-StateType-r17 in MIMOparam-r17 in the higher layer signaling ServingCellConfig being configured to be joint or separate. In this case, the UE may perform TCI state activation by using a fixed MAC-CE structure regardless of higher layer signaling configured by a base station. For example, with respect to the MAC-CE structure of FIG. 6, the UE may omit the third octet including P1, P2, . . . , and P8 fields in FIG. 6, in a case where unifiedTCI-StateType-r17 in MIMOparam-r17 in the higher layer signaling ServingCellConfig is configured to be joint. In this case, the UE may save the payload of the MAC-CE by a maximum of 8 bits according to higher layer signaling configured by the base station. In addition, the UE may consider or determine that all D/U fields positioned on the first bits in octets starting from a fourth octet in FIG. 6 are R fields, and all the R fields may be configured as 0 bits.

### [PDCCH: Regarding DCI]

Next, downlink control information (DCI) in a 5G communication system will be described in detail.

In a 5G system, scheduling information regarding uplink data (or physical uplink shared channel (PUSCH)) or downlink data (or physical downlink shared channel (PDSCH)) is included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH) after a channel coding and modulation process. A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI. If the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 1_0 in which the CRC is scrambled by a C-RNTI may include the following pieces of information given in Table 4 below, for example.

```
TABLE 4
  - Identifier for DCI formats - [1] bit
  $‐ Frequency domain resource assignment - [ ⌈ {log}_{2} ( \frac{{N}_{RB}^{UL , BWP} ( {N}_{RB}^{UL , BWP} + 1 )}{2} ) ⌉ s$
  - Time domain resource assignment - X bits
  - Frequency hopping flag - 1 bit.
  - Modulation and coding scheme - 5 bits
  - New data indicator - 1 bit
  - Redundancy version - 2 bits
  - HARQ process number - 4 bits
  - Transmit power control (TPC) command for scheduled PUSCH - [2] bits
  - Uplink/supplementary uplink (UL/SUL) indicator - 0 or 1 bit
```

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 5 below, for example.

```
TABLE 5
  - Carrier indicator - 0 or 3 bits
  - UL/SUL indicator - 0 or 1 bit
  - Identifier for DCI formats - [1] bits
  - Bandwidth part indicator - 0, 1 or 2 bits
  - Frequency domain resource assignment
        $* For resource allocation type 0 , ⌈ \frac{{N}_{RB}^{UL , BWP}}{P} ⌉ bits$
        $* For resource allocation type 1 , ⌈ {log}_{2} ( \frac{{N}_{RB}^{UL , BWP} ( {N}_{RB}^{UL , BWP} + 1 )}{2} ) ⌉$
  - Time domain resource assignment - 1, 2, 3, or 4 bits
  - Virtual resource block (VRB)-to-physical resource block (PRB) mapping - 0 or
1 bit, only for resource allocation type 1.
        * 0 bit if only resource allocation type 0 is configured;
        * 1 bit otherwise.
  - Frequency hopping flag - 0 or 1 bit, only for resource allocation type 1.
        * 0 bit if only resource allocation type 0 is configured;
        * 1 bit otherwise.
  - Modulation and coding scheme - 5 bits
  - New data indicator - 1 bit
  - Redundancy version - 2 bits
  - HARQ process number - 4 bits
  - 1st downlink assignment index- 1 or 2 bits
        * 1 bit for semi-static HARQ-ACK codebook;
        * 2 bits for dynamic HARQ-ACK codebook with single HARQ-ACK
        codebook.
  - 2nd downlink assignment index - 0 or 2 bits
        * 2 bits for dynamic HARQ-ACK codebook with two HARQ-ACK sub-
        codebooks;
        * 0 bit otherwise.
  - TPC command for scheduled PUSCH - 2 bits
  - SRS resource in [symbol] tor ┌ [symbol] log [symbol] _2(Σ_(k =
1)\hat{ }(L_(maxΣ)) [symbol]  (▪(N_“SRS” @k))(┤))┐}lo [symbol] 2(N_“SRS”)┐ bits
        $* ⌈ {log}_{2} ( {\sum }_{k = 1}^{{L}_{max \sum }} ( \begin{matrix}{N}_{SRS} \\ k\end{matrix} ) ( ) ) ⌉ n ‐ codebook based PUSCH$
        transmission;
        * ┌log₂(N_{SRS})]for codebook based PUSCH transmission.
  - Precoding information and number of layers - up to 6 bits
  - Antenna ports - up to 5 bits
  - SRS request - 2 bits
  - Channel state information (CSI) request - 0, 1, 2, 3, 4, 5, or 6 bits
  - Code block group (CBG) transmission information - 0, 2, 4, 6, or 8 bits
  - Phase tracking reference signal (PTRS)-demodulation reference signal
(DDMRS) association - 0 or 2 bits.
  - beta_offset indicator - 0 or 2 bits
  - DMRS sequence initialization - 0 or 1 bit
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 6 below, for example.

```
TABLE 6
  - Identifier for DCI formats - [1] bit
  $‐ Frequency domain resource assignment - [ ⌈ {log}_{2} ( \frac{{N}_{RB}^{DL , BWP} ( {N}_{RB}^{DL , BWP} + 1 )}{2} ) ⌉ s$
  - Time domain resource assignment - X bits
  - VRB-to-PRB mapping - 1 bit.
  - Modulation and coding scheme - 5 bits
  - New data indicator - 1 bit
  - Redundancy version - 2 bits
  - HARQ process number - 4 bits
  - Downlink assignment index - 2 bits
  - TPC command for scheduled PUCCH - [2] bits
  - Physical uplink control channel (PUCCH) resource indicator - 3 bits
  - PDSCH-to-HARQ feedback timing indicator - [3] bits
```

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 7 below, for example.

```
TABLE 7
  - Carrier indicator - 0 or 3 bits
  - Identifier for DCI formats - [1] bits
  - Bandwidth part indicator - 0, 1 or 2 bits
  - Frequency domain resource assignment
        $* For resource allocation type 0 , ⌈ \frac{{N}_{RB}^{DL , BWP}}{P} ⌉ bits$
        $* For resource allocation type 1 , ⌈ {log}_{2} ( \frac{{N}_{RB}^{DL , BWP} ( {N}_{RB}^{DL , BWP} + 1 )}{2} ) ⌉$
  - Time domain resource assignment -1, 2, 3, or 4 bits
  - VRB-to-PRB mapping - 0 or 1 bit, only for resource allocation type 1.
        * 0 bit if only resource allocation type 0 is configured;
        * 1 bit otherwise.
  - Physical resource block (PRB) bundling size indicator - 0 or 1 bit
  - Rate matching indicator - 0, 1, or 2 bits
  - Zero power (ZP) channel state information (CSI)-reference signal (RS) trigger -
0, 1, or 2 bits
  For transport block 1:
  - Modulation and coding scheme - 5 bits
  - New data indicator - 1 bit
  - Redundancy version - 2 bits
  For transport block 2:
  - Modulation and coding scheme - 5 bits
  - New data indicator - 1 bit
  - Redundancy version - 2 bits
  - HARQ process number - 4 bits
  - Downlink assignment index - 0 or 2 or 4 bits
  - TPC command for scheduled PUCCH - 2 bits
  - PUCCH resource indicator - 3 bits
  - PDSCH-to-HARQ_feedback timing indicator - 3 bits
  - Antenna ports - 4, 5 or 6 bits
  - Transmission configuration indication - 0 or 3 bits
  - SRS request - 2 bits
  - CBG transmission information - 0, 2, 4, 6, or 8 bits
  - CBG flushing out information - 0 or 1 bit
  - DMRS sequence initialization - 1 bit
```

### [PDCCH: CORESET, Resource Element Group (REG), Control Channel Element (CCE), and Search Space]

Hereinafter, a downlink control channel in a 5G communication system will be described in more detail with reference to the accompanying drawings.

FIG. 5 illustrates an example of a control resource set (CORESET) used to transmit a downlink control channel in a 5G wireless communication system. FIG. 5 illustrates an example in which a UE bandwidth part 510 is configured along the frequency axis, and two control resource sets (control resource set #1 501 and control resource set #2 502) are configured within one slot 520 along the time axis. The control resource sets 501 and 502 may be configured in a specific frequency resource 503 within the entire UE bandwidth part 510 along the frequency axis. One or multiple OFDM symbols may be configured along the time axis, and this may be defined as a control resource set duration 504. Referring to the example illustrated in FIG. 5, control resource set #1 501 is configured to have a control resource set duration corresponding to two symbols, and control resource set #2 502 is configured to have a control resource set duration corresponding to one symbol.

A control resource set in the 5G communication system described above may be configured for a UE by a base station through upper layer signaling (for example, system information, master information block (MIB), radio resource control (RRC) signaling). The description that a control resource set is configured for a UE may mean that at least one piece of information among the identity, frequency location, and symbol duration of a control resource set is provided. For example, the control resource set may include the following pieces of information in Table 8.

TABLE 8

| | |
|---|---|
| ControlResourceSet ::= | SEQUENCE |

-- Corresponds to L1 parameter ‘CORESET-ID’

| | |
|---|---|
| controlResourceSetId | ControlResourceSetId, |

(control resource set identity)

| | |
|---|---|
| frequencyDomainResources | BIT STRING (SIZE (45)), |

(frequency domain resource assignment information)

| | |
|---|---|
| duration | INTEGER (1..maxCoReSetDuration), |

(time domain resource assignment information)

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, n6}, |

(REG bundle size)

| | |
|---|---|
| precoderGranularity | ENUMERATED {sameAsREG-bun |

dle, allContiguousRBs},

| | |
|---|---|
| interleaverSize | ENUMERATED {n2, n3, n6} |

(interleaver size)

| | |
|---|---|
| shiftIndex | INTEGER(0..maxNrofPhysicalResource |
| Blocks−1) | OPTIONAL |

```
        (interleaver shift)
    },
```

| | |
|---|---|
| nonInterleaved | NULL |

},

| | |
|---|---|
| tci-StatesPDCCH | SEQUENCE(SIZE (1..maxNrofTCI-StatesP |
| DCCH)) OF TCI-StateId | OPTIONAL, |

(QCL configuration information)

| | |
|---|---|
| tci-PresentInDCI | ENUMERATED {enabled} |

```
            OPTIONAL, ... Need S
  }
```

In Table 8, tci-StatesPDCCH (simply referred to as transmission configuration indication (TCI) state) configuration information may include information of one or multiple SS/PBCH block indexes or channel state information reference signal (CSI-RS) indexes, which are quasi-co-located (OCLed) with a DMRS transmitted in a corresponding control resource set.

FIG. 8 illustrates an example of a downlink control channel in a wireless communication system according to an embodiment of the disclosure.

Referring to FIG. 8, FIG. 8 illustrates an example of a basic unit of time and frequency resources constituting a downlink control channel available in a 5G system. According to FIG. 8, the basic unit of time and frequency resources constituting a control channel may be referred to as a resource element group (REG) 803, and the REG 803 may be defined by one OFDM symbol 801 along the time axis and one physical resource block (PRB) 802 (that is, 12 subcarriers) along the frequency axis. The base station may configure a downlink control channel allocation unit by concatenating the REGs 803.

Provided that the basic unit of downlink control channel allocation in 5G is a control channel element 804 as illustrated in FIG. 8, one CCE 704 may include multiple REGs 803. To describe the REG 803 illustrated in FIG. 8, for example, the REG 803 may include 12 REs, and if one CCE 804 includes six REGs 803, one CCE 804 may then include 72 REs. A downlink control resource set, once configured, may include multiple CCEs 804, and a specific downlink control channel may be mapped to one or multiple CCEs 804 and then transmitted according to the aggregation level (AL) in the control resource set. The CCEs 804 in the control resource set are distinguished by numbers, and the numbers of CCEs 804 may be allocated according to a logical mapping scheme.

The basic unit of the downlink control channel illustrated in FIG. 8, that is, the REG 803 may include both REs to which DCI is mapped, and an area to which a reference signal (DMRS 805) for decoding the same is mapped. As in FIG. 8, three DRMSs 805 may be transmitted inside one REG 803. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs has been defined for blind decoding. The search space is a set of downlink control channel candidates including CCEs which the UE needs to attempt to decode at a given AL. Since 1, 2, 4, 8, or 16 CCEs constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the base station through upper layer signaling (for example, SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, the at least one piece of information configured for the UE may include at least one of the following pieces of information

TABLE 9

| | |
|---|---|
| SearchSpace ::= | SEQUENCE { |

-- Identity of the search space. SearchSpaceId = 0 identifies the SearchSpace configured via
PBCH (MIB) or ServingCellConfigCommon.

| | |
|---|---|
| search SpaceId | SearchSpaceId, |

(search space identity)

| | |
|---|---|
| controlResourceSetId | ControlResourceSetId, |

(control resource set identity)

| | |
|---|---|
| monitoringSlotPeriodicity AndOffset | CHOICE { |

(monitoring slot level periodicity)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

```
    }
          OPTIONAL,
```

| | |
|---|---|
| duration (monitoring duration) | INTEGER (2..2559) |
| monitoringSymbolsWithinSlot | BIT STRING (SIZE (14)) |

```
            OPTIONAL,
  (monitoring symbols within slot)
```

| | |
|---|---|
| nrofCandidates | SEQUENCE { |

(number of PDCCH candidates for each aggregation level)

| | |
|---|---|
| aggregationLevel 1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |

},

| | |
|---|---|
| searchSpaceType | CHOICE { |

```
    (search space type)
      -- Configures this search space as common search space (CSS) and DCI formats to
monitor.
```

| | |
|---|---|
| common | SEQUENCE |

(common search space)

| | |
|---|---|
| } | SEQUENCE { |

```
      ue-Specific
    (UE-specific search space)
        -- Indicates whether the UE monitors in this USS for DCI formats 0-0 and 1-0 or for
formats 0-1 and 1-1.
```

| | |
|---|---|
| formats | ENUMERATED {formats0-0-And-1-0, formats |

0-1-And-1-1},
...
}

According to configuration information, the base station may configure one or multiple search space sets for the UE. According to an embodiment, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the examples given below are not limiting:
DCI format 0_0/1_0 with CRC scrambled by C-RNTI, CS-RNTI, SP-CSI-RNTI, RA-RNTI, TC-RNTI, P-RNTI, SI-RNTI;
DCI format 2_0 with CRC scrambled by SFI-RNTI;
DCI format 2_1 with CRC scrambled by INT-RNTI;
DCI format 2_2 with CRC scrambled by TPC-PUSCH-RNTI, TPC-PUCCH-RNTI; and/or
DCI format 2_3 with CRC scrambled by TPC-SRS-RNTI.

Combinations of DCI formats and RNTIs given below may be monitored in a UE-specific search space. Obviously, the examples given below are not limiting:
DCI format 0_0/1_0 with CRC scrambled by C-RNTI, CS-RNTI, TC-RNTI; and/or
DCI format 1_0/1_1 with CRC scrambled by C-RNTI, CS-RNTI, TC-RNTI.

Enumerated RNTIs may follow the definition and usage given below:
Cell RNTI (C-RNTI): used to schedule a UE-specific PDSCH;
Temporary cell RNTI (TC-RNTI): used to schedule a UE-specific PDSCH;
Configured scheduling RNTI (CS-RNTI): used to schedule a semi-statically configured UE-specific PDSCH;
Random access RNTI (RA-RNTI): used to schedule a PDSCH in a random access step;
Paging RNTI (P-RNTI): used to schedule a PDSCH in which paging is transmitted;
System information RNTI (SI-RNTI): used to schedule a PDSCH in which system information is transmitted;
Interruption RNTI (INT-RNTI): used to indicate whether a PDSCH is punctured;
Transmit power control for PUSCH RNTI (TPC-PUSCH-RNTI): used to indicate a power control command regarding a PUSCH;
Transmit power control for PUCCH RNTI (TPC-PUCCH-RNTI): used to indicate a power control command regarding a PUCCH;
Transmit power control for SRS RNTI (TPC-SRS-RNTI): used to indicate a power control command regarding an SRS; and/or
The DCI formats enumerated above may follow the definitions given in Table 10 below, for example.

TABLE 10

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |

In a 5G system, the search space at aggregation level L in connection with CORESET p and search space set s may be expressed by Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i aggregation level ; \qquad [ Equation 1 ]$$

n_{C1}: carrier index;
N_{CCE,p}: total number of CCEs existing in control resource set p;
n_{s,f}^{μ}: slot index;
M_{s,max}^{(L)}er of PDCCH candidates at aggregation level L;
m_{s,n}_{_{CI}}=0, . . . , M_{s,max}^{(L)} DCCH candidate index at aggregation level L;
i=0, . . . , L−1;
Y_{p,n}_{_{s,f}}_{^{μ}}=(Aₚ·Y_{p,n}_{_{s,f}}_{^{μ}}₋₁) mod D, Y_{p,-1}=n_{RNTI}≠0, Aₚ=39827 for pmod 3=0, Aₚ=39829 for pmod 3=1, Aₚ=39839 for pmod 3=2, D=65537; and
n_{RNTI}: UE identity.

The Y_{p,n}_{_{s,f}}_{^{μ}} value may correspond to 0 in the case of a common search space.

The Y_{p,n}_{_{s,f}}_{^{μ}} value may correspond to a value changed by the UE's identity (C-RNTI or ID configured for the UE by the base station) and the time index in the case of a UE-specific search space.

In a 5G system, multiple search space sets may be configured by different parameters (for example, parameters in Table 9), and the group of search space sets monitored by the UE at each timepoint may differ accordingly. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

### [PUCCH: Regarding Transmission]

In a 5G communication system, a UE may transmit control information (UCI) to a base station through a PUCCH. The control information may include at least one of a HARQ-ACK indicating whether the UE has succeeded in demodulating/decoding a transport block (TB) having been received through a PDSCH, a scheduling request (SR) through which the UE requests a PUSCH base station to allocate resources for uplink data transmission, and channel state information (CSI) that is information for reporting a channel state of the UE.

PUCCH resources may be generally classified as for a long PUCCH and a short PUCCH according to the length of allocated symbols. In a 5G communication system, a long PUCCH has a length of 4 or more symbols in a slot, and a short PUCCH has a length of 2 or less symbols in a slot.

More specifically, a long PUCCH may be used for enhancement of uplink cell coverage. Therefore, a long PUCCH may be transmitted in a DFT-S-OFDM scheme relating to single carrier transmission rather than OFDM transmission. A long PUCCH may support transmission formats, such as PUCCH format 1, PUCCH format 3, or PUCCH format 4, according to the number of supportable control information bits, and support or nonsupport of UE multiplexing through pre-DFT OCC support at an IFFT front end.

First, PUCCH format 1 is a DFT-S-OFDM-based long PUCCH format capable of supporting control information up to 2 bits, and may use as many frequency resources as 1 RB. The control information may be configured by a combination or each of a HARQ-ACK and an SR. PUCCH format 1 may have a structure in which an OFDM symbol including a demodulation reference signal (DMRS) that is a demodulation reference signal (or reference signal) and an OFDM symbol including UCI are repeated.

For example, if the number of transmission symbols of PUCCH format 1 is 8, the 8 symbols may be configured by a DMRS symbol, a UCI symbol, a DMRS symbol, a UCI symbol, a DMRS symbol, a UCI symbol, a DMRS symbol, and a UCI symbol sequentially starting from the first starting symbol. DMRS symbols may be spread using an orthogonal code (or orthogonal sequence or spreading code, wᵢ(m)) on the time axis for a sequence corresponding to the length of 1 RB on the frequency axis in one OFDM symbol, may be subject to IFFT, and then be transmitted.

In relation to UCI symbols, the UE may perform BPSK modulation of 1-bit control information or QPSK modulation of 2-bit control information to generate d(0), multiply the generated d(0) by a sequence corresponding to the length of 1 RB on the frequency axis to scramble same, spread the scrambled sequence by using an orthogonal code (or orthogonal sequence or spreading code, wᵢ(m)) on the time axis, perform IFFT of the spread sequence, and then transmit same.

The UE may generate a sequence, based on a group hopping (or sequence hopping) configuration and an ID configured by the base station through higher layer signaling, Then, the UE may perform a cyclic shift of the generated sequence by using an initial cyclic shift (CS) value configured through a higher signal to generate a sequence corresponding to the length of 1 RB.

wᵢ(m) may be determined such as

$${w}_{i} ( m ) = {e}^{\frac{j 2 πφ ( m )}{{N}_{SF}}}$$

when the length (NSF) of a spreading code is given and, specifically, may be given as shown in Table 11 below. I means the index of the spreading code itself, and m denotes the index of each element of the spreading code. Herein, the numbers in the square brackets [ ] in Table 11 may indicate φ(m). For example, if the length of a spreading code is 2 and the configured index i of the spreading code is 0 (i=0), the spreading code wᵢ(m) becomes

$${w}_{i} ( 0 ) = {e}^{j 2 π \cdot \frac{0}{{N}_{SF}}} = 1 and {w}_{i} ( 1 ) = {e}^{j 2 π \cdot \frac{0}{{N}_{SF}}} = 1$$

and thus wᵢ(m) is equal to [1 1].

TABLE 1
$Spreading code {w}_{i} ( m ) = {e}^{\frac{j 2 πφ ( m )}{{N}_{SF}}} for PUCCH format 1$
φ(m)

| N_{SF} | i = 0 | i = 1 | i = 2 | i = 3 | i = 4 | i = 5 | i = 6 |
|---|---|---|---|---|---|---|---|
| 1 | [0] | | | | | | |
| 2 | [0 0] | [0 1] | | | | | |
| 3 | [0 0 0] | [0 1 2] | [0 2 1] | | | | |
| 4 | [0 0 0 0] | [0 2 0 2] | [0 0 2 2] | [0 2 2 0] | | | |
| 5 | [0 0 0 0 0] | [0 1 2 3 4] | [0 2 4 1 3] | [0 3 1 4 2] | [0 4 3 2 1] | | |
| 6 | [0 0 0 0 0 0] | [0 1 2 3 4 5] | [0 2 4 0 2 4] | [0 3 0 3 0 3] | [0 4 2 0 4 2] | [0 5 4 3 2 1] | |
| 7 | [0 0 0 0 0 0 0 0] | [0 1 2 3 4 5 6] | [0 2 4 6 1 3 5] | [0 3 6 2 5 1 4] | [0 4 1 5 2 6 3] | [0 5 3 1 6 4 2] | [0 6 5 4 3 2 1] |

Next, PUCCH format 3 may be a DFT-S-OFDM-based long PUCCH format capable of supporting control information greater than 2 bits, and the number of used RBs may be configured through a higher layer. The control information may be configured by a combination or each of a HARQ-ACK, an SR, and CSI. DMRS symbol positions in PUCCH format 3 may be represented in Table 12 below according to whether there is frequency hopping in a slot, and whether an additional DMRS symbol is configured.

TABLE 2

| | DMRS position in transmission of PUCCH format 3/4 | | | |
|---|---|---|---|---|
| | Additional DMRS | | Additional DMRS | |
| Transmission | not configured | | configured | |
| length of | Frequency | Frequency | Frequency | Frequency |
| PUCCH | hopping not | hopping | hopping not | hopping |
| format 3/4 | configured | configured | configured | configured |
| 4 | 1 | 0, 2 | 1 | 0, 2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

If the number of transmission symbols of PUCCH format 3 is 8, a DMRS may be transmitted on a first symbol and a fifth symbol when the 0-th symbol is used as the first starting symbol of the 8 symbols. Table 12 is applied even to DMRS symbol positions of PUCCH format 4 in the same way.

Next, PUCCH format 4 may be a DFT-S-OFDM-based long PUCCH format capable of supporting control information greater than 2 bits, and may use as many frequency resources as 1 RB. The control information may be configured by a combination or each of a HARQ-ACK, an SR, and CSI. PUCCH format 4 may differ from PUCCH format 3 in that PUCCH formats 4 of several UEs are multiplexable in one RB. It may be possible to multiplex PUCCH formats 4 of multiple UEs through application of a pre-DFT orthogonal cover code (OCC) to control information at an IFFT front end. However, the number of control information symbols transmittable by one UE may be reduced according to the number of multiplexed UEs. The number of multiplexable UEs (e.g., the number of available different OCCs) may be 2 or 4, and the number of OCCs and OCC indexes to be applied may be configured through a higher layer.

Next, short PUCCHs are described. A short PUCCH may be transmitted on both a downlink-centric slot and an uplink-centric slot. In general, a short PUCCH may be transmitted on the last symbol of a slot or an OFDM symbol positioned in a back part (e.g., the last OFDM symbol, the second last OFDM symbol, or the last two OFDM symbols). A short PUCCH being transmitted on a random position in a slot may also be possible. A short PUCCH may be transmitted using one OFDM symbol or two OFDM symbols. A short PUCCH may be used to shorten a delay time, compared to a long PUCCH, in a situation where uplink cell coverage is good, and may be transmitted in a CP-OFDM scheme.

A short PUCCH may support transmission formats, such as PUCCH format 0 and PUCCH format 2, according to the number of supportable control information bits. First, PUCCH format 0 may be a short PUCCH format capable of supporting control information up to 2 bits, and may use as many frequency resources as 1 RB. The control information may be configured by a combination or each of a HARQ-ACK and an SR. PUCCH format 0 may have a structure of not transmitting a DMRS and transmitting only a sequence mapped to 12 subcarriers on the frequency axis in one OFDM symbol. The UE may generate a sequence, based on a group hopping (or sequence hopping) configuration and an ID configured by the base station through a higher signal. Then, the UE may perform a cyclic shift of the generated sequence by using a final CS value obtained after adding, to an indicated initial CS value, a CS value varying according to an ACK or NACK, map the sequence to 12 subcarriers, and transmit the mapped sequence.

For example, in a case where a HARQ-ACK has 1 bit, as shown in Table 13 below, if the HARQ-ACK is an ACK, the UE may generate the final CS by adding 6 to the initial CS value, and if the HARQ-ACK is a NACK, the UE may generate the final CS by adding 0 to the initial CS. The value of 0 that is a CS value for NACK and the value of 6 that is a CS value for ACK are defined in a specification, and the UE may generate PUCCH format 0 according to the values defined in the specification to transmit a 1-bit HARQ-ACK.

TABLE 3

| 1-bit HARQ-ACK | NACK | ACK |
|---|---|---|
| Final CS | (initial CS + 0) | (initial CS + 6) |
| | mod 12 = initial CS | mod 12 |

For example, in a case where a HARQ-ACK has 2 bits, as shown in [Table 14] below, the UE may add 0 to the initial CS value if the HARQ-ACK is (NACK, NACK), add 3 to the initial CS value if the HARQ-ACK is (NACK, ACK), add 6 to the initial CS value if the HARQ-ACK is (ACK, ACK), and add 9 to the initial CS value if the HARQ-ACK is (ACK, NACK). The value of 0 that is a CS value for (NACK, NACK), the value of 3 that is a CS value for (NACK, ACK), the value of 6 that is a CS value for (ACK, ACK), and the value of 9 that is a CS value for (ACK, NACK) may be defined in a specification. The UE may generate PUCCH format 0 according to the values defined in the specification to transmit a 2-bit HARQ-ACK. If the final CS value exceeds 12 due to the CS value added to the initial CS value according to an ACK or NACK, since length of the sequence is 12, modulo 12 may be applied to the final CS value.

TABLE 4

| 2-bit | NACK, | NACK, | ACK, | ACK, |
|---|---|---|---|---|
| HARQ-ACK | NACK | ACK | ACK | NACK |
| Final CS | (initial CS + | (initial CS + | (initial CS + | (initial CS + |
| | 0) mod 12 = | 3) mod 12 | 6) mod 12 | 9) mod 12 |
| | initial CS | | | |

Next, PUCCH format 2 is a short PUCCH format supporting control information greater than 2 bits, and the number of used RBs may be configured through a higher layer. The control information may be configured by a combination or each of a HARQ-ACK, an SR, and CSI. If the index of a first subcarrier is #0, PUCCH format 2 may be fixed to subcarriers having indexes of #1, #4, #7, and #10 as the positions of subcarriers on which a DMRS is transmitted in one OFDM symbol. The control information may undergo channel coding and a subsequent modulation process to be mapped to the remaining subcarriers except the subcarriers on which the DMRS is positioned.

In summary, configurable values for each PUCCH format described above and the ranges thereof may be organized as shown in Table 15 below. Values not required to be configured may be represented by N.A. as shown in Table 15 below.

TABLE 5

| | | PUCCH | PUCCH | PUCCH | PUCCH | PUCCH |
|---|---|---|---|---|---|---|
| | | Format 0 | Format 1 | Format 2 | Format 3 | Format 4 |
| Starting | Configurability | ✓ | ✓ | ✓ | ✓ | ✓ |
| symbol | Value range | 0-13 | 0-10 | 0-13 | 0-10 | 0-10 |
| Number of | Configurability | ✓ | ✓ | ✓ | ✓ | ✓ |
| symbols | Value range | 1, 2 | 4-14 | 1, 2 | 4-14 | 4-14 |
| in a slot | | | | | | |
| Index for | Configurability | ✓ | ✓ | ✓ | ✓ | ✓ |
| identifying | Value range | 0-274 | 0-274 | 0-274 | 0-274 | 0-274 |
| starting PRB | | | | | | |
| Number | Configurability | N.A. | N.A. | ✓ | ✓ | N.A. |
| of PRBs | Value range | N.A. | N.A. | 1-16 | 1-6, 8-10, | N.A. |
| | | (Default is 1) | (Default is 1) | | 12, 15, 16 | (Default is 1) |
| Enabling | Configurability | ✓ | ✓ | ✓ | ✓ | ✓ |
| frequency | Value range | On/Off | On/Off | On/Off | On/Off | On/Off |
| hopping | | (only for 2 | | (only for 2 | | |
| (intra-slot) | | symbols) | | symbols) | | |
| Frequency | Configurability | ✓ | ✓ | ✓ | ✓ | ✓ |
| resource of | Value range | 0-274 | 0-274 | 0-274 | 0-274 | 0-274 |
| 2^{nd} hop if | | | | | | |
| intra-slot | | | | | | |
| frequency | | | | | | |
| hopping is | | | | | | |
| enabled | | | | | | |
| Index of | Configurability | ✓ | ✓ | N.A. | N.A. | N.A. |
| initial | Value range | 0-11 | 0-11 | N.A. | N.A. | N.A. |
| cyclic shift | | | | | | |
| Index of | Configurability | N.A. | ✓ | N.A. | N.A. | N.A. |
| time-domain | Value range | N.A. | 0-6 | N.A. | N.A. | N.A. |
| OCC | | | | | | |
| Length of | Configurability | N.A. | N.A. | N.A. | N.A. | ✓ |
| Pre-DFT OCC | Value range | N.A. | N.A. | N.A. | N.A. | 2, 4 |
| Index of | Configurability | N.A. | N.A. | N.A. | N.A. | ✓ |
| Pre-DFT OCC | Value range | N.A. | N.A. | N.A. | N.A. | 0, 1, 2, 3 |

For uplink coverage enhancement, multi-slot repetition may be supported for PUCCH formats 1, 3, and 4, and PUCCH repetition may be configured for each PUCCH format. The UE may perform repeated transmission of a PUCCH including UCI as many times as the number of slots configured through the higher layer signaling nrofSlots. For PUCCH repeated transmission, PUCCH transmission on each slot may be performed using the same number of consecutive symbols. The number of consecutive symbols may be configured through nrofSymbols in the higher layer signaling PUCCH-format1, PUCCH-format3, or PUCCH-format4. For PUCCH repeated transmission, PUCCH transmission on each slot may be performed using the same starting symbol. The starting symbol may be configured through startingSymbolIndex in the higher layer signaling PUCCH-format1, PUCCH-format3, or PUCCH-format4. For PUCCH repeated transmission, single PUCCH-spatialRelationlnfo may be configured for a single PUCCH resource. For PUCCH repeated transmission, if the UE is configured to perform frequency hopping between PUCCH transmissions on different slots, the UE may perform frequency hopping in a unit of a slot. In addition, if the UE is configured to perform frequency hopping between PUCCH transmissions on different slots, the UE may start a PUCCH transmission on an even-numbered slot at a first PRB index configured through the higher layer signaling startingPRB, and start a PUCCH transmission on an odd-numbered slot at a second PRB index configured through the higher layer signaling secondHopPRB. Additionally, if the UE is configured to perform frequency hopping between PUCCH transmissions on different slots, the index of a slot indicated for the UE to perform a first PUCCH transmission thereon is 0, and through a configured entire PUCCH repeated transmission count, a PUCCH repeated transmission count value may be increased independently of whether PUCCH transmission is performed on each slot. If the UE is configured to perform frequency hopping between PUCCH transmissions on different slots, the UE does not expect that frequency hopping in a slot at the time of PUCCH transmission is configured. If performing frequency hopping between PUCCH transmissions on different slots is not configured for the UE and frequency hopping in a slot is configured, the first and second PRB indexes may also be identically applied in the slot. If the number of uplink symbols on which PUCCH transmission is possible is smaller than a number indicated by nrofSymbols configured through higher layer signaling, the UE may not transmit a PUCCH. Even if the UE has failed PUCCH transmission on a slot for a reason during PUCCH repeated transmission, the UE may increase the PUCCH repeated transmission count.

In NR Release 17, the number of slots for repeated transmission of each PUCCH resource in PUCCH-ResourceExt that is an expansion of the higher layer signaling PUCCH-Resource for PUCCH resources may be configured through the higher layer signaling pucch-RepetitionNrofSlots-r17. If the higher layer signaling pucch-RepetitionNrofSlots-r17 is configured, a corresponding PUCCH resource may be scheduled. If the higher layer signaling nrofSlots is also configured, the UE may determine the number of slots on which the corresponding PUCCH resource is repeatedly transmitted through pucch-RepetitionNrofSlots-r17, and disregard the higher layer signaling nrofSlots.

### [PUCCH: Regarding Transmission Power]

As an embodiment of the disclosure, a method of, when uplink control information is transmitted through an uplink control channel (physical uplink control channel, PUCCH) in response to a power control command received from a base station, configuring the transmission power of the uplink control channel and transmitting same by a UE will be described. Uplink control channel transmission power (P_PUCCH) of the UE in a PUCCH power control adjustment state corresponding to the i-th transmission unit and closed loop index l may be determined as Equation 2 below expressed by a unit of dBm. In Equation 2 below, when the UE supports multiple carrier frequencies in multiple cells, each parameter may be determined by primary cell c, carrier frequency f, and bandwidth part b, and may be distinguished by the indexes b, f, and c.

$$[ Equation 2 ]$$

$${P}_{PUCCH , b , f , c} ( i , {q}_{u} , {q}_{d} , l ) = min {\{ \begin{matrix}{P}_{CMAX , f , c} ( i ) , \\ {P}_{{0}_{PUCCH} , b , f , c} ( {q}_{u} ) + 10 {log}_{10} ( {2}^{μ} * {M}_{RB , b , f , c}^{PUCCH} ( i ) ) + \\ {PL}_{b , f , c} ( {q}_{d} ) + {Δ}_{{F}_{PUCCH}} ( F ) + {Δ}_{TF , b , f , c} ( i ) + {f}_{b , f , c} ( i , l )\end{matrix} \} [ dBm ]}_{-} ( CMAX , f , \text{?} :$$

$$\text{?} \text{indicates text missing or illegible when filed}$$

This is maximum transmission power usable by the UE in the i-th transmission unit, and may be determined by the power class of the UE, and parameters activated by the base station and various parameters embedded in the UE;
P_{OPUCCH,b,f,c}(qᵤ): P_{OPUCCH,b,f,c}(qᵤ) may be configured by the sum of

$${P}_{{0}_{{NOMINAL}_{PUCCH}}} and {P}_{{0}_{{UE}_{PUCCH}}} ( {q}_{u} ) \cdot {P}_{{0}_{{NOMINAL}_{PUCCH}}}$$

is a cell-specific value and may be configured through p0-nominal that is cell-specific higher layer signaling, and if there is no configuration described above,

$${P}_{{0}_{{NOMINAL}_{PUCCH}}}$$

may be 0 dBm.

$${P}_{{0}_{{UE}_{PUCCH}}}$$

(qᵤ) is a UE-specific value and may be configured through p0-PUCCH-Value in the higher layer signaling p0-PUCCH at bandwidth part b, carrier frequency f, and primary cell c. qᵤ may be a value equal to or greater than 0 and smaller than Qᵤ, and Qᵤ may indicate the size of a set of

$${P}_{{0}_{{UE}_{PUCCH}}}$$

values and may be configured through the higher layer signaling maxNrofPUCCH-P0-PerSet. The set of

$${P}_{{0}_{{UE}_{PUCCH}}}$$

values may be configured through the higher layer signaling p0-Set, and if there is no configuration described above, the set may be considered or determined as

$${P}_{{0}_{{UE}_{PUCCH}}} ( {q}_{u} ) = 0 ;$$

(qᵤ)=0;
β: Subcarrier spacing configuration value;
M_{RB,b,f,c}^{PUCCH}(i): This may indicate a resource amount (e.g., the number of resource blocks (RBs) used for PUCCH transmission on the frequency axis) used in the i-th PUCCH transmission unit in bandwidth part b, carrier frequency f, and primary cell c;
PL_{b,f,c}(q_{d}): This represents a pathloss between the base station and the UE, and the UE may calculate a pathloss from the difference between the transmission power of a reference signal (RS) resource q_{d} signaled by the base station and the UE reception signal level of the reference signal;
Δ_{F}_{_{PUCCH}} (F): If the higher layer signaling deltaF-PUCCH-f0 is configured for the UE with respect to PUCCH format 0, the UE may use a configured value. If the higher layer signaling deltaF-PUCCH-f1 is configured for the UE with respect to PUCCH format 1, the UE may use a configured value. If the higher layer signaling deltaF-PUCCH-f2 is configured for the UE with respect to PUCCH format 2, the UE may use a configured value. If the higher layer signaling deltaF-PUCCH-f3 is configured for the UE with respect to PUCCH format 3, the UE may use a configured value. If the higher layer signaling deltaF-PUCCH-f4 is configured for the UE with respect to PUCCH format 4, the UE may use a configured value. If higher layer signaling is not configured for the UE with respect to all PUCCH formats, the UE may use 0;
Δ_{TF,b,f,c}(i): This is a PUCCH transmission power adjustment element in bandwidth part b, carrier frequency f, and primary cell c, and different calculation methods may be used according to PUCCH formats; and
g_{b,f,c}(i,l): This may indicate a PUCCH power control adjustment state value for the i-th PUCCH transmission unit corresponding to closed loop index 1 in bandwidth part b, carrier frequency f, and primary cell c. Here, closed loop power adjustment for PUCCH transmission may employ an accumulation method of accumulating and applying a value indicated by a TPC command.

The PUCCH power control adjustment state g_{b,f,c}(i,l) may be determined through bandwidth part b, carrier frequency f, primary cell c, the i-th transmission unit, and closed loop index 1.
δ_{PUCCH,b,f,c}(i,l): This may be a value indicated by a TPC command field included in DCI format 1_0, 1_1, or 1_2 scheduling PDSCH reception and the i-th PUCCH transmission unit corresponding to closed loop index 1 in bandwidth part b, carrier frequency f, and primary cell c, or may be a value indicated by a TPC command field included in DCI format 2_2 transmitted together with a CRC scrambled with a TPC-PUCCH-RNTI.
   If the higher layer signaling twoPUCCH-PC-AdjustmentStates and PUCCH-SpatialRelationInfo are configured for the UE, closed loop index 1 may have a value of 0 or 1.
   If the higher layer signaling twoPUSCH-PC-AdjustmentStates or PUCCH-SpatialRelationInfo is not configured for the UE, closed loop index 1 may have a value of 0.
   If the UE obtains a TPC command value through a TPC command field included in DCI format 1_0, 1_1, or 1_2 scheduling PDSCH reception and the higher layer signaling PUCCH-SpatialRelationlnfo is configured for the UE, the UE may obtain a connection relation between a pucch-SpatialRelationInfold value and a closedLoopIndex value configuring a value of closed loop index 1, based on an index configurable through the higher layer signaling p0-PUCCH-Id. If the UE receives a MAC-CE corresponding to pucch-SpatialRelationInfold, the UE may determine a closedLoopIndex value configuring a value of closed loop index 1, based on a corresponding p0-PUCCH-Id index.
   If the UE obtains one TPC command value from a TPC command field included in DCI format 2_2 transmitted together with a CRC scrambled with a TPC-PUCCH-RNTI, the UE may obtain an 1 value, based on a closed loop index field included in DCI format 2_2.
The PUCCH power control adjustment state g_{b,f,c}(i,l) for the i-th PUCCH transmission unit corresponding to closed loop index 1 in bandwidth part b, carrier frequency f, and primary cell c may be calculated as shown in Equation 3.

$${g}_{b , f , c} ( i , l ) = {g}_{b , f , c} ( i - {i}_{0} , l ) + {\sum }_{m = 0}^{c ( {C}_{i} ) - 1} {δ}_{PUCCH , b , f , c} ( m , l ) . \qquad [ Equation 3 ]$$

δ_{PUCCH,b,f,c}(m,l): This may be, as described above, a value indicated by a TPC command field included in DCI format 1_0, 1_1, or 1_2 scheduling PDSCH reception and the m-th PUCCH transmission unit corresponding to closed loop index 1 in bandwidth part b, carrier frequency f, and primary cell c, or may be a value indicated by a TPC command field included in DCI format 2_2 transmitted together with a CRC scrambled with a TPC-PUCCH-RNTI. If a TPC command accumulation operation is possible, a value of δ_{PUCCH,b,f,c} may be a corresponding value in a unit of [dB] according to a value which a TPC command field included in DCI format 1_0, 1_1, 1_2, or 2_2 is indicated to be, as shown in Table 18. For example, if the value of the TPC command field is 0, δ_{PUCCH,b,f,c} may have a value of −1 dB.
Σₘ₌₀^{c(c}^{ᵢ}⁾⁻¹δ_{PUCCH,b,f,c}(m,l) may indicate the sum of δ_{PUCCH,b,f,c} for all corresponding transmission units in the particular set Cᵢ according to the above TPC command value. c(Cᵢ) may indicate the number of all elements belonging to the set Cᵢ. Cᵢ may indicate a set of pieces of DCI including all TPC command values for which a TPC command accumulation operation is to be performed for the i-th PUCCH transmission unit. In order to determine Cᵢ, the UE may define a start point and an end point on the time dimension and include all the pieces of DCI received by the UE between the two points as the elements of Cᵢ.
   The end point for determining Cᵢ may be a point before K_{PUCCH} (i) symbols from the starting symbol of the i-th PUCCH transmission unit.
   The start point for determining Cᵢ may be a point before K_{PUCCH}(i−i₀)−1 symbols from the starting symbol of the (i−i0)-th PUCCH transmission unit. i0, which is a positive integer, may be determined to be the smallest value satisfying that a time point before K_{PUCCH}(i−i₀) symbols from the starting symbol of the (i−i0)-th PUCCH transmission unit is earlier, in time, than the end point for determining Cᵢ (e.g., a point before K_{PUCCH} (i) symbols from the starting symbol of the i-th PUCCH transmission unit).
   For example, if the UE may define the end point for determining Cᵢ to be sym(i) and define the time point before K_{PUCCH}(i−i₀) symbols from the starting symbol of the (i−i0)-th PUCCH transmission unit to be sym(i−i0) and sym(i)=sym(i−1)>sym(i−2)>sym(i−3) is satisfied, i0 may be determined to be 2.

### [PUSCH: Regarding Transmission Scheme]

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 16 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 16 through upper signaling. If PUSCH transmission is operated by a configured grant, parameters applied to the PUSCH transmission are applied through configuredGrantConfig (upper signaling) in Table 16 except for dataScramblingIdentityPUSCH, txConfig, codebookSubset, maxRank, and scaling of UCI-OnPUSCH, which are provided by pusch-Config (upper signaling) in Table 17. If provided with transformPrecoder inside configuredGrantConfig (upper signaling) in Table 16, the UE applies tp-pi2BPSK inside pusch-Config in Table 17 to PUSCH transmission operated by a configured grant.

TABLE 16

| | |
|---|---|
| ConfiguredGrantConfig ::= | SEQUENCE { |

| | | |
|---|---|---|
| frequencyHopping | ENUMERATED {intraSlot, interSlot} | OPTIONAL, |

-- Need S,

| | |
|---|---|
| cg-DMRS-Configuration | DMRS-UplinkConfig, |

| | | |
|---|---|---|
| mcs-Table | ENUMERATED {qam256, qam64LowSE} | OPTIONAL, - |

- Need S

| | |
|---|---|
| mcs-TableTransformPrecoder | ENUMERATED {qam256, qam64LowSE} |

OPTIONAL, -- Need S

| | | |
|---|---|---|
| uci-OnPUSCH | SetupRelease { CG-UCI-OnPUSCH } | OPTIONAL, -- |

Need M

| | |
|---|---|
| resourceAllocation | ENUMERATED { resourceAllocationType0, |

resourceAllocationType1, dynamicSwitch },

| | | |
|---|---|---|
| rbg-Size | ENUMERATED {config2} | OPTIONAL, -- Need S |

| | |
|---|---|
| powerControlLoopToUse | ENUMERATED {n0, n1}, |

| p0-PUSCH-Alpha | P0-PUSCH-AlphaSetId, | |
|---|---|---|
| transformPrecoder | ENUMERATED {enabled, disabled} | OPTIONAL, - |

- Need S

| | |
|---|---|
| nrofHARQ-Processes | INTEGER(1..16), |

| repK | ENUMERATED {n1, n2, n4, n8}, | |
|---|---|---|
| repK-RV | ENUMERATED {s1-0231, s2-0303, s3-0000} | OPTIONAL, |

-- Need R

| | |
|---|---|
| periodicity | ENUMERATED { |
| | sym2, sym7, sym1x14, sym2x14, sym4x14, sym5x14, sym8x14, sym10x14, |

sym16x14, sym20x14,

sym32x14, sym40x14, sym64x14, sym80x14, sym128x14, sym160x14,

sym256x14, sym320x14, sym512x14,

sym640x14, sym1024x14, sym1280x14, sym2560x14, sym5120x14,
sym6, sym1x12, sym2x12, sym4x12, sym5x12, sym8x12, sym10x12,

sym16x12, sym20x12, sym32x12,

sym40x12, sym64x12, sym80x12, sym128x12, sym160x12, sym256x12,

sym320x12, sym512x12, sym640x12,

sym1280x12, sym2560x12

},

| | | |
|---|---|---|
| configuredGrantTimer | INTEGER (1..64) | OPTIONAL, -- Need |

R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |

| | |
|---|---|
| antennaPort | INTEGER (0..31), |

| dmrs-SeqInitialization | INTEGER (0..1) | OPTIONAL, -- Need R |
|---|---|---|
| precodingAndNumberOfLayers | INTEGER (0..63), | |
| srs-ResourceIndicator | INTEGER (0..15) | OPTIONAL, -- Need R |

| | |
|---|---|
| mcsAndTBS | INTEGER (0..31), |
| frequencyHoppingOffset | INTEGER (1.. maxNrofPhysicalResourceBlocks-1) |

OPTIONAL, -- Need R

| | |
|---|---|
| pathlossReferenceIndex | INTEGER (0..maxNrofPUSCH-PathlossReferenceRSs- |

1),
...

| | |
|---|---|
| } | OPTIONAL, -- Need R |

...
}

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 17, which is upper signaling, is “codebook” or “nonCodebook.”

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE may perform beam configuration for PUSCH transmission by using pucch-spatialRelationlnfoID corresponding to a UE-specific PUCCH resource corresponding to the minimum ID inside an activated uplink BWP inside a serving cell, and the PUSCH transmission may be based on a single antenna port. The UE may not expect scheduling regarding PUSCH transmission through DCI format 0_0 inside a BWP having no configured PUCCH resource including pucch-spatialRelationlnfo. If the UE has no configured txConfig inside pusch-Config in Table 17, the UE does not expect scheduling through DCI format 0_1. [Table 17]

TABLE 17

| | |
|---|---|
| PUSCH-Config ::= | SEQUENCE { |

| | | |
|---|---|---|
| dataScramblingIdentityPUSCH | INTEGER (0..1023) | OPTIONAL, -- Need |

S

| | | |
|---|---|---|
| txConfig | ENUMERATED {codebook, nonCodebook} | OPTIONAL, |

-- Need S

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | | |
|---|---|---|
| pusch-PowerControl | PUSCH-PowerControl | OPTIONAL, -- Need M |

| | | |
|---|---|---|
| frequencyHopping | ENUMERATED {intraSlot, interSlot} | OPTIONAL, - |

- Need S

| | |
|---|---|
| frequencyHoppingOffsetLists | SEQUENCE (SIZE (1..4)) OF INTEGER (1.. |

maxNrofPhysicalResourceBlocks-1)
OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |

| TimeDomainResourceAllocationList } | OPTIONAL, -- Need M | |
|---|---|---|
| pusch-AggregationFactor | ENUMERATED { n2, n4, n8 } | OPTIONAL, -- |

Need S

| | | |
|---|---|---|
| mcs-Table | ENUMERATED {qam256, qam64LowSE} | OPTIONAL, - |

- Need S

| | |
|---|---|
| mcs-Table TransformPrecoder | ENUMERATED {qam256, qam64LowSE} |

OPTIONAL, -- Need S

| | | |
|---|---|---|
| transformPrecoder | ENUMERATED {enabled, disabled} | OPTIONAL, -- |

Need S

| | |
|---|---|
| codebookSubset | ENUMERATED {fullyAndPartialAndNonCoherent, |

partialAndNonCoherent,nonCoherent}
OPTIONAL, -- Cond codebookBased

| | | |
|---|---|---|
| maxRank | INTEGER (1..4) | OPTIONAL, -- Cond codebookBased |

| | | |
|---|---|---|
| rbg-Size | ENUMERATED { config2} | OPTIONAL, -- Need S |
| uci-OnPUSCH | SetupRelease { UCI-OnPUSCH} | OPTIONAL, -- Need |

M

| | | |
|---|---|---|
| tp-pi2BPSK | ENUMERATED {enabled} | OPTIONAL, -- Need S |

...
}

Hereinafter, codebook-based PUSCH transmission will be described. The codebook-based PUSCH transmission may be dynamically scheduled through DCI format 0_0 or 0_1, and may be semi-statically operated by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be indicated through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI may refer to the SRS resource corresponding to the SRI, among SRS resources transmitted prior to the PDCCH including the corresponding SRI. The TPMI and the transmission rank may be given through “precoding information and number of layers” (a field inside DCI) or configured through precodingAndNumberOfLayers (upper signaling). The TPMI may be used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission may be selected from an uplink codebook having the same number of antenna ports as the value of nrofSRS-Ports inside SRS-Config (upper signaling). In connection with codebook-based PUSCH transmission, the UE may determine a codebook subset, based on codebookSubset inside pusch-Config (upper signaling) and TPMI. The codebookSubset inside pusch-Config (upper signaling) may be configured to be one of “fullyAndPartialAndNonCoherent,” “partialAndNonCoherent,” or “noncoherent,” based on UE capability reported by the UE to the base station. If the UE reported “partialAndNonCoherent” as UE capability, the UE may not expect that the value of codebookSubset (upper signaling) may be configured as “fullyAndPartialAndNonCoherent.” In addition, if the UE reported “nonCoherent” as UE capability, UE may not expect that the value of codebookSubset (upper signaling) may be configured as “fullyAndPartialAndNonCoherent” or “partialAndNonCoherent.” If nrofSRS-Ports inside SRS-ResourceSet (upper signaling) indicates two SRS antenna ports, the UE does not expect that the value of codebookSubset (upper signaling) may be configured as “partialAndNonCoherent.”

The UE may have one SRS resource set configured therefor, wherein the value of usage inside SRS-ResourceSet (upper signaling) is “codebook,” and one SRS resource may be indicated through an SRI inside the corresponding SRS resource set. If multiple SRS resources are configured inside the SRS resource set wherein the value of usage inside SRS-ResourceSet (upper signaling) is “codebook,” the UE expects that the value of nrofSRS-Ports inside SRS-Resource (upper signaling) is identical for all SRS resources.

The UE may transmit, to the base station, one or multiple SRS resources included in the SRS resource set wherein the value of usage is configured as “codebook” according to upper signaling, and the base station may select one from the SRS resources transmitted by the UE and instructs/indicates the UE to transmit a PUSCH by using transmission beam information of the corresponding SRS resource. In connection with the codebook-based PUSCH transmission, the SRI may be used as information for selecting the index of one SRS resource, and may be included in DCI. Additionally, the base station may add information indicating the rank and TPMI to be used by the UE for PUSCH transmission to the DCI. Using the SRS resource indicated by the SRI, the UE may apply, in performing PUSCH transmission, the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be semi-statically operated by a configured grant. If at least one SRS resource is configured inside an SRS resource set wherein the value of usage inside SRS-ResourceSet (upper signaling) is “nonCodebook,” non-codebook-based PUSCH transmission may be scheduled for the UE through DCI format 0_1.

With regard to the SRS resource set wherein the value of usage inside SRS-ResourceSet (upper signaling) is “nonCodebook,” one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE may not expect that information regarding the precoder for SRS transmission may be updated.

If the configured value of resourceType inside SRS-ResourceSet (upper signaling) is “aperiodic,” the connected NZP CSI-RS may be indicated by an SRS request which is a field inside DCI format 0_1 or 1_1. If the connected NZP CSI-RS resource is an aperiodic NZP CSI-RS resource, the existence of the connected NZP CSI-RS may be indicated with regard to the case in which the value of SRS request (a field inside DCI format 0_1 or 1_1) is not “00.” The corresponding DCI may not indicate cross carrier or cross BWP scheduling. In addition, if the value of SRS request indicates the existence of a NZP CSI-RS, the NZP CSI-RS may be located in the slot used to transmit the PDCCH including the SRS request field. In this case, TCI states configured for the scheduled subcarrier may not be configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE may not expect that spatialRelationInfo which is upper signaling regarding the SRS resource and associatedCSI-RS inside SRS-ResourceSet (upper signaling) may be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE may occupy the same RB. The UE may configure one SRS port for each SRS resource. There may be only one configured SRS resource set wherein the value of usage inside SRS-ResourceSet (upper signaling) is “nonCodebook,” and a maximum of four SRS resources may be configured for non-codebook-based PUSCH transmission.

The base station may transmit one NZP-CSI-RS connected to the SRS resource set to the UE, and the UE may calculate the precoder to be used when transmitting one or multiple SRS resources inside the corresponding SRS resource set, based on the result of measurement when the corresponding NZP-CSI-RS is received. The UE may apply the calculated precoder when transmitting, to the base station, one or multiple SRS resources inside the SRS resource set wherein the configured usage is “nonCodebook,” and the base station may select one or multiple SRS resources from the received one or multiple SRS resources. In connection with the non-codebook-based PUSCH transmission, the SRI may indicate an index that may express one SRS resource or a combination of multiple SRS resources. The number of SRS resources indicated by the SRI transmitted by the base station may be the number of transmission layers of the PUSCH, and the UE may transmit the PUSCH by applying the precoder applied to SRS resource transmission to each layer.

### [PUSCH: Regarding Transmission Power]

As an embodiment of the disclosure, a method of, when uplink data is transmitted through an uplink data channel (physical uplink shared channel, PUSCH) in response to a power control command received from a base station, configuring the transmission power of the uplink data channel and transmitting same by a UE will be described. Uplink data channel transmission power of the UE in a PUSCH power control adjustment state corresponding to the i-th transmission unit, parameter set configuration index j, and closed loop index l may be determined as Equation 4 below represented by a unit of dBm. In Equation 4 below, when the UE supports multiple carrier frequencies in multiple cells, each parameter may be determined by cell c, carrier frequency f, and bandwidth part b, and may be distinguished by the indexes b, f, and c.

$$[ Equation 4 ]$$

$${P}_{PUSCH , b , f , c} ( i , j , {q}_{d} , l ) = min {\{ \begin{matrix}{P}_{CMAX , f , c} ( i ) , \\ {P}_{{0}_{PUSCH} , b , f , c} ( j ) + 10 {log}_{10} ( {2}^{μ} * {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \} [ dBm ]}_{-} ( CMAX , f , \text{?} :$$

$$\text{?} \text{indicates text missing or illegible when filed}$$

This is maximum transmission power usable by the UE in the i-th transmission unit, and may be determined by the power class of the UE, and parameters activated by the base station and various parameters embedded in the UE.
P_{O}_{_{PUSCH}}_{,b,f,c}(j): P_{O}_{_{PUSCH}}_{,b,f,c}(j) is configured by the sum of

$${P}_{{0}_{{NOMINAL}_{PUSCH}} , f , c} ( j ) and {P}_{{0}_{{UE}_{PUSCH}} , b , f , c} ( j ) \cdot {P}_{{0}_{{NOMINAL}_{PUSCH}} , f , c} ( j )$$

may be configured for the UE through cell-specific higher layer signaling, and

$${P}_{{0}_{{UE}_{PUSCH}} , b , f , c} ( j )$$

may be a value configured through UE-specific higher layer signaling.

$${P}_{{0}_{{UE}_{PUSCH}} , b , f , c} ( j )$$

may indicate a PUSCH for transmitting msg3 when j=0, indicate a configured grant PUSCH when j=1, and indicate a grant PUSCH when j is one value of {2, . . . , J−1}.
μ: Subcarrier spacing configuration value.
M_{RB,b,f,c}^{PSUCH}(i): This may indicate a resource amount (e.g., the number of resource blocks (RBs) used for PUSCH transmission on the frequency axis) used in the i-th PUSCH transmission unit.
α_{b,f,c}(j): This is a value for compensating for a pathloss, and may indicate a value that may be determined through a higher layer configuration and an SRS resource indicator (SRI) (in a case of a dynamic grant PUSCH).
PL_{b,f,c}(q_{d}): This represents a pathloss between the base station and the UE, and the UE may calculate a pathloss from the difference between the transmission power of a reference signal (RS) resource q_{d} signaled by the base station and the UE reception signal level of a reference signal. This equation denotes a downlink pathloss estimation estimated by the UE through a reference signal having a reference signal index of q_{d}, and the reference signal index q_{d} may be determined by the UE through a higher layer configuration and an SRI (in a case of a dynamic grant PUSCH or a configured grant PUSCH (type 2 configured grant PUSCH) based on ConfiguredGrantConfig not including the higher layer configuration rrc-ConfiguredUplinkGrant) or through a higher layer configuration.
Δ_{TF,b,f,c}(i): This may indicate a value determined according to a modulation coding scheme (MCS) and a format (transport format (TF), e.g., whether UL-SCH is included or whether CSI is included) of information transmitted through a PUSCH.
f_{b,f,c}(i,l): This is a closed loop power control adjustment value, and may indicate a value of closed loop index 1 which may be determined for a PUSCH by a higher layer configuration and an SRI. Closed loop power adjustment for PUSCH transmission may be supported by an accumulation method of accumulating and applying a value indicated by a TPC command, or an absolute method of directly applying a value indicated by a TPC command, and the above method may be determined according to whether the higher layer parameter tpc-Accumulation is configured. If the higher layer parameter tpc-Accumulation is configured to be disabled, closed loop power adjustment for PUSCH transmission may be performed by the absolute method, and if tpc-Accumulation is not configured, closed loop power adjustment for PUSCH transmission may be performed by the accumulation method.

The PUSCH power control adjustment state f_{b,f,c}(i,l) may be determined through bandwidth part b, carrier frequency f, cell c, the i-th transmission unit, and closed loop index 1.
δ_{PUSCH,b,f,c}(i,l): This may be a value indicated by a TPC command field included in DCI format 0_0, 0_1, or 0_2 scheduling the i-th PUSCH transmission unit corresponding to closed loop index 1 in bandwidth part b, carrier frequency f, and cell c, or may be a value indicated by a TPC command field included in DCI format 2_2 transmitted together with a CRC scrambled with a TPC-PUSCH-RNTI.
   If the higher layer signaling twoPUSCH-PC-AdjustmentStates is configured for the UE, closed loop index 1 may have a value of 0 or 1.
   If the higher layer signaling twoPUSCH-PC-AdjustmentStates is not configured for the UE or a PUSCH transmission based on a RAR UL grant is scheduled thereto, closed loop index 1 may have a value of 0.
      If the higher layer signaling ConfiguredGrantConfig is configured for the UE and the UE performs a PUSCH transmission or retransmission therefor, closed loop index 1 may follow the value of the higher layer signaling powerControlLoopToUse.
      If the higher layer signaling SRI-PUSCH-PowerControl is configured for the UE, the UE may obtain a connection relation between a value indicated by an SRS resource indicator (SRI) field in a DCI format scheduling a PUSCH transmission and closed loop index 1 configured through the higher layer signaling sri-PUSCH-ClosedLoopIndex. The UE may determine closed loop index 1 according to the value indicated by the SRI field in the DCI format, based on the connection relation.
      If a PUSCH transmission is scheduled to the UE, based on a DCI format not including an SRI field, or the higher layer signaling SRI-PUSCH-PowerControl is not configured therefor, the UE may consider or determine closed loop index 1 to be 0.
      If a TPC command value is indicated to the UE through a TPC command field included in DCI format 2_2 transmitted together with a CRC scrambled with a TPC-PUSCH-RNTI, closed loop index 1 may be indicated through a closed loop index field included in DCI format 2_2.
If the higher layer signaling tpc-Accumulation is not configured for the UE (e.g., if a TPC command accumulation operation for the UE is possible), the PUSCH power control adjustment state f_{b,f,c}(i,l) for the i-th PUSCH transmission unit corresponding to closed loop index 1 in bandwidth part b, carrier frequency f, and cell c may be calculated as shown in Equation 5.

$${f}_{b , f , c} ( i , l ) = {f}_{b , f , c} ( i - {i}_{0} , l ) + {\sum }_{m = 0}^{c ( {D}_{i} ) - 1} {δ}_{PUSCH , b , f , c} ( m , l ) . \qquad [ Equation 5 ]$$

δ_{PUSCH,b,f,c}(m,l) may be, as described above, a value indicated by a TPC command field included in DCI format 0_0, 0_1, or 0_2 scheduling the m-th PUSCH transmission unit corresponding to closed loop index 1 in bandwidth part b, carrier frequency f, and cell c, or may be a value indicated by a TPC command field included in DCI format 2_2 transmitted together with a CRC scrambled with a TPC-PUSCH-RNTI. If a TPC command accumulation operation is possible, a value of δ_{PUSCH,b,f,c} may be a corresponding value in a unit of [dB] according to a value which a TPC command field included in DCI format 0_0, 0_1, 0_2, or 2_2 is indicated to be, as shown in Table 18 below. For example, if the value of the TPC command field is 0, δ_{PUSCH,b,f,c} may have a value of −1 dB.
Σₘ₌₀^{c(D}^{ᵢ}⁾⁻¹δ_{PUSCH,b,f,c}(m,l) may indicate the sum of δ_{PUSCH,b,f,c} for all corresponding transmission units in the particular set Dᵢ according to the above TPC command value. c(Dᵢ) may indicate the number of all elements belonging to the set Dᵢ. Dᵢ may indicate a set of pieces of DCI including all TPC command values for which a TPC command accumulation operation is to be performed for the i-th PUSCH transmission unit. In order to determine Dᵢ, the UE may define a start point and an end point on the time dimension and include all the pieces of DCI received by the UE between the two points as the elements of Dᵢ.
The end point for determining Dᵢ may be a point before K_{PUSCH} (i) symbols from the starting symbol of the i-th PUSCH transmission unit.
The start point for determining Dᵢ may be a point before K_{PUSCH}(i−i₀)−1 symbols from the starting symbol of the (i−i0)-th PUSCH transmission unit. i₀, which is a positive integer, may be determined to be the smallest value satisfying that a time point before K_{PUSCH}(i−i0) symbols from the starting symbol of the (i−i_0)-th PUSCH transmission unit is earlier, in time, than the end point for determining Dᵢ(e.g., a point before K_{PUSCH} (i) symbols from the starting symbol of the i-th PUSCH transmission unit).
For example, if the end point for determining Dᵢ is definable to be sym(i), the time point before K_{PUSCH}(i−i0) symbols from the starting symbol of the (i−i_0)-th PUSCH transmission unit is definable to be sym(i−i0), and sym(i)=sym(i−1)>sym(i−2)>sym(i−3) is satisfied, i0 may be determined to be 2.
If the higher layer signaling tpc-Accumulation is configured for the UE (e.g., if a TPC command accumulation operation for the UE is impossible), the PUSCH power control adjustment state f_{b,f,c} (i,l) for the i-th PUSCH transmission unit corresponding to closed loop index 1 in bandwidth part b, carrier frequency f, and cell c may be calculated as shown in Equation 6.

$${f}_{b , f , c} ( i , l ) = {δ}_{PUSCH , b , f , c} ( i , l ) . \qquad [ Equation 6 ]$$

δ_{PUSCH,b,f,c}(i,l) may be, as described above, a value indicated by a TPC command field included in DCI format 0_0, 0_1, or 0_2 scheduling the i-th PUSCH transmission unit corresponding to closed loop index 1 in bandwidth part b, carrier frequency f, and cell c, or may be a value indicated by a TPC command field included in DCI format 2_2 transmitted together with a CRC scrambled with a TPC-PUSCH-RNTI. If a TPC command accumulation operation is impossible, a value of δ_{PUSCH,b,f,c} may be a corresponding value in a unit of [dB] according to a value which a TPC command field included in DCI format 0_0, 0_1, 0_2, or 2_2 is indicated to be, as shown in Table 18 below. For example, if the value of the TPC command field is 0, δ_{PUSCH,b,f,c} may have a value of −4 dB.

TABLE 18

| | Accumulated | Absolute |
|---|---|---|
| TPC | δ_{PUSCH, b, f, c} | δ_{PUSCH, b, f, c} |
| command field | [dB] | [dB] |
| 0 | −1 | −4 |
| 1 | 0 | −1 |
| 2 | 1 | 1 |
| 3 | 3 | 4 |

### [Regarding SRS]

Next, an uplink channel estimation method using sounding reference signal (SRS) transmission of a UE will be described. The base station may configure at least one SRS configuration with regard to each uplink BWP in order to transfer configuration information for SRS transmission to the UE, and may also configure as least one SRS resource set with regard to each SRS configuration. As an example, the base station and the UE may exchange upper signaling information as follows, in order to transfer information regarding the SRS resource set:
srs-ResourceSetId: an SRS resource set index;
srs-ResourceldList: a set of SRS resource indices referred to by SRS resource sets;
resourceType: time domain transmission configuration of SRS resources referred to by SRS resource sets, and may be configured as one of “periodic,” “semi-persistent,” and “aperiodic.” If configured as “periodic” or “semi-persistent,” associated CSI-RS information may be provided according to the place of use of SRS resource sets. If configured as “aperiodic,” an aperiodic SRS resource trigger list/slot offset information may be provided, and associated CSI-RS information may be provided according to the place of use of SRS resource sets;
usage: a configuration regarding the place of use of SRS resources referred to by SRS resource sets, and may be configured as one of “beamManagement,” “codebook,” “nonCodebook,” and “antennaSwitching”; and/or
alpha, p0, pathlossReferenceRS, srs-PowerControlAdjustmentStates: provides a parameter configuration for adjusting the transmission power of SRS resources referred to by SRS resource sets.

The UE may understand that an SRS resource included in a set of SRS resource indices referred to by an SRS resource set follows the information configured for the SRS resource set.

In addition, the base station and the UE may transmit/receive upper layer signaling information in order to transfer individual configuration information regarding SRS resources. As an example, the individual configuration information regarding SRS resources may include time-frequency domain mapping information inside slots of the SRS resources, and this may include information regarding intra-slot or inter-slot frequency hopping of the SRS resources. The individual configuration information regarding SRS resources may include time domain transmission configuration of SRS resources, and may be configured as one of “periodic,” “semi-persistent,” and “aperiodic” The time domain transmission configuration of SRS resources may be limited to have the same time domain transmission configuration as the SRS resource set including the SRS resources. If the time domain transmission configuration of SRS resources is configured as “periodic” or “semi-persistent,” the time domain transmission configuration may further include an SRS resource transmission cycle and a slot offset (for example, periodicityAndOffset).

The base station may activate or deactivate SRS transmission for the UE through upper layer signaling including RRC signaling or MAC CE signaling, or L1 signaling (for example, DCI). For example, the base station may activate or deactivate periodic SRS transmission for the UE through upper layer signaling. The base station may indicate activation of an SRS resource set having resourceType configured as “periodic” through upper layer signaling, and the UE may transmit the SRS resource referred to by the activated SRS resource set. Intra-slot time-frequency domain resource mapping of the transmitted SRS resource follows resource mapping information configured for the SRS resource, and slot mapping, including the transmission cycle and slot offset, follows periodicityAndOffset configured for the SRS resource. In addition, the spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the uplink BWP activated with regard to the periodic SRS resource activated through upper layer signaling.

For example, the base station may activate or deactivate semi-persistent SRS transmission for the UE through upper layer signaling. The base station may indicate activation of an SRS resource set through MAC CE signaling, and the UE may transmit the SRS resource referred to by the activated SRS resource set. The SRS resource set activated through MAC CE signaling may be limited to an SRS resource set having resourceType configured as “semi-persistent.” Intra-slot time-frequency domain resource mapping of the transmitted SRS resource follows resource mapping information configured for the SRS resource, and slot mapping, including the transmission cycle and slot offset, follows periodicityAndOffset configured for the SRS resource. In addition, the spatial domain transmission filter applied to the transmitted SRS resource may refer to spatial relation info configured for the SRS resource, or may refer to associated CSI-RS information configured for the SRS resource set including the SRS resource. If the SRS resource has spatial relation info configured therefor, the spatial domain transmission filter may be determined, without following the same, by referring to configuration information regarding spatial relation info transferred through MAC CE signaling that activates semi-persistent SRS transmission. The UE may transmit the SRS resource inside the uplink BWP activated with regard to the semi-persistent SRS resource activated through upper layer signaling.

For example, the base station may trigger aperiodic SRS transmission by the UE through DCI. The base station may indicate one of aperiodic SRS triggers (aperiodicSRS-ResourceTrigger) through the SRS request field of DCI. The UE may understand that the SRS resource set including the aperiodic SRS resource trigger indicated through DCI in the aperiodic SRS resource trigger list, among configuration information of the SRS resource set, has been triggered. The UE may transmit the SRS resource referred to by the triggered SRS resource set. Intra-slot time-frequency domain resource mapping of the transmitted SRS resource may follow resource mapping information configured for the SRS resource. In addition, slot mapping of the transmitted SRS resource may be determined by the slot offset between the SRS resource and a PDCCH including DCI, and this may refer to value(s) included in the slot offset set configured for the SRS resource set. Specifically, as the slot offset between the SRS resource and the PDCCH including DCI, a value indicated in the time domain resource assignment field of DCI, among offset value(s) included in the slot offset set configured for the SRS resource set, may be applied. In addition, the spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the uplink BWP activated with regard to the aperiodic SRS resource triggered through DCI.

If the base station triggers aperiodic SRS transmission by the UE through DCI, a minimum time interval may be necessary between the transmitted SRS and the PDCCH including the DCI that triggers aperiodic SRS transmission, in order for the UE to transmit the SRS by applying configuration information regarding the SRS resource. The time interval for SRS transmission by the UE may be defined as the number of symbols between the last symbol of the PDCCH including the DCI that triggers aperiodic SRS transmission and the first symbol mapped to the first transmitted SRS resource among transmitted SRS resource(s). The minimum time interval may be determined with reference to the PUSCH preparation procedure time needed by the UE to prepare PUSCH transmission. The minimum time interval may have a different value depending on the place of use of the SRS resource set including the transmitted SRS resource. For example, the minimum time interval may be determined as N2 symbols defined in consideration of UE processing capability that follows the UE's capability with reference to the UE's PUSCH preparation procedure time. In addition, if the place of use of the SRS resource set is configured as “codebook” or “antennaSwitching” in view of the place of use of the SRS resource set including the transmitted SRS resource, the minimum time interval may be determined as N2 symbols, and if the place of use of the SRS resource set is configured as “nonCodebook” or “beamManagement,” the minimum time interval may be determined as N2+14 symbols. The UE may transmit an aperiodic SRS if the time interval for aperiodic SRS transmission is larger than or equal to the minimum time interval, and may ignore the DCI that triggers the aperiodic SRS if the time interval for aperiodic SRS transmission is smaller than the minimum time interval.

TABLE 19

| | |
|---|---|
| SRS-Resource ::= | SEQUENCE { |
| srs-ResourceId | , |
| nrofSRS-Ports | ENUMERATED {port1, ports2, ports4}, |
| ptrs-PortIndex | ENUMERATED {n0, n1 } |

OPTIONAL, -- Need R

| | |
|---|---|
| transmissionComb | CHOICE { |

| | |
|---|---|
| n2 | SEQUENCE { |

| | |
|---|---|
| combOffset-n2 | INTEGER (0..1), |
| cyclicShift-n2 | INTEGER (0..7) |

},

| | |
|---|---|
| n4 | SEQUENCE { |

| | |
|---|---|
| combOffset-n4 | INTEGER (0..3), |
| cyclicShift-n4 | INTEGER (0..11) |

```
    }
  },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |

| | |
|---|---|
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, |
| | groupHopping, quenceHopping }, |

| | |
|---|---|
| resourceType | CHOICE { |
| aperiodic | SEQUENCE { |

```
      ...
    },
```

| | |
|---|---|
| semi-persistent | SEQUENCE { |

| | |
|---|---|
| periodicityAndOffset-sp | SRS-PeriodicityAndOffset, |

```
      ...
    },
```

| | |
|---|---|
| periodic | SEQUENCE { |

| | |
|---|---|
| periodicityAndOffset-p | SRS-PeriodicityAndOffset, |

```
      ...
    }
  },
```

| | |
|---|---|
| sequenceId | INTEGER (0..1023), |

| | |
|---|---|
| spatialRelationInfo | SRS-SpatialRelationInfo |

OPTIONAL, -- Need R
...
}

Configuration information spatialRelationInfo in Table 19 above may be applied, with reference to one reference signal, to a beam used for SRS transmission corresponding to beam information of the corresponding reference signal. For example, configuration of spatialRelationInfo may include information as in Table 20 below. Obviously, the example given below is not limiting.

TABLE 20

| SRS-SpatialRelationInfo ::= SEQUENCE { | |
|---|---|
| servingCellId | ServCellIndex OPTIONAL, -- Need S |
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
    }
  }
}
```

Referring to the spatialRelationInfo configuration, an SS/PBCH block index, CSI-RS index, or SRS index may be configured as the index of a reference signal to be referred to in order to use beam information of a specific reference signal. Upper signaling referenceSignal corresponds to configuration information indicating which reference signal's beam information is to be referred to for corresponding SRS transmission, ssb-Index may refer to the index of an SS/PBCH block, csi-RS-Index may refer to the index of a CSI-RS, and srs may refer to the index of an SRS. If upper signaling referenceSignal has a configured value of “ssb-Index,” the UE may apply the reception beam which was used to receive the SS/PBCH block corresponding to ssb-Index as the transmission beam for the corresponding SRS transmission. If upper signaling referenceSignal has a configured value of “csi-RS-Index,” the UE may apply the reception beam which was used to receive the CSI-RS corresponding to csi-RS-Index as the transmission beam for the corresponding SRS transmission. If upper signaling referenceSignal has a configured value of “srs,” the UE may apply the reception beam which was used to transmit the SRS corresponding to srs as the transmission beam for the corresponding SRS transmission.

### [Regarding SRS Transmission Power]

As an embodiment of the disclosure, a method of, when a UE performs transmission through an uplink reference signal (sounding reference signal, SRS) in response to a power control command received from a base station, configuring the transmission power of the uplink reference signal and transmitting same by the UE will be described. Uplink reference signal transmission power (PSRS) of the UE in an SRS power control adjustment state corresponding to the i-th transmission unit and closed loop index l may be determined as Equation 7 below expressed by a unit of dBm. In Equation 7 below, when the UE supports multiple carrier frequencies in multiple cells, each parameter may be determined by cell c, carrier frequency f, and bandwidth part b, and may be distinguished by the indexes b,f, and c.

$$[ Equation 7 ]$$

$${P}_{SRS , b , f , c} ( i , {q}_{s} , l ) = min {\{ \begin{matrix}{P}_{CMAX , f , c} ( i ) , \\ {P}_{{0}_{SRS} , b , f , c} ( {q}_{s} ) + 10 {log}_{10} ( {2}^{μ} * {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix} \} [ dBm ]}_{-} ( CMAX , f , \text{?} :$$

$$\text{?} \text{indicates text missing or illegible when filed}$$

This is maximum transmission power usable by the UE in the i-th transmission unit, and may be determined by the power class of the UE, and parameters activated by the base station and various parameters embedded in the UE.
P_{O}_{_{SRS}}_{,b,f,c}(qₛ): This may be configured by the higher layer signaling p0 for bandwidth part b, carrier frequency f, and cell c, and the SRS resource set qₛ may be configured through the higher layer signalings SRS-ResourceSet and SRS-ResourceSetId.
μ: Subcarrier spacing configuration value.
M_{SRS,b,f,c}(i): This may indicate a resource amount (e.g., the number of resource blocks (RBs) used for SRS transmission on the frequency axis) used in the i-th SRS transmission unit.
α_{SRS,b,f,c}(j): This may be configured by the higher layer signaling alpha for bandwidth part b, carrier frequency f, and cell c, and the SRS resource set qₛ may be configured through the higher layer signalings SRS-ResourceSet and SRS-ResourceSetId.
PL_{b,f,c}(q_{d}): This represents a pathloss between the base station and the UE, and the UE may calculate a pathloss from the difference between the transmission power of a reference signal (RS) resource q_{d} signaled by the base station and the UE reception signal level of a reference signal.
h_{b,f,c}(i,l): This may indicate an SRS power control adjustment state value for the i-th SRS transmission unit corresponding to closed loop index 1 in bandwidth part b, carrier frequency f, and cell c.

The SRS power control adjustment state may be determined through bandwidth part b, carrier frequency f, cell c, and the i-th transmission unit.
If the UE is configured to have the same power control adjustment state value between SRS transmission and PUSCH transmission through the higher layer signaling srs-PowerControlAdjustmentStates, the SRS power control adjustment state may be represented as shown in Equation 8 below, and f_{b,f,c}(i,l) in Equation 8 may indicate a current PUSCH power control adjustment state. In this case, the UE may calculate f_{b,f,c}(i,l) through various methods of embodiment 1 described above, and substitute the value into h_{b,f,c}(i,l).

$${h}_{b , f , c} ( i , l ) = {f}_{b , f , c} ( i , l ) . \qquad [ Equation 8 ]$$

If the UE fails to be configured for PUSCH transmission in bandwidth part b, carrier frequency f, and cell c, the UE is configured to have different power control adjustment state values between SRS transmission and PUSCH transmission through the higher layer signaling srs-PowerControlAdjustmentStates, and the higher layer signaling tpc-Accumulation is not configured, an SRS power control adjustment state may be represented independently to closed loop 1 as shown in Equation 9 below.

$${h}_{b , f , c} ( i ) = {h}_{b , f , c} ( i - {i}_{0} ) + {\sum }_{m = 0}^{c ( {S}_{i} ) - 1} {δ}_{SRS , b , f , c} ( m ) . \qquad [ Equation 9 ]$$

δ_{SRS,b,f,c}(m): This may be a value indicated by a TPC command field included in DCI format 2_3, and the value may follow Table 17 above.
   Σₘ₌₀^{c(s}^{ᵢ}⁾⁻¹δ_{SRS,b,f,c}(m) may indicate the sum of δ_{SRS,b,f,c} for all corresponding transmission units in the particular set Sᵢ according to the above TPC command value. c(Sᵢ) may indicate the number of all elements belonging to the set Sᵢ. Sᵢ may indicate a set of pieces of DCI including all TPC command values for which a TPC command accumulation operation is to be performed for the i-th PUSCH transmission unit. In order to determine Sᵢ, the UE may define a start point and an end point on the time dimension and include all the pieces of DCI received by the UE between the two points as the elements of Sᵢ.
      The end point for determining Sᵢ may be a point before K_{SRS}(i) symbols from the starting symbol of the i-th SRS transmission unit.
      The start point for determining Sᵢ may be a point before K_{SRS}(i−i₀)−1 symbols from the starting symbol of the (i−i0)-th SRS transmission unit. i0, which is a positive integer, may be determined to be the smallest value satisfying that a time point before K_{SRS}(i−₀) symbols from the starting symbol of the (i−i0)-th SRS transmission unit is earlier, in time, than the end point for determining Sᵢ (e.g., a point before K_{SRS}(i) symbols from the starting symbol of the i-th SRS transmission unit).
      For example, if the UE may define the end point for determining Sᵢ to be sym(i) and define the time point before K_{SRS}(i−i₀) symbols from the starting symbol of the (i−i0)-th SRS transmission unit to be sym(i−i0), and sym(i)=sym(i−1)>sym(i−2)>sym(i−3) is satisfied, i0 may be determined to be 2.
If the UE fails to be configured for PUSCH transmission in bandwidth part b, carrier frequency f, and cell c, or the UE is configured to have different power control adjustment state values between SRS transmission and PUSCH transmission through the higher layer signaling srs-PowerControlAdjustmentStates, and the higher layer signaling tpc-Accumulation is configured (e.g., the UE is unable to perform a TPC command accumulation operation and an absolute TCP command value is applicable), an SRS power control adjustment state may be represented independently to closed loop 1 as shown in Equation 10 below.

$${h}_{b , f , c} ( i ) = {δ}_{SRS , b , f , c} ( i ) . \qquad [ Equation 10 ]$$

δ_{SRS,b,f,c}(i) may be, as described above, a value indicated by a TPC command field included in DCI format 2_3 in bandwidth part b, carrier frequency f, and cell c, and the value may follow Table 18 above. For example, if the value of the TPC command field is 0, δ_{SRS,b,f,c} may have a value of −4 dB.

### [Regarding UE Capability Report]

In LTE and NR, a UE may perform a procedure in which, while being connected to a serving base station, the UE may report capability supported by the UE to the corresponding base station. In the following description, the above-described procedure will be referred to as a UE capability report.

The base station may transfer a UE capability enquiry message to the UE in a connected state so as to request a capability report. The message may include a UE capability request with regard to each radio access technology (RAT) type of the base station. The RAT type-specific request may include supported frequency band combination information and the like. In addition, in the case of the UE capability enquiry message, UE capability with regard to multiple RAT types may be requested through one RRC message container transmitted by the base station, or the base station may transfer a UE capability enquiry message including multiple UE capability requests with regard to respective RAT types. That is, a capability enquiry may be repeated multiple times in one message, and the UE may configure a UE capability information message corresponding thereto and report the same multiple times. In next-generation mobile communication systems, a UE capability request may be made regarding multi-RAT dual connectivity (MR-DC), such as NR, LTE, E-UTRA-NR dual connectivity (EN-DC). The UE capability enquiry message may be transmitted initially after the UE is connected to the base station, in general, but may be requested in any condition if needed by the base station.

According to an embodiment, upon receiving the UE capability report request from the base station, the UE may configure UE capability according to band information and RAT type requested by the base station. The method in which the UE configures UE capability in an NR system is summarized below.

1. If the UE receives a list regarding LTE and/or NR bands from the base station at a UE capability request, the UE may construct band combinations (BCs) regarding EN-DC and NR standalone (SA). That is, the UE may configure a candidate list of BCs regarding EN-DC and NR SA, based on bands received from the base station at a request through FreqBandList. In addition, bands may have priority in the order described in FreqBandList.

2. If the base station has set “eutra-nr-only” flag or “eutra” flag and requested a UE capability report, the UE may remove everything related to NR SA BCs from the configured BC candidate list. Such an operation may occur only if an LTE base station (eNB) requests “eutra” capability.

3. The UE may then remove fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same can be omitted. This step may be applied in MR-DC as well, that is, LTE bands may also be applied. BCs remaining after the above step may constitute the final “candidate BC list.”

4. The UE may select BCs appropriate for the requested RAT type from the final “candidate BC list” and select BCs to report. In this step, the UE may configure supportedBandCombinationList in a determined order. That is, the UE may configure BCs and UE capability to report according to a preconfigured rat-Type order. (nr->eutra-nr->eutra). In addition, the UE may configure featureSetCombination regarding the configured supportedBandCombinationList and configures a list of “candidate feature set combinations” from a candidate BC list from which a list regarding fallback BCs (including capability of the same or lower step) is removed. The “candidate feature set combinations” may include all feature set combinations regarding NR and EUTRA-NR BCs, and may be acquired from feature set combinations of containers of UE-NR-Capabilities and UE-MRDC-Capabilities.

5. If the requested RAT type is eutra-nr and has an influence, featureSetCombinations may be included on both containers of UE-MRDC-Capabilities and UE-NR-Capabilities. However, the feature set of NR may be included only in UE-NR-Capabilities.

After the UE capability is configured, the UE may transfer a UE capability information message including the UE capability to the base station. The base station may perform scheduling and transmission/reception management appropriate for the UE, based on the UE capability received from the UE.

### [Regarding NC-JT]

According to an embodiment of the disclosure, non-coherent joint transmission (NC-JT) may be used to enable a UE to receive a PDSCH from multiple TRPs.

Unlike conventional systems, a 5G wireless communication system may not only support a service requiring high data rate, but also a service having very short transmission delay and a service requiring high connection density. In a wireless communication network including multiple cells, transmission and reception points (TRPs), or beams, cooperative communication (coordinated transmission) between cells, TRPs, and/or beams may increase the strength of a signal received by a UE or efficiently perform interference control between cells, TRPs, and/or beams so as to satisfy various service requirements.

Joint transmission (JT) is a representative transmission technology for cooperative communication described above, and transmits a signal to one UE through multiple different cells, TRPs, and/or beams so as to increase the processing rate or the strength of the signal received by the UE. Channels between each cell, TRP, and/or beam and the UE may have large difference in the characteristic thereof. Particularly, in a case of non-coherent joint transmission (NC-JT) supporting non-coherent precoding between cells, TRPs, and/or beams, individual precoding, MCS, resource allocation, and TCI indication may be required according to a channel characteristic for each link between the UE and each cell, TRP, and/or beam.

NC-JT described above may be applied to at least one channel among a downlink data channel (PDSCH), a downlink control channel (PDCCH), an uplink data channel (PUSCH), and an uplink control channel (PUCCH). At the time of PDSCH transmission, transmission information, such as precoding, an MCS, resource allocation, and a TCI, is indicated through DL DCI, and the transmission information is required to be independently indicated for each cell, TRP, and/or beam for NC-JT. This is a main reason of increasing a payload required for DL DCI transmission and may adversely affect the reception performance of a PDCCH transmitting DCI. Therefore, in order to support JT of a PDSCH, careful design of the tradeoff between the amount of DCI information and the reception performance of control information is necessary.

FIG. 10 illustrates an example of an antenna port configuration and resource allocation for transmitting a PDSCH by using cooperative communication in a wireless communication system according to an embodiment of the disclosure.

Referring to FIG. 10, an example for PDSCH transmission is described for each joint transmission (JT) technique, and embodiments for allocating a wireless resource for each TRP are illustrated.

Referring to FIG. 10, an example 1000 for coherent joint transmission (C-JT) supporting coherent precoding between cells, TRPs, and/or beams is illustrated.

In a case of C-JT, TRP A 1005 and TRP B 1010 transmit single data (PDSCH) to a UE 1015, and multiple TRPs may perform joint precoding. This may imply that a DMRS is transmitted through the same DMRS ports to allow TRP A 1005 and TRP B 1010 to transmit the same PDSCH. For example, each of TRP A 1005 and TRP B 1010 may transmit a DMRS to the UE through DMRS port A and DMRS B. In this case, the UE may receive one piece of DCI information for receiving one PDSCH demodulated based on the DMRS transmitted through DMRS port A and DMRS B.

FIG. 10 illustrates an example 1020 of non-coherent joint transmission (NC-JT) supporting non-coherent precoding between cells, TRPs, and/or beams for PDSCH transmission.

In a case of NC-JT, respective cells, TRPs, and/or beams transmit PDSCHs to a UE 1035, and individual precoding may be applied to each PDSCH. Respective cells, TRPs, and/or beams may transmit different PDSCHs or different PDSCH layers to the UE so as to improve a processing rate compared to single cell, TRP, and/or beam transmission. In addition, respective cells, TRPs, and/or beams may repeat transmission of the same PDSCH to the UE so as to improve reliability compared to single cell, TRP, and/or beam transmission. For convenience of explanation, hereinafter, a cell, TRP, and/or beam is collectively called a TRP.

Various wireless resource allocations may be considered, such as a case 1040 where frequency and time resources used in multiple TRPs for PDSCH transmission are all the same, a case 1045 where frequency and time resources used in multiple TRPs do not overlap at all, and a case 1050 where some of frequency and time resources used in multiple TRPs overlap.

For NC-JT support, pieces of DCI having various types, structures, and relations may be considered to simultaneously allocate multiple PDSCHs to one UE.

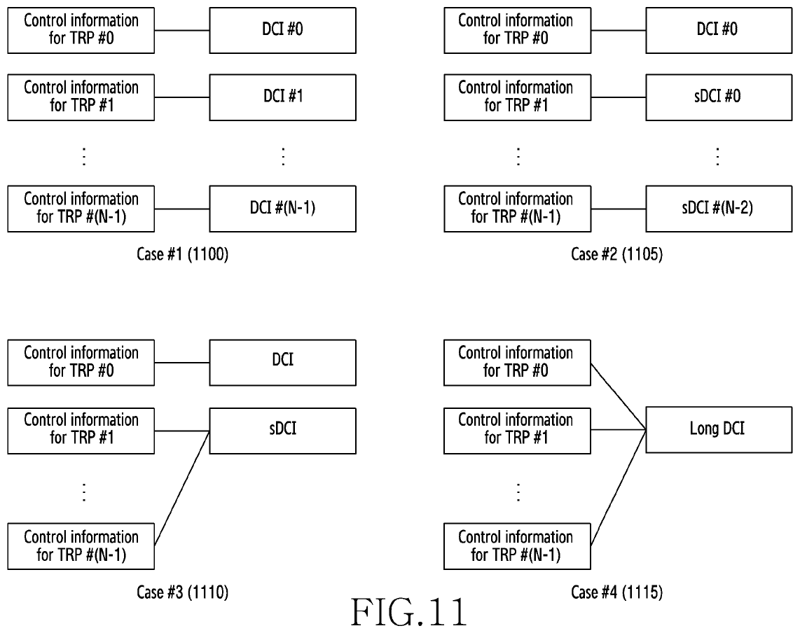

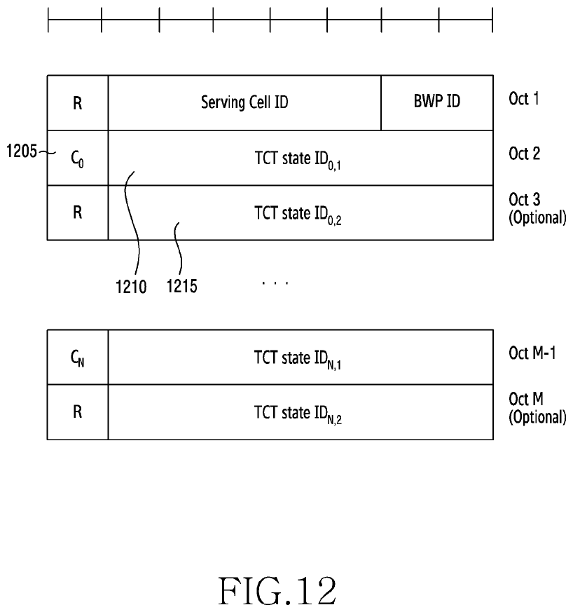

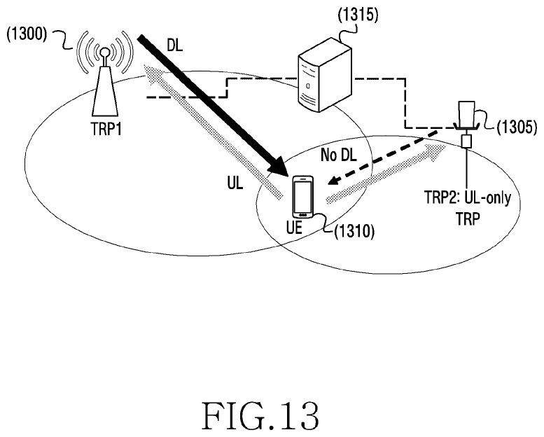

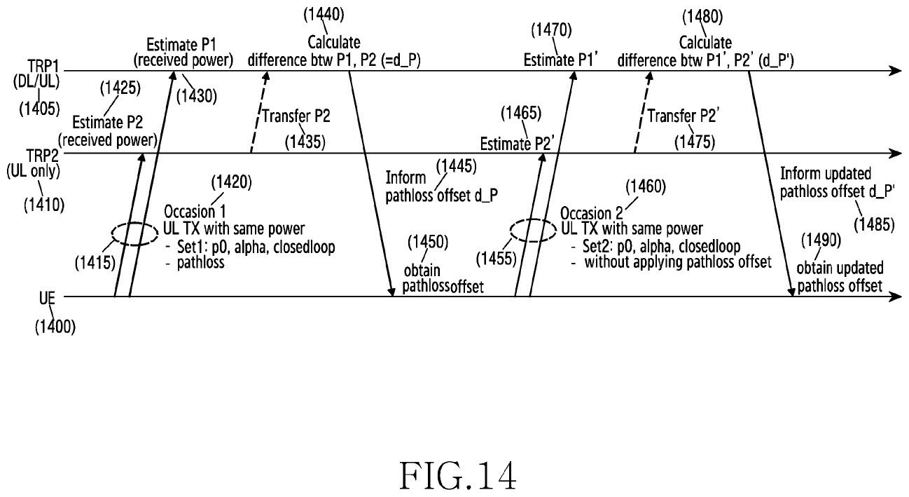

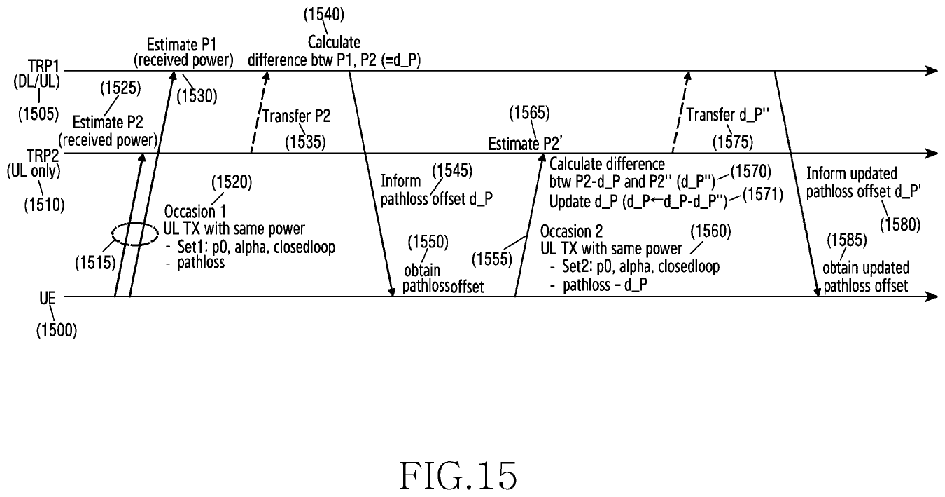

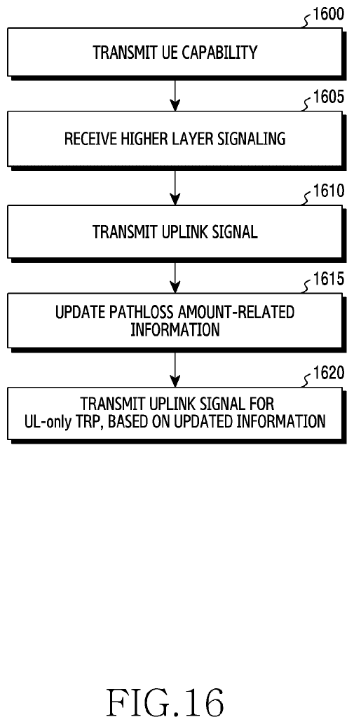

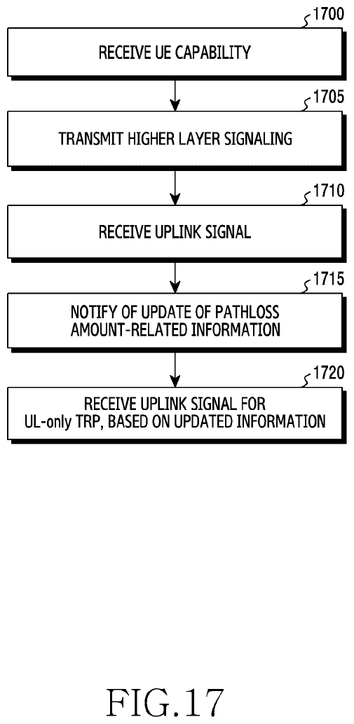

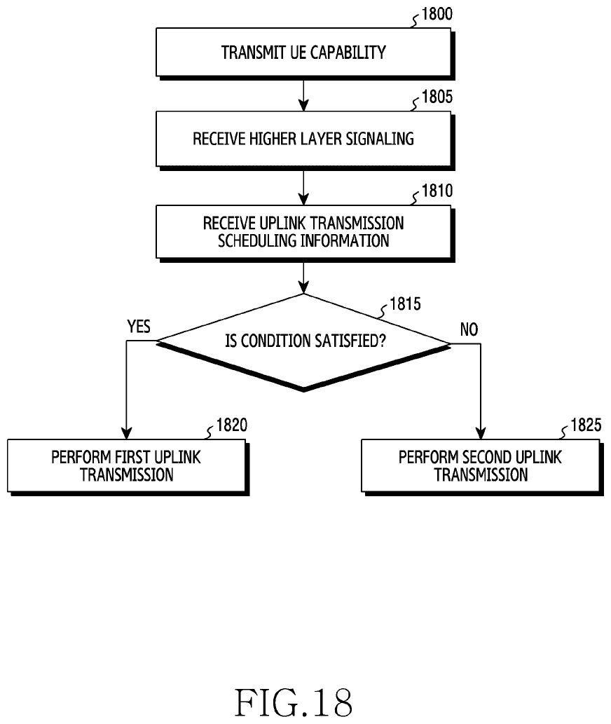

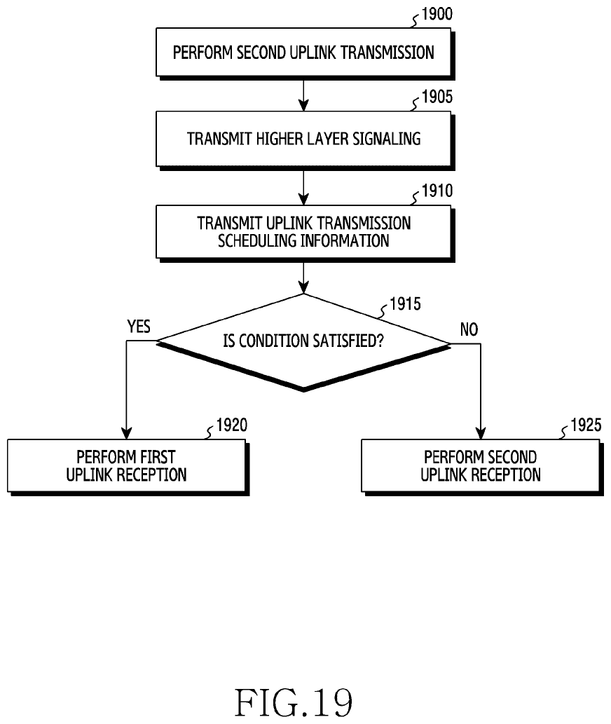

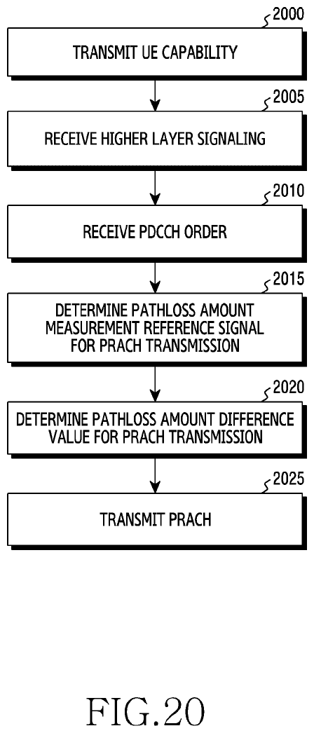

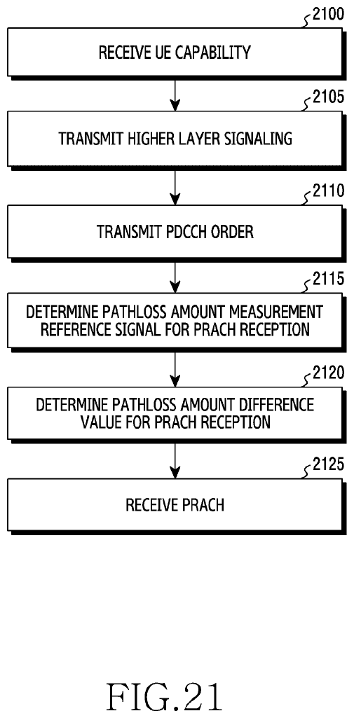

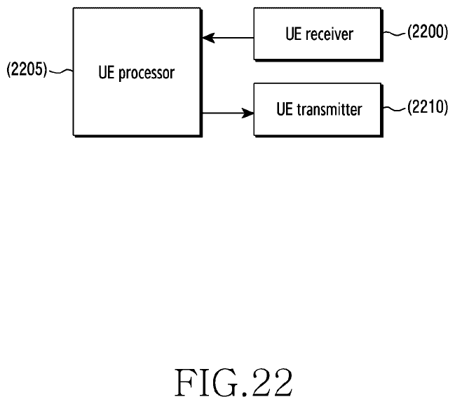

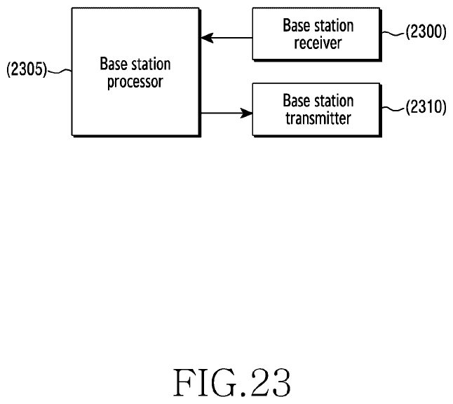

FIG. 11 illustrates an example of a configuration of downlink control information (DCI) for cooperative communication in a wireless communication system according to an embodiment of the disclosure.

Referring to FIG. 11, a configuration of downlink control information (DCI) for NC-JT wherein respective TRPs transmit different PDSCHs or different PDSCH layers to a UE in a wireless communication system according to an embodiment of the disclosure is illustrated.

Referring to FIG. 11, case #1 1100 is an example in which, in a situation where different (N−1) number of PDSCHs are transmitted from additional (N−1) number of TRPs (TRP #1 to TRP #(N−1)) other than a serving TRP (TRP #0) used at the time of single PDSCH transmission, control information for the PDSCHs transmitted from the additional (N−1) number of TRPs is transmitted independently of control information for a PDSCH transmitted from the serving TRP. That is, a UE may obtain control information for PDSCHs transmitted from different TRPs (TRP #0 to TRP #(N−1)) through independent pieces of DCI (DCI #0 to DCI #(N−1)). The formats of the independent pieces of DCI may be identical to or different from each other, and the payloads of the pieces of DCI may also be identical to or different from each other. In case #1 described above, a degree of freedom for each PDSCH control or allocation may be completely ensured, but when pieces of DCI are transmitted from different TRPs, there occurs a difference in coverage between the pieces of DCI and thus reception performance may be degraded.

Case #2 1105 shows that, in a situation where different (N−1) number of PDSCHs are transmitted from additional (N−1) number of TRPs (TRP #1 to TRP #(N−1)) other than a serving TRP (TRP #0) used at the time of single PDSCH transmission, pieces of control information (DCI) for the PDSCHs of the additional (N−1) number of TRPs are transmitted respectively, and each of the pieces of DCI may be dependent on control information for a PDSCH transmitted from the serving TRP.

For example, DCI #0 that is the control information for the PDSCH transmitted from the serving TRP (TRP #0) includes all information elements of DCI format 1_0, DCI format 1_1, or DCI format 1_2, but shortened DCI (hereinafter, sDCI) (sDCI #0 to sDCI #(N−2)) that is control information for each of PDSCHs transmitted from cooperative TRPs (TRP #1 to TRP #(N−1)) may include only some of information elements of DCI format 1_0, DCI format 1_1, or DCI format 1_2. Therefore, sDCI transmitting control information for PDSCHs transmitted from the cooperative TRPs has a payload smaller than that of normal DCI (nDCI) transmitting control information related to a PDSCH transmitted from the serving TRP, and thus may include reserved bits compared to nDCI.

In case #2 described above, a degree of freedom for each PDSCH control or allocation may be limited according to the content of information elements included in sDCI, but the reception performance of sDCI is superior to nDCI, and thus a probability that a difference in coverage between pieces of DCI may occur may be lowered.

Case #3 1110 shows an example in which, in a situation where different (N−1) number of PDSCHs are transmitted from additional (N−1) number of TRPs (TRP #1 to TRP #(N−1)) other than a serving TRP (TRP #0) used at the time of single PDSCH transmission, one piece of control information for the PDSCHs of the additional (N−1) number of TRPs is transmitted, and the DCI is dependent on control information for a PDSCH transmitted from the serving TRP.

For example, DCI #0 that is the control information for the PDSCH transmitted from the serving TRP (TRP #0) includes all information elements of DCI format 1_0, DCI format 1_1, or DCI format 1_2 and, in a case of control information for PDSCHs transmitted from cooperative TRPs (TRP #1 to TRP #(N−1)), it may be possible to collect only some of information elements of DCI format 1_0, DCI format 1_1, or DCI format 1_2 in one piece of “secondary” DCI (sDCI) and transmit same. For example, the sDCI may include at least one piece of information among pieces of HARQ-related information, such as frequency domain resource assignment, time domain resource assignment, or an MCS of cooperative TRPs. In addition, other information not included in sDCI, such as a bandwidth part (BWP) indicator or a carrier indicator, may follow DCI (DCI #0, normal DCI, or nDCI) of the serving TRP.

Case #3 1110, a degree of freedom for each PDSCH control or allocation may be limited according to the content of information elements included in sDCI, but the reception performance of sDCI is controllable and the complexity of DCI blind decoding of a UE may be reduced compared to case #1 1100 or case #2 1105.

Case #4 1115 is an example in which, in a situation where different (N−1) number of PDSCHs are transmitted from additional (N−1) number of TRPs (TRP #1-TRP #(N−1)) other than a serving TRP (TRP #0) used at the time of single PDSCH transmission, control information for the PDSCHs transmitted from the additional (N−1) number of TRPs is transmitted through the same DCI (long DCI) as that of control information for a PDSCH transmitted from the serving TRP. That is, a UE may obtain control information for PDSCHs transmitted from different TRPs (TRP #0-TRP #(N−1)) through single DCI. In case of case #4 1115, the complexity of DCI blind decoding of the UE may not be increased, but a degree of freedom for PDSCH control or allocation may be low like the number of cooperative TRPs being limited due to the limitation of a long DCI payload.

In the following description and embodiments, sDCI may be referred to as various pieces of auxiliary DCI, such as shortened DCI, secondary DCI, or normal DCI (DCI format 1_0 or 1_1 described above) including PDSCH control information transmitted from a cooperative TRP, and if there is no special explicit limitation, the above description may be similarly applicable to the various pieces of auxiliary DCI.

In the following description and embodiments, case #1 1100, case #2 1105, and case #3 1110 described above in which one or more pieces of DCI (PDCCHs) are used for NC-JT support are classified as NC-JT based on multiple PDCCHs, and case #4 1115 described above in which single DCI (PDCCH) is used for NC-JT support may be classified as NC-JT based on a single PDCCH. In PDSCH transmission based on multiple PDCCHs, a CORESET in which DCI of a serving TRP (TRP #0) is scheduled may be distinguished from a CORESET in which DCI of cooperative TRPs (TRP #1 to TRP #(N−1)) is scheduled. Methods for distinguishing between CORESETs may include a method of distinguishment using a higher layer indicator for each CORESET and a method of distinguishment using a beam configuration for each CORESET. In addition, in NC-JT based on a single PDCCH, single DCI schedules a single PDSCH having multiple layers rather than scheduling multiple PDSCHs, and the multiple layers may be transmitted from multiple TRPs. The connection relation between a layer and a TRP transmitting the layer may be indicated through a transmission configuration indicator (TCI) indication for the layer.

In embodiments of the disclosure, a “cooperative TRP” may be replaced with various terms including a “cooperative panel” or a “cooperative beam,” when actually applied.

In embodiments of the disclosure, “a case where NC-JT is applied” is variously interpretable in accordance with a situation as “a case where a UE simultaneously receives one or more PDSCHs in one BWP,” “a case where a UE receives a PDSCH, based on two or more transmission configuration indicator (TCI) indications simultaneously, in one BWP,” and “a case where a PDSCH received by a UE is associated with one or more DMRS port groups.” However, for convenience of explanation, one expression is used.

In the disclosure, a wireless protocol structure for NC-JT may be variously used according to a TRP-based scenario. For example, if there is no or a small backhaul delay between cooperative TRPs, a method (CA-like method) using a structure based on MAC layer multiplexing similarly to the structure 410 in FIG. 4 may be possible. On the contrary, if a backhaul delay between cooperative TRPs is large enough not to be ignorable (e.g., a time of 2 ms or longer is required for exchange of information, such as CSI, scheduling, or HARQ-ACK, between cooperative TRPs), a method (DC-like method) of using a TRP-specific independent structure from an RLC layer, similarly to the structure 420 in FIG. 4, so as to ensure a characteristic resistant to delays may be possible.

A UE supporting C-JT and/or NC-JT may receive a parameter or setting value related to C-JT and/or NC-JT from a higher layer configuration, and set an RRC parameter of the UE, based on the same parameter or setting value. The UE may use a UE capability parameter, for example, tci-StatePDSCH for the higher layer configuration. The UE capability parameter, for example, tci-StatePDSCH may define TCI states for the purpose of PDSCH transmission, and the number of TCI states may be configured to be 4, 8, 16, 32, 64, or 128 in FR 1 and 64 and 128 in FR 2, and a maximum of 8 states indicatable by 3 bits of a TCI field of DCI among the configured number of TCI states may be configured through a MAC CE message. The maximum value 128 may mean a value indicated by maxNumberConfiguredTCIstatesPerCC in the parameter tci-StatePDSCH included in capability signaling of the UE. As described above, a series of configuration processes from a higher layer configuration to a MAC CE configuration may be applied to a beamforming indication or beamforming change command for at least one PDSCH from one TRP.

### [Multi-DCI-Based Multi-TRP]

As an embodiment of the disclosure, a multi-DCI-based multi-TRP transmission method is described. In the multi-DCI-based multi-TRP transmission method, a downlink control channel for NC-JT may be configured based on multiple PDCCHs.

In NC-JT based on multiple PDCCHs, at the time of DCI transmission for PDSCH scheduling of each TRP, a CORESET or a search space distinguished for each TRP may be provided. The CORESET or search space for each TRP may be configurable according to at least one of the following cases.
Configuration of higher layer index for each CORESET: CORESET configuration information configured through a higher layer may include an index value, and the configured index value for each CORESET may be used to distinguish a TRP transmitting a PDCCH in a corresponding CORESET. That is, in a set of CORESETs having the same higher layer index value, it may be considered or determined that the same TRP transmits PDCCHs or it may be considered or determined that PDCCHs scheduling PDSCHs of the same TRP are transmitted. The index for each CORESET described above may be called CORESETPoolIndex, and it may be considered or determined that PDCCHs are transmitted from the same TRP in CORESETs configured to have the same value of CORESETPoolIndex. It may be considered or determined that a default value of CORESETPoolIndex is configured for a CORESET for which a value of CORESETPoolIndex is not configured, and the default value may be 0.
   In the disclosure, if the number of CORESETPoolIndex types of multiple CORESETs included in the higher layer signaling PDCCH-Config exceeds 1, that is, if each CORESET has a different value of CORESETPoolIndex, a UE may consider or determine that a base station is able to use a multi-DCI-based multi-TRP transmission method.
   On the contrary, in the disclosure, if the number of CORESETPoolIndex types of multiple CORESETs included in the higher layer signaling PDCCH-Config is 1, that is, if all the CORESETs have the same value of CORESETPoolIndex of 0 or 1, the UE may consider or determine that the base station performs transmission by using a single TRP rather than using a multi-DCI-based multi-TRP transmission method.
Configuration of multiple values of PDCCH-Config: Multiple values of PDCCH-Config are configured in one BWP, and each value of PDCCH-Config may include a TRP-specific PDCCH configuration. That is, a CORESET list for each TRP and/or a search space list for each TRP may be configured in one value of PDCCH-Config, and one or more CORESETs and one or more search spaces included in one value of PDCCH-Config may be considered or determined to correspond to a particular TRP.
CORESET beam/beam group configuration: Through a beam or beam group configured for each CORESET, a TRP corresponding to a corresponding CORESET may be distinguished. For example, if the same TCI state is configured for multiple CORESETs, it may be assumed that the CORESETs are transmitted through the same TRP or it may be assumed or determined that PDCCHs scheduling PDSCHs of the same TRP are transmitted in the CORESETs.
Search space beam/beam group configuration: A beam or beam group is configured for each search space, and a TRP for each search space may be distinguished therethrough. For example, if the same beam/beam group or TCI state is configured for multiple search spaces, it may be assumed or determined that the same TRP transmits PDCCHs in the search spaces or it may be assumed or determined that PDCCHs scheduling PDSCHs of the same TRP are transmitted in the search spaces.

A CORESET or search space is distinguished by each TRP as described above, whereby classification of a PDSCH and HARQ-ACK information for each TRP is possible and thus independent generation of a HARQ-ACK codebook and independent usage of PUCCH resources for each TRP may be possible.

In addition, the above configuration may be independent for each cell or each BWP. For example, two different values of CORESETPoolIndex may be configured for a PCell, and on the contrary, a value of CORESETPoolIndex may not be configured for a particular SCell. In this case, it may be assumed or determined that NC-JT is configured in the PCell, but NC-JT is not configured in the SCell for which a value of CORESETPoolIndex is not configured.

FIG. 9 illustrates an example of a process for beam configuration and activation of a PDSCH in a wireless communication system according to an embodiment of the disclosure.

Referring to FIG. 9, a PDSCH TCI state activation/deactivation MAC-CE which is applicable to a multi-DCI-based multi-TRP transmission method may follow FIG. 9 described above. If CORESETPoolIndex for all CORESETs in the higher layer signaling PDCCH-Config is not configured for a UE, the UE may disregard a CORESET pool ID field 955 in a MAC-CE 950. If the UE is able to support a multi-DCI-based multi-TRP transmission method (e.g., if CORESETs in the higher layer signaling PDCCH-Config have different values of CORESETPoolIndex), the UE may activate a TCI state in DCI included in PDCCHs transmitted in CORESETs having the same value of CORESETPoolIndex as that of the CORESET pool ID field 955 in the MAC-CE 950. For example, if the value of the CORESET pool ID field 955 in the MAC-CE 950 is 0, a TCI state in DCI included in PDCCHs transmitted from CORESETs having CORESETPoolIndex of 0 may follow activation information of the MAC-CE.

In a case where the UE is configured, by the base station, to be able to use a multi-DCI-based multi-TRP transmission method, that is, in a case where the number of CORESETPoolIndex types of multiple CORESETs included in the higher layer signaling PDCCH-Config exceeds 1, or in a case where the respective CORESETs have different values of CORESETPoolIndex, the UE may recognize that PDSCHs scheduled by PDCCHs in the respective CORESETs having two different values of CORESETPoolIndex have the following restrictions.

1) If PDSCHs indicated by PDCCHs in respective CORESETs having two different values of CORESETPoolIndex fully or partially overlap with each other, the UE may apply TCI states indicated by the PDCCHs to different code division multiplexing (CDM) groups, respectively. That is, two or more TCI states may not be applied to one CDM group.

If PDSCHs indicated by PDCCHs in respective CORESETs having two different values of CORESETPoolIndex fully or partially overlap with each other, the UE may expect that the PDSCHs have the same number of actual front loaded DMRS symbols, the same number of actual additional DMRS symbols, the same position of an actual DMRS symbol, and the same DMRS type.

3) The UE may expect that bandwidth parts indicated by PDCCHs in respective CORESETs having two different values of CORESETPoolIndex are the same and subcarrier spacings indicated thereby are also the same.

4) The UE may expect that information on a PDSCH scheduled by a PDCCH in each of CORESETs having two different values of CORESETPoolIndex is fully included in the PDCCH.

### [Single-DCI-Based Multi-TRP]

As an embodiment of the disclosure, a single-DCI-based multi-TRP transmission method is described. In the single-DCI-based multi-TRP transmission method, a downlink control channel for NC-JT may be configured based on a single PDCCH.

In the single-DCI-based multi-TRP transmission method, a PDSCH transmitted by multiple TRPs may be scheduled by one piece of DCI. As a method of indicating the number of TRPs transmitting the PDSCH, the number of TCI states may be used. That is, if the number of TCI states indicated in DCI scheduling a PDSCH is 2, transmission may be considered or determined to be single PDCCH-based NC-JT, and if the number of TCI states is 1, transmission may be considered or determined to be single-TRP transmission. TCI states indicated in DCI may correspond to one or two TCI states among TCI states activated by a MAC-CE. If TCI states of DCI correspond to two TCI states activated by a MAC-CE, a TCI codepoint indicated in the DCI and the TCI states activated by the MAC-CE may have a correspondence relation, and this may correspond to a case where the number of the TCI states activated by the MAC-CE and corresponding to the TCI codepoint is 2.

As another example, if at least one codepoint among all codepoints of a TCI state field in DCI indicates two TCI states, a UE may consider or determine that a base station is able to perform transmission based on a single-DCI-based multi-TRP method. The at least one codepoint indicating two TCI states in the TCI state field may be activated trough an enhanced PDSCH TCI state activation/deactivation MAC-CE.

FIG. 12 illustrates an example of an enhanced PDSCH TCI state activation-deactivation MAC-CE structure in a wireless communication system according to an embodiment of the disclosure. Referring to FIG. 12, the meaning of each field in the MAC CE and a value configurable for each field ma be shown as in Table 21 below.

```
TABLE 21
  - Serving Cell ID: This field indicates the identity of the Serving Cell for which the
MAC CE applies. The length of the field is 5 bits. If the indicated Serving Cell is configured
as part of a simultaneousTCI-UpdateList1 or simultaneousTCI-UpdateList2 as specified in TS
38.331 [5], this MAC CE applies to all the Serving Cells configured in the set simultaneousTCI-
UpdateList1 or simultaneousTCI-UpdateList2, respectively;
  - BWP ID: This field indicates a DL BWP for which the MAC CE applies as the
codepoint of the DCI bandwidth part indicator field as specified in TS 38.212 [9]. The length
of the BWP ID field is 2 bits;
  - Ci: This field indicates whether the octet containing TCI state IDi,2 is present. If this
field is set to “1,” the octet containing TCI state IDi,2 is present. If this field is set to “0,” the
octet containing TCI state IDi,2 is not present;
  - TCI state IDi,j: This field indicates the TCI state identified by TCI-StateId as specified
in TS 38.331 [5], where i is the index of the codepoint of the DCI Transmission configuration
indication field as specified in TS 38.212 [9] and TCI state IDi,j denotes the j-th TCI state
indicated for the i-th codepoint in the DCI Transmission Configuration Indication field. The
TCI codepoint to which the TCI States are mapped is determined by its ordinal position among
all the TCI codepoints with sets of TCI state IDi,j fields, i.e., The first TCI codepoint with TCI
state ID0,1 and TCI state ID0,2 may be mapped to the codepoint value 0, the second TCI
codepoint with TCI state ID1,1 and TCI state ID1,2 may be mapped to the codepoint value 1
and so on. The TCI state IDi,2 is optional based on the indication of the Ci field. The maximum
number of activated TCI codepoint is 8 and the maximum number of TCI states mapped to a
TCI codepoint is 2.
  - R: Reserved bit, set to “0.”
```

In FIG. 12, if the value of a C0 field 1205 is 1, the MAC-CE may include a TCI state ID0,2 field 1215 in addition to a TCI state ID0,1 field 1210. This implies that TCI state ID0,1 and TCI state ID0,2 are activated for the 0-th codepoint of a TCI state field included in DCI, and if a base station indicates the codepoint to a UE, two TCI states may be indicated to the UE. If a value of the C0 field 1205 is 0, the MAC-CE is unable to include the TCI state ID0,2 field 1215, and this may imply that one TCI state corresponding to TCI state ID0,1 is activated for a 0-th codepoint of a TCI state field included in DCI.

The above configuration may be independent for each cell or each BWP. For example, the number of activated TCI states corresponding to one TCI codepoint is a maximum of 2 in a PCell, but the number of activated TCI states corresponding to one TCI codepoint may be a maximum of 1 in a particular SCell. In this case, it may be considered or determined that NC-JT is configured in the PCell, but NC-JT is not configured in the SCell.

### [Single-DCI-Based Multi-TRP PDSCH Repeated Transmission Technique (TDM/FDM/SDM) Distinguishment Method]

Next, a method of distinguishing a single-DCI-based multi-TRP PDSCH repeated transmission technique is described. Different single-DCI-based multi-TRP PDSCH repeated transmission techniques (e.g., TDM, FDM, and SDM) may be indicated to a UE by a base station according to a value indicated by a DCI field and a higher layer signaling configuration. Table 22 below may show a method of distinguishing between single or multi-TRP-based techniques indicated to the UE according to a value of a particular DCI field and a higher layer signaling configuration.

TABLE 22

| | | | repetitionNumber | | |
|---|---|---|---|---|---|
| | TCI | CDM | configuration and | Related to | Transmission |
| | state | group | indication | repetitionScheme | technique |
| Combination | Number | Number | condition | configuration | indicated to UE |
| 1 | 1 | ≥1 | Condition 2 | Not configured | Single-TRP |
| 2 | 1 | ≥1 | Condition 2 | Configured | Single-TRP |
| 3 | 1 | ≥1 | Condition 3 | Configured | Single-TRP |
| 4 | 1 | 1 | Condition 1 | Configured or | Single-TRP |
| | | | | not configured | TDM scheme B |
| 5 | 2 | 2 | Condition 2 | Not configured | Multi-TRP SDM |
| 6 | 2 | 2 | Condition 3 | Not configured | Multi-TRP SDM |
| 7 | 2 | 2 | Condition 3 | Configured | Multi-TRP SDM |
| 8 | 2 | 1 | Condition 3 | Configured | Multi-TRP FDM |
| | | | | | scheme A/FDM |
| | | | | | scheme B/TDM |
| | | | | | scheme A |
| 9 | 2 | 1 | Condition 1 | Not configured | Multi-TRP TDM |
| | | | | | scheme B |

In Table 22, each column may be described as follows.
Number of TCI states (second column): This indicates the number of TCI states indicated by a TCI state field in DCI, and may be 1 or 2.
Number of CDM groups (third column): This indicates the number of different CDM groups of DMRS ports indicated by an antenna port field in DCI. The number may be 1, 2, or 3.
repetitionNumber configuration and indication condition (fourth column): There may be three conditions according to whether repetitionNumber is configured for all TDRA entries indicatable by a time domain resource allocation field in DCI, and whether an actually indicated TDRA entry has a repetitionNumber configuration.
   Condition 1: At least one of all TDRA entries indicatable by a time domain resource allocation field includes a configuration on repetitionNumber, and a TDRA entry indicated by a time domain resource allocation field in DCI includes a configuration on repetitionNumber greater than 1.
   Condition 2: At least one of all TDRA entries indicatable by a time domain resource allocation field includes a configuration on repetitionNumber, and a TDRA entry indicated by a time domain resource allocation field in DCI does not include a configuration on repetitionNumber.
   Condition 3: All TDRA entries indicatable by a time domain resource allocation field do not include a configuration on repetitionNumber.
Related to repetitionScheme configuration (fifth column): This may indicate whether repetitionScheme that is higher layer signaling is configured. As the higher layer signaling repetitionScheme, one of “tdmSchemeA,” “fdmSchemeA,” and “fdmSchemeB” may be configured.
Transmission technique indicated to UE (sixth column): This indicates single or multi-TRP techniques indicated by combinations (first column) represented in Table 22.
   Single-TRP: This indicates single-TRP-based PDSCH transmission. If pdsch-AggegationFactor in the higher layer signaling PDSCH-config is configured for the UE, single-TRP-based PDSCH repeated transmission performed a configured number of times may be scheduled to the UE. Otherwise, single-TRP-based PDSCH single transmission may be scheduled to the UE.
   Single-TRP TDM scheme B: This indicates single-TRP-based inter-slot time resource division-based PDSCH repeated transmission. According to condition 1 related to repetitionNumber described above, the UE repeats PDSCH transmission on the time domain in a number of slots equal to the count of repetitionNumber greater than 1 configured in a TDRA entry indicated by a time domain resource allocation field. The UE may apply the same starting symbol and the same symbol length of a PDSCH indicated by the TDRA entry for each of the slots, the number of which is equal to the count of repetitionNumber, and apply the same TCI state to every PDSCH repeated transmission. The single-TRP TDM scheme B is similar to a slot aggregation scheme in that inter-slot PDSCH repeated transmission is performed on time resources, but differs from slot aggregation in that whether repeated transmission is indicated may be dynamically determined based on a time domain resource allocation field in DCI.
   Multi-TRP SDM: This means a multi-TRP-based spatial resource division PDSCH transmission scheme. This is a method of receiving distributed layers from TRPs, and is not a repeated transmission scheme, but may increase the reliability of PDSCH transmission in that the number of layers is increased to enable transmission at a lowered code rate. The UE may apply two TCI states indicated through a TCI state field in DCI to two CDM groups indicated by the base station, respectively, so as to receive a PDSCH.
   Multi-TRP FDM scheme A: This means a multi-TRP-based frequency resource division PDSCH transmission scheme. This technique provides one PDSCH transmission occasion and thus is not repeated transmission like multi-TRP SDM. However, the amount of frequency resources is increased to lower a code rate and thus enable transmission with high reliability. Multi-TRP FDM scheme A may apply two TCI states indicated through a TCI state field in DCI to frequency resources not overlapping each other, respectively. In a case where a PRB bundling size is determined to be a wideband, if the number of RBs indicated by a frequency domain resource allocation field is N, the UE may apply a first TCI state to a first ceil(N/2) number of RBs, and apply a second TCI state to the remaining floor(N/2) number of RBs for reception. Here, ceil(.) and floor(.) are operators indicating rounding up and down for one decimal place. If a PRB bundling size is determined to be 2 or 4, the UE may apply the first TCI state to even-numbered PRGs and apply the second TCI state to odd-numbered PRGs for reception.
   Multi-TRP FDM scheme B: This means a multi-TRP-based frequency resource division PDSCH repeated transmission scheme, and provides two PDSCH transmission occasions to repeat PDSCH transmission in the respective occasions. In the same way as multi-TRP FDM scheme A, multi-TRP FDM scheme B may also apply two TCI states indicated through a TCI state field in DCI to frequency resources not overlapping each other, respectively. In a case where a PRB bundling size is determined to be a wideband, if the number of RBs indicated by a frequency domain resource allocation field is N, the UE may apply a first TCI state to a first ceil(N/2) number of RBs, and apply a second TCI state to the remaining floor(N/2) number of RBs for reception. Here, ceil(.) and floor(.) are operators indicating rounding up and down for one decimal place. If a PRB bundling size is determined to be 2 or 4, the UE may apply the first TCI state to even-numbered PRGs and apply the second TCI state to odd-numbered PRGs for reception.
   Multi-TRP TDM scheme A: This means a multi-TRP-based time resource division intra-slot PDSCH repeated transmission scheme. The UE may have two PDSCH transmission occasions in one slot, and a first reception occasion may be determined based on the starting symbol and the symbol length of a PDSCH indicated through a time domain resource allocation field in DCI. A starting symbol of a second reception occasion of the PDSCH may be a position obtained by applying a symbol offset of the higher layer signaling StartingSymbolOffsetK to a last symbol of the first transmission occasion, and the transmission occasion may be determined to be as long as the indicated symbol length from the position. If the higher layer signaling StartingSymbolOffsetK is not configured, a symbol offset may be considered or determined as 0.
   Multi-TRP TDM scheme B: This means a multi-TRP-based time resource division inter-slot PDSCH repeated transmission scheme. The UE may have one PDSCH transmission occasion in one slot, and receive repeated transmission, based on the same starting symbol and the same symbol length of a PDSCH during a number of slots corresponding to the count of repetitionNumber indicated through a time domain resource allocation field in DCI. If repetitionNumber is 2, the UE may receive PDSCH repeated transmission in first and second slots by applying first and second TCI states thereto, respectively. If repetitionNumber is greater than 2, the UE may use different TCI state application schemes according to which value the higher layer signaling tciMapping is configured to be. If tciMapping is configured to be cyclicMapping, the UE may apply the first and second TCI states to first and second PDSCH transmission occasions, respectively, and also apply this TCI state application method to the remaining PDSCH transmission occasions in the same way. If tciMapping is configured to be sequenticalMapping, the UE may apply the first TCI state to the first and second PDSCH transmission occasions, apply the second TCI state to third and fourth PDSCH transmission occasions, and also apply this TCI state application method to the remaining PDSCH transmission occasions in the same way.

Hereinafter, embodiments of the disclosure will be described in detail in conjunction with the accompanying drawings. The contents of the disclosure may be applied to FDD and TDD systems. As used herein, upper signaling (or upper layer signaling) is a method for transferring signals from a base station to a UE by using a downlink data channel of a physical layer, or from the UE to the base station by using an uplink data channel of the physical layer, and may also be referred to as “RRC signaling,” “PDCP signaling,” or “medium access control (MAC) control element (MAC CE).”

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to a case in which the UE receives a PDSCH to which cooperative communication is applied, based on conditions similar to those described above.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

Hereinafter, for the sake of descriptive convenience, a cell, a transmission point, a panel, a beam, and/or a transmission direction which can be distinguished through an upper layer/L1 parameter such as a TCI state or spatial relation information, a cell ID, a TRP ID, or a panel ID may be described as a TRP, a beam, or a TCI state as a whole. Therefore, when actually applied, a TRP, a beam, or a TCI state may be appropriately replaced with one of the above terms.

In the following description of the disclosure, upper layer signaling may refer to signaling corresponding to at least one signaling among the following signaling, or a combination of one or more thereof:
Master information block (MIB);
System information block (SIB) or SIB X (X=1, 2, . . . );
Radio resource control (RRC); and/or
Medium access control (MAC) control element (CE).

In addition, L1 signaling may refer to signaling corresponding to at least one signaling method among signaling methods using the following physical layer channels or signaling, or a combination of one or more thereof:
Physical downlink control channel (PDCCH);
Downlink control information (DCI);
UE-specific DCI;
Group common DCI;
Common DCI;
Scheduling DCI (for example, DCI used for the purpose of scheduling downlink or uplink data);
Non-scheduling DCI (for example, DCI not used for the purpose of scheduling downlink or uplink data);
Physical uplink control channel (PUCCH); and/or
Uplink control information (UCI).

As used herein, the term “slot” may generally refer to a specific time unit corresponding to a transmit time interval (TTI), may specifically refer to a slot used in a 5G NR system, or may refer to a slot or a subframe used in a 4G LTE system.

### First Embodiment: Method of Configuring Transmission Power Parameter when Unified TCI State is Supported

As an embodiment of the disclosure, a method of configuring, for a UE, a transmission power parameter when the UE supports a unified TCI state is described. This embodiment may be operated in combination with other embodiments.

The higher layer signaling ServingCellConfig may be configured for a UE by a base station and, additionally, the higher layer signaling MIMOParam-r17 may be configured in ServingCellConfig for the UE. The detailed higher layer signaling structures of ServingCellConfig and MIMOParam-r17 may be shown in Table 23 below.

TABLE 23

| | |
|---|---|
| ServingCellConfig ::= | SEQUENCE { |

```
  ...
  pathlossReferenceLinking ENUMERATED {spCell, sCell} OPTIONAL, -- Cond
SCellOnly
```

| | | |
|---|---|---|
| mimoParam-r17 | SetupRelease {MIMOParam-r17} | OPTIONAL, -- |

```
Need M
  ...
  }
  MIMOParam-r17 ::= SEQUENCE {
    additionalPCI-ToAddModList-r17 SEQUENCE (SIZE(1..maxNrofAdditionalPCI-
r17)) OF SSB-MTC-AdditionalPCI-r17 OPTIONAL, -- Need N
    additionalPCI-ToReleaseList-r17 SEQUENCE (SIZE(1..maxNrofAdditionalPCI-
r17)) OF AdditionalPCIIndex-r17 OPTIONAL, -- Need N
```

| | |
|---|---|
| unifiedTCI-StateType-r17 ENUMERATED {separate, joint} | OPTIONAL, |

```
-- Need R
    uplink-PowerControlToAddModList-r17 SEQUENCE (SIZE (1..maxUL-TCI-r17))
OF Uplink-powerControl-r17 OPTIONAL, -- Need N
    uplink-PowerControlToReleaseList-r17 SEQUENCE (SIZE (1..maxUL-TCI-r17)) OF
Uplink-powerControlId-r17 OPTIONAL, -- Need N
```

| | |
|---|---|
| sfnSchemePDCCH-r17 | ENUMERATED {sfnSchemeA,sfnSchemeB} |

OPTIONAL, -- Need R

| | |
|---|---|
| sfnSchemePDSCH-r17 | ENUMERATED {sfnSchemeA,sfnSchemeB} |

OPTIONAL -- Need R
}

As shown in Table 23 above, the higher layer signaling unifiedTCI-StateType-r17 may be configured in MIMOParam-r17 for the UE by the base station, and the value may be one of separate or joint.
The higher layer signaling unifiedTCI-StateType-r17 being configured for the UE as separate may imply that, when the UE receives a configuration and indication related to a unified TCI state from the base station, a TCI state (e.g., a DL TCI state) applicable for downlink reception and a TCI state (e.g., a UL TCI state) applicable for uplink transmission are individually configurable and indicatable. In this case, each of the higher layer signalings dl-OrJointTCI-StateList and ul-TCI-ToAddModList indicating lists of DL TCI states and UL TCI states may be configured for the UE by the base station.
The higher layer signaling unifiedTCI-StateType-r17 being configured for the UE as joint may imply that, when the UE receives a configuration and indication related to a unified TCI state from the base station, a TCI state (e.g., a joint TCI state) applicable for downlink reception and uplink transmission is collectively configurable and indicatable. In this case, the higher layer signaling dl-OrJointTCI-StateList indicating a list of joint TCI states may be configured for the UE by the base station.

As shown in Table 23, the higher layer signaling uplink-PowerControlToAddModList may be configured in MIMOParam-r17 for the UE. If the higher layer signaling unifiedTCI-StateType is configured in a serving cell for the UE, the higher layer signaling uplink-PowerControlToAddModList may include transmission power parameters for a PUSCH, a PUCCH, and an SRS. The higher layer signaling uplink-PowerControlToAddModList may include a list of a maximum of 64 values of Uplink-powerControl-r17 and Uplink-powerControlId-r17. The higher layer signaling Uplink-powerControl-r17 may have a structure as shown in Table 24 below.

As shown in Table 23, pathlossReferenceLinking may be configured in ServingCellConfig for the UE. The higher layer signaling pathlossReferenceLinking may indicate which of an SpCell or SCell in which the UE refers to a list of reference signals for pathloss amount measurement.

TABLE 24

| Uplink-powerControl-r17 ::= SEQUENCE { | |
|---|---|
| ul-powercontrolId-r17 Uplink-powerControlId-r17, | |
| p0AlphaSetforPUSCH-r17 P0AlphaSet-r17 | OPTIONAL, -- Need |
| R | |
| p0AlphaSetforPUCCH-r17 P0AlphaSet-r17 | OPTIONAL, -- Need |
| R | |
| p0AlphaSetforSRS-r17 P0AlphaSet-r17 | OPTIONAL -- Need R |

| } | |
|---|---|
| P0AlphaSet-r17 ::= SEQUENCE { | |
| p0-r17 INTEGER (−16..15) | OPTIONAL, -- Need R |
| alpha-r17 Alpha | OPTIONAL, -- Need S |

```
    closedLoopIndex-r17 ENUMERATED { i0, i1 }
  }
  Uplink-powerControlId-r17 ::= INTEGER(1.. maxUL-TCI-r17)
```

As shown Table 24, the UE may include ul-powercontrolId-r17 in one Uplink-powerControl-r17 parameter, individual P0AlphaSet-r17 applicable to each of a PUSCH, a PUCCH, or an SRS may be configured for the UE. In addition, each P0AlphaSet-r17 may include p0, alpha, and a closed loop index that are uplink transmission power parameters described above.

The higher layer signalings in Table 23 above may be applied to all bandwidth parts in the corresponding serving cell. Table 25 below may represent a higher layer signaling structure configurable for the UE for each uplink bandwidth part (e.g., BWP-UplinkDedicated).

TABLE 25
BWP-UplinkDedicated ::= SEQUENCE {

| | | |
|---|---|---|
| pucch-Config | SetupRelease { PUCCH-Config } | OPTIONAL, -- |

Need M

| | | |
|---|---|---|
| pusch-Config | SetupRelease { PUSCH-Config } | OPTIONAL, -- |

Need M

| | |
|---|---|
| configuredGrantConfig | SetupRelease { ConfiguredGrantConfig } |

OPTIONAL, -- Need M

| | | |
|---|---|---|
| srs-Config | SetupRelease { SRS-Config } | OPTIONAL, -- Need M |

```
  ...
  [[
    ul-TCI-StateList-r17 CHOICE {
```

| | |
|---|---|
| explicitlist | SEQUENCE { |

```
        ul-TCI-ToAddModList-r17 SEQUENCE (SIZE (1..maxUL-TCI-r17)) OF TCI-
UL-State-r17 OPTIONAL, -- Need N
        ul-TCI-ToReleaseList-r17 SEQUENCE (SIZE (1..maxUL-TCI-r17)) OF TCI-UL-
StateId-r17 OPTIONAL -- Need N
      },
      unifiedTCI-StateRef-r17 ServingCellAndBWP-Id-r17
```

| } | OPTIONAL, -- Need R | |
|---|---|---|
| ul-powerControl-r17 | Uplink-powerControlId-r17 | OPTIONAL, -- |

```
Cond NoTCI-PC
  ...
  [[
```

| | |
|---|---|
| pathlossReferenceRSToAddModList-r17 | SEQUENCE (SIZE |

(1..maxNrofPathlossReferenceRSs-r17)) OF PathlossReferenceRS-r17

OPTIONAL, -- Need N

| | |
|---|---|
| pathlossReferenceRSToReleaseList-r17 | SEQUENCE (SIZE |

(1..maxNrofPathlossReferenceRSs-r17)) OF PathlossReferenceRS-Id-r17

OPTIONAL -- Need N

```
    ]]
  }
```

As shown in Table 25 above, the higher layer signaling ul-TCI-StateList-r17 may be configured for the UE, and one of explicitlist or unifiedTCI-StateRef-r17 may be configured for the UE. If explicitlist is configured for the UE with respect to the higher layer signaling ul-TCI-StateList-r17, a list of UL TCI states usable in an uplink bandwidth part may be explicitly configured for the UE through ul-TCI-ToAddModList-r17. If unifiedTCI-StateRef-r17 is configured for the UE with respect to the higher layer signaling ul-TCI-StateList-r17, a joint TCI state or UL TCI state usable in an uplink bandwidth part may not be explicitly configured for the UE for the uplink bandwidth part, and the UE may refer to and use a joint TCI state or UL TCI state configured for another uplink bandwidth part. The higher layer signaling unifiedTCI-StateRef-r17 may indicate an index of a random bandwidth part in a random serving cell. In addition, the UE may expect that a serving cell including a bandwidth part for which unifiedTCI-StateRef-r17 is configured, and a random serving cell including a bandwidth part configurable by the base station through unifiedTCI-StateRef-r17 have the same value of unifiedTCI-StateType.

As shown in Table 25 above, if unifiedTCI-StateType is configured for the UE, the higher layer signaling ul-powerControl may be configured for the UE and ul-powerControl may refer to one value of Uplink-powerControlId-r17. In this case, the higher layer signaling ul-powerControl may be configured for the UE with respect to all uplink bandwidth parts in a particular serving cell, or the higher layer signaling ul-powerControl may not be configured with respect to all the uplink bandwidth parts. If unifiedTCI-StateRef-r17 is configured in BWP-UplinkDedicated for the UE or the UE receives a configuration referring to a different serving cell and bandwidth part through a value of unifiedTCI-StateRef-r17 in PDSCH-Config, and unifiedTCI-StateType is configured as joint, the UE may expect that ul-powerControl is configured for the UE in a referred serving cell and all uplink bandwidth parts in the serving cell, or ul-powerControl is not configured in the referred serving cell and all the uplink bandwidth parts in the serving cell. The higher layer signaling ul-powerControl may be configured for the UE only when a condition called NoTCI-PC is satisfied. The condition called NoTCI-PC may indicate that the higher layer signaling ul-powerControl is not configured in a joint TCI state or UL TCI state in a serving cell.

As shown in Table 25 above, if unifiedTCI-StateType is configured for the UE, the higher layer signaling pathlossReferenceRSToAddModList-r17 may be configured for the UE. pathlossReferenceRSToAddModList-r17 may indicate a list of reference signals usable to calculate a pathloss amount when a PUSCH, a PUCCH, or an SRS is transmitted in a case where the UE supports a unified TCI state. If unifiedTCI-StateType is not configured for the UE, pathlossReferenceRSToAddModList-r17 may not include any list.

If unifiedTCI-StateType is configured for the UE, when a reference signal for pathloss amount measurement is indicated to the UE through a TCI state indication, the indicated reference signal for pathloss amount measurement may indicate a reference signal for pathloss amount measurement configured in a serving cell to which the indicated TCI state is applied. In this case, if pathlossReferenceLinking described above is configured for the UE, the UE may consider or determine that the indicated reference signal for pathloss amount measurement indicates a reference signal for pathloss amount measurement configured in a serving cell configured through pathlossReferenceLinking described above.

If the UE operates based on a unified TCI state, (e.g., if the higher layer signaling unifiedTCI-StateType is configured for the UE as joint or separate), a higher layer signaling structure of a TCI state indicatable to the UE by the base station may be determined. If the higher layer signaling unifiedTCI-StateType is configured for the UE as joint, a joint TCI state may be configured and indicated for the UE by the base station by using a higher layer signaling structure shown in Table 26. If the higher layer signaling unifiedTCI-StateType is configured for the UE as separate, a DL TCI state may be configured and indicated for the UE by the base station by using a higher layer signaling structure shown in Table 26, and a UL TCI state may be configured and indicated for the UE by the base station by using a higher layer signaling structure shown in Table 27.

If the higher layer signaling unifiedTCI-StateType is configured for the UE as joint, the UE may expect that pathlossReferenceRS-Id-r17 in Table 26 below is always configured. Alternatively, if unifiedTCI-StateType is configured as separate or unifiedTCI-StateType is not configured, the UE may expect that pathlossReferenceRS-Id-r17 is not configured, and the name of such a condition may be defined as JointTCI1.

If the higher layer signaling unifiedTCI-StateType is configured for the UE as separate, the UE may expect that pathlossReferenceRS-Id-r17 in Table 27 below is always configured, and the name of such a condition may be defined as Mandatory.

TABLE 26

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, -- Need R |

```
    ...,
    [[
```

| | |
|---|---|
| additionalPCI-r17 AdditionalPCIIndex-r17 | OPTIONAL, -- Need R |

| | |
|---|---|
| pathlossReferenceRS-Id-r17 | OPTIONAL, -- Cond JointTCI1 |

| | |
|---|---|
| ul-powerControl-r17 Uplink-powerControlId-r17 | OPTIONAL -- Cond |

```
JointTCI
    ]]
  }
```

TABLE 27
TCI-UL-State-r17 ::= SEQUENCE {
tci-UL-StateId-r17 ,

| servingCellId-r17 ServCellIndex | | OPTIONAL, -- Need R |
|---|---|---|
| bwp-Id-r17 | BWP-Id | OPTIONAL, -- Cond CSI-RSorSRS-Indicated |

| | |
|---|---|
| referenceSignal-r17 | CHOICE { |
| ssb-Index-r17 | SSB-Index, |
| csi-RS-Index-r17 | NZP-CSI-RS-ResourceId, |
| srs-r17 | SRS-ResourceId |

},

| | |
|---|---|
| additionalPCI-r17 AdditionalPCIIndex-r17 | OPTIONAL, -- Need R |
| ul-powerControl-r17 Uplink-powerControlId-r17 | OPTIONAL, -- Need R |

| | |
|---|---|
| pathlossReferenceRS-Id-r17 | OPTIONAL, -- Cond Mandatory |

...
}

Higher layer signaling related to a transmission power parameter applicable at the time of SRS transmission may be configured for the UE according to Table 28 and Table 29 below.

TABLE 28

| | |
|---|---|
| SRS-Config ::= | SEQUENCE { |

srs-ResourceSetToReleaseList SEQUENCE (SIZE(1..maxNrofSRS-ResourceSets))
OF SRS-ResourceSetId OPTIONAL, -- Need N

| | |
|---|---|
| srs-ResourceSetToAddModList | SEQUENCE (SIZE(1..maxNrofSRS- |

ResourceSets)) OF SRS-ResourceSet OPTIONAL, -- Need N

| | |
|---|---|
| srs-ResourceToReleaseList | SEQUENCE (SIZE(1..maxNrofSRS-Resources)) OF |

SRS-ResourceId OPTIONAL, -- Need N

| | |
|---|---|
| srs-ResourceToAddModList | SEQUENCE (SIZE(1..maxNrofSRS-Resources)) OF |

SRS-Resource OPTIONAL, -- Need N

| | | |
|---|---|---|
| tpc-Accumulation | ENUMERATED {disabled} | OPTIONAL, -- |

```
Need S
    ...,
    [[
```

| | | |
|---|---|---|
| srs-RequestDCI-1-2-r16 | INTEGER (1..2) | OPTIONAL, -- Need |

S

| | | |
|---|---|---|
| srs-RequestDCI-0-2-r16 | INTEGER (1..2) | OPTIONAL, -- Need |

```
S
    srs-ResourceSetToAddModListDCI-0-2-r16 SEQUENCE (SIZE(1..maxNrofSRS-
ResourceSets)) OF SRS-ResourceSet OPTIONAL, -- Need N
    srs-ResourceSetToReleaseListDCI-0-2-r16 SEQUENCE (SIZE(1..maxNrofSRS-
ResourceSets)) OF SRS-ResourceSetId OPTIONAL, -- Need N
```

| | |
|---|---|
| srs-PosResourceSetToReleaseList-r16 | SEQUENCE (SIZE(1..maxNrofSRS- |
| PosResourceSets-r16)) OF SRS-PosResourceSetId-r16 | |

OPTIONAL, -- Need N

| | |
|---|---|
| srs-PosResourceSetToAddModList-r16 | SEQUENCE (SIZE(1..maxNrofSRS- |

PosResourceSets-r16)) OF SRS-PosResourceSet-r16 OPTIONAL,-- Need N

| | |
|---|---|
| srs-PosResourceToReleaseList-r16 | SEQUENCE (SIZE(1..maxNrofSRS- |

PosResources-r16)) OF SRS-PosResourceId-r16 OPTIONAL,-- Need N

| | |
|---|---|
| srs-PosResourceToAddModList-r16 | SEQUENCE (SIZE(1..maxNrofSRS- |

```
PosResources-r16)) OF SRS-PosResource-r16 OPTIONAL -- Need N
    ]]
  }
```

```
TABLE 29
  SRS-ResourceSet ::= SEQUENCE {
    srs-ResourceSetId ,
    srs-ResourceIdList SEQUENCE (SIZE(1..maxNrofSRS-ResourcesPerSet)) OF
SRS-ResourceId OPTIONAL, -- Cond Setup
    resourceType CHOICE {
      aperiodic SEQUENCE {
        aperiodicSRS-ResourceTrigger INTEGER (1..maxNrofSRS-TriggerStates-1),
```

| | | |
|---|---|---|
| csi-RS | NZP-CSI-RS-ResourceId | OPTIONAL, -- Cond |

NonCodebook

| | | |
|---|---|---|
| slotOffset | INTEGER (1..32) | OPTIONAL, -- Need S |

```
        ...,
        [[
```

| | |
|---|---|
| aperiodicSRS-ResourceTriggerList | SEQUENCE (SIZE(1..maxNrofSRS- |

TriggerStates-2))

OF INTEGER (1..maxNrofSRS-TriggerStates-1) OPTIONAL --

```
Need M
        ]]
      },
      semi-persistent SEQUENCE {
```

| | |
|---|---|
| associatedCSI-RS NZP-CSI-RS-ResourceId | OPTIONAL, -- Cond |

```
NonCodebook
        ...
      },
```

| | |
|---|---|
| periodic | SEQUENCE { |

| | |
|---|---|
| associatedCSI-RS NZP-CSI-RS-ResourceId | OPTIONAL, -- Cond |

```
NonCodebook
        ...
      }
    },
```

| | |
|---|---|
| usage | ENUMERATED {beamManagement, codebook, nonCodebook, |

antennaSwitching},

| alpha | | OPTIONAL, -- Need S |
|---|---|---|
| p0 | INTEGER (−202..24) | OPTIONAL, -- Cond Setup |

| | |
|---|---|
| pathlossReferenceRS PathlossReferenceRS-Config | OPTIONAL, -- |

Need M

| | |
|---|---|
| srs-PowerControlAdjustmentStates | ENUMERATED { sameAsFci2, |

| | |
|---|---|
| separateClosedLoop} | OPTIONAL, -- Need S |

```
    ...,
    [[
    pathlossReferenceRSList-r16 SetupRelease { PathlossReferenceRSList-r16}
OPTIONAL -- Need M
    ]],
    [[
```

| | |
|---|---|
| usagePDC-r17 ENUMERATED {true} | OPTIONAL, -- Need R |

availableSlotOffsetList-r17 SEQUENCE (SIZE(1..4)) OF AvailableSlotOffset-r17
OPTIONAL, -- Need R

| | |
|---|---|
| followUnifiedTCI-StateSRS-r17 ENUMERATED {enabled} | OPTIONAL |

-- Need R

| | |
|---|---|
| applyIndicatedTCI-State-r18 ENUMERATED {first, second} | OPTIONAL |

```
-- Cond FollowUTCI
    ]]
  }
```

Description of each higher layer signaling parameter in Table 28 and Table 29 above may be as follows.
tpc-Accumulation: If tpc-Accumulation is not configured, when a TPC command indicating a change in SRS transmission power is received, the UE may perform an operation of additionally accumulating the TPC command to previously indicated TPC command values. If disabled is configured as tpc-Accumulation, when a TPC command indicating a change in SRS transmission power is received, the UE may not perform an operation of accumulating and perform an operation of applying an absolute TPC described above. An absolute TPC operation may be possible when an SRS does not share a closed loop index with a PUSCH.
Alpha: An alpha value for determining SRS transmission power may be configured for the UE through higher layer signaling.
p0: An p0 value in SRS-resourceSet for determining SRS transmission power may be configured for the UE through higher layer signaling. If the higher layer signaling unifiedTCI-StateType is not configured for the UE, the UE may determine a P_{O}_{_{SRS}}_{,b,f,c}(qₛ) value in Equation 7 described above through the higher layer signaling p0. If the higher layer signaling unifiedTCI-StateType is configured for the UE, the UE may determine a P_{O}_{_{SRS}}_{,b,f,c}(qₛ) value in Equation 7 described above to be the sum of p0 in the higher layer signaling SRS-resourceSet and a p0 value (e.g.,

$${P}_{{0}_{{UE}_{SRS}} , b , f , c} ( {q}_{s} ) )$$

configurable in p0AlphaSetforSRS in Uplink-powerControlId-r17 above. The Uplink-powerControlId-r17 described above may be determined through the following method.
   If the UE determines uplink transmission power through [Method 1-1], Uplink-powerControlId-r17 may be determined through one value of ul-powerControl configured in a particular uplink bandwidth part.
   If the UE determines uplink transmission power through [Method 1-2],
      If the higher layer signaling followUnifiedTCIstateSRS is configured in an SRS resource set for the UE, the UE may be provided with the values of

$${P}_{{0}_{{UE}_{SRS}} , b , f , c} ( {q}_{s} ) ,$$

alpha, and srs-PowerControlAdjustmentStates, based on the higher layer signaling p0AlphaSetforSRS associated with TCIState or UL-TCIstate indicated by the base station. The UE may be provided with the higher layer signaling pathlossReferenceRS indicating a pathloss reference signal, based on pathlossReferenceRS-Id-r17 that is higher layer signaling associated with or included in TCIState or UL-TCIstate indicated by the base station.
   If the higher layer signaling followUnifiedTCIstateSRS is not configured in an SRS resource set for the UE, the UE may be provided from the base station with the values of

$${P}_{{0}_{{UE}_{SRS}} , b , f , c} ( {q}_{s} ) ,$$

alpha, and srs-PowerControlAdjustmentStates, based on the higher layer signaling p0AlphaSetforSRS associated with TCIState or UL-TCIstate configured in an SRS resource having the lowest index in the SRS resource set. The UE may be provided from the base station with the higher layer signaling pathlossReferenceRS indicating a pathloss reference signal, based on pathlossReferenceRS-Id-r17 that is higher layer signaling associated with or included in TCIState or UL-TCIstate configured in an SRS resource having the lowest index in the SRS resource set.
srs-PowerControlAdjustmentStates: A closed loop index used at the time of determination of SRS transmission power may be configured for the UE through this higher layer signaling. If the higher layer signaling fails to be configured for the UE, the UE may share a closed loop index of an SRS with a first closed loop index of a PUSCH. If the higher layer signaling is configured for the UE as sameAsFci2, the UE may share a closed loop index of an SRS with a second closed loop index of a PUSCH. In this case, higher layer signaling may have been configured for the UE to have a maximum of two closed loop indexes for a PUSCH. If the higher layer signaling is configured for the UE as separateClosedLoop, the UE does not share a closed loop index of an SRS with a closed loop index of a PUSCH and the index may be individually configured for the UE.
   If the higher layer signaling unifiedTCI-StateType is configured for the UE and srs-PowerControlAdjustmentStates described above is configured in a particular SRS resource set as separateClosedLoop, the UE may consider or determine that SRS resources included in the SRS resource set are connected to a closed loop index independent to a PUSCH. The UE may consider a closed loop index independent to a PUSCH, as described above, regardless of a closed loop connected to a TCI state indicated by the base station.
   If the higher layer signaling unifiedTCI-StateType is configured for the UE and srs-PowerControlAdjustmentStates above is not configured in a particular SRS resource set as separateClosedLoop (e.g., srs-PowerControlAdjustmentStates is not configured or is configured as sameAsFci2), the UE may consider or determine that SRS resources included in the particular SRS resource set are connected to a first or second closed loop index connected to a PUSCH. If a closed loop connected to a TCI state indicated by the base station is i0, the UE may consider or determine that, at the time of determination of the transmission power of an SRS to which the indicated TCI state is applied, the SRS resources are connected to the first closed loop index connected to a PUSCH. If the closed loop is i1, the UE may consider or determine that, at the time of determination of the transmission power of an SRS to which the indicated TCI state is applied, the SRS resources are connected to the second closed loop index connected to a PUSCH.
pathlossReferenceRSList: A list of reference signals capable of measuring a pathloss amount for determining SRS transmission power may be configured for the UE through pathlossReferenceRSList.
followUnifiedTCI-StateSRS-r17: The UE may determine, through followUnifiedTCI-StateSRS-r17, whether a joint TCI state or UL TCI state indicated to the UE through DCI is applied to an SRS resource in an SRS resource set described above, when the UE operates according to a unified TCI state (e.g., unifiedTCI-StateType is configured for the UE). If the higher layer signaling is configured as enabled, the UE may apply a joint TCI state or UL TCI state indicated through DCI to an SRS resource in the SRS resource set described above. If followUnifiedTCI-StateSRS-r17 is not configured for the UE, a joint TCI state or UL TCI state may be configured for the UE with respect to each SRS resource in the SRS resource set described above, and the UE may not apply a joint TCI state or UL TCI state indicated through DCI to the SRS resources in the SRS resource set described above. If the usage of the SRS resource set is configured as beam management and resourceType is aperiodic, or if the usage of the SRS resource set is configured as codebook, non-codebook, or antenna switching and resourceType is aperiodic, semi-persistent, or periodic, followUnifiedTCI-StateSRS-r17 may be configured for the UE.
applyIndicatedTCI-State-r18: Which TCI state the UE is to apply to an SRS resource in an SRS resource set for which applyIndicatedTCI-State-r18 is configured may be configured for the UE through applyIndicatedTCI-State-r18 when the UE operates according to a unified TCI state (e.g., unifiedTCI-StateType is configured for the UE and the UE operates for multiple TRPs). If followUnifiedTCI-StateSRS-r17 above is configured for the UE, applyIndicatedTCI-State-r18 may not be configured for the UE. If the usage of the SRS resource set is configured as beam management and resourceType is aperiodic, or if the usage of the SRS resource set is configured as codebook, non-codebook, or antenna switching and resourceType is aperiodic, semi-persistent, or periodic, applyIndicatedTCI-State-r18 may be configured in the SRS resource set for the UE.
   In a case where the UE operates for single-DCI-based multiple TRPs (e.g., two joint TCI states, two DL TCI states, or two UL TCI states are configured for the UE in at least one codepoint of a TCI state field in DCI), if applyIndicatedTCI-State-r18 is configured for the UE as first, the UE may apply a first joint TCI state or first UL TCI state to at least one SRS resource in an SRS resource set for which applyIndicatedTCI-State-r18 is configured, among at least one joint TCI state or at least one UL TCI state indicated to the UE through DCI. If applyIndicatedTCI-State-r18 is configured for the UE as second, the UE may apply a second joint TCI state or second UL TCI state to at least one SRS resource in an SRS resource set for which applyIndicatedTCI-State-r18 is configured, among at least one joint TCI state or at least one UL TCI state indicated to the UE through DCI. If applyIndicatedTCI-State-r18 is not configured for the UE, a joint TCI state or UL TCI state may be configured for the UE with respect to each of at least one SRS resource in an SRS resource set, and the UE may not apply a joint TCI state or UL TCI state indicated through DCI to the SRS resources in the SRS resource set.
   In a case where the UE operates for multi-DCI-based multiple TRPs (e.g., two different values of CORESETPoolIndex are configured for the UE), if applyIndicatedTCI-State-r18 is configured for the UE as first or second, the UE may apply a joint TCI state or UL TCI state indicated through DCI received in a CORESET configured to have CORESETPoolIndex of 0 or 1, to at least one SRS resource in an SRS resource set for which applyIndicatedTCI-State-r18 is configured. If applyIndicatedTCI-State-r18 is not configured for the UE and an SRS resource set configured to have resourceType being aperiodic is triggered through DCI, the UE may determine a joint TCI state or UL TCI state to be applied to at least one SRS resource in the SRS resource set for which applyIndicatedTCI-State-r18 is configured, according to which CORESETPoolIndex a CORESET, in which DCI has been received, is configured to have. For example, if applyIndicatedTCI-State-r18 is not configured for the UE, followUnifiedTCI-StateSRS-r17 above is configured for the UE, and an SRS resource set configured to have resourceType being aperiodic is triggered through DCI received in a CORESET configured to have CORESETPoolIndex of 0, the UE may apply a joint TCI state or UL TCI state indicated through DCI received in a CORESET configured to have CORESETPoolIndex of 0, to at least one SRS resource in the SRS resource set. For example, if applyIndicatedTCI-State-r18 is not configured for the UE, and an SRS resource set configured to have resourceType being aperiodic is triggered through DCI received in a CORESET configured to have CORESETPoolIndex of 1, the UE may apply a joint TCI state or UL TCI state indicated through DCI received in a CORESET configured to have CORESETPoolIndex of 1, to at least one SRS resource in the SRS resource set. If applyIndicatedTCI-State-r18 is not configured for the UE, and followUnifiedTCI-StateSRS-r17 above is not configured for the UE, a joint TCI state or UL TCI state may be configured for the UE with respect to each of at least one SRS resource in an SRS resource set, and the UE may not apply a joint TCI state or UL TCI state indicated through DCI to the SRS resources in the SRS resource set.

In consideration of the higher layer signaling structure described above, the UE may use two types of uplink transmission power determination methods when operating according to a unified TCI state.

### [Method 1-1] Basic Transmission Power Determination Method: Application of Common Transmission Power Parameter

The parameter ul-powerControl may be configured for the UE with respect to each of at least one uplink bandwidth part configured in a particular serving cell. For example, at the time of all uplink transmission in each uplink bandwidth part, the UE may apply a set of transmission power parameters (e.g., p0, alpha, and closed loop index) identifiable through ul-powerControl configured for a corresponding uplink bandwidth part. Therefore, the UE does not use an individual transmission power parameter according to an uplink channel and signal, and may use only one common set of transmission power parameters.

### [Method 1-2] Additional Transmission Power Determination Method: Different Transmission Power Parameters Applicable

The parameter ul-powerControl is not configured for each of at least one uplink bandwidth part configured in a particular serving cell, and the UE may apply a set of transmission power parameters (e.g., p0, alpha, and closed loop index) identifiable through the higher layer signaling ul-powerControl-r17 in a joint TCI state or UL TCI state as shown in Table 26 or Table 27 above. Therefore, different values of ul-powerControl-r17 may be configured for the UE according to different joint TCI states or UL TCI states. Therefore, the UE may operate various transmission power parameters compared to [Method 1-1], and use different transmission power parameters according to uplink transmission situations and UE and base station operation scenarios.

Commonly for [Method 1-1] and [Method 1-2] described above, a reference signal for pathloss amount measurement may be configured for the UE in a joint TCI state or UL TCI state. For example, as described above, if the UE operates according to a unified TCI state, a reference signal for pathloss amount measurement may be always configured for the UE in a joint TCI state or UL TCI state. Furthermore, the UE may determine a pathloss amount to be reflected at the time of determination of uplink transmission power by using a reference signal for pathloss amount measurement configured in a configured and indicated unified TCI state. In addition, the UE may track a maximum of four reference signals for pathloss amount measurement per random serving cell to update a maximum of four different pathloss amounts.

The UE may transfer whether the UE supports at least one combination of [Method 1-1] and [Method 1-2] above, to the base station through a UE capability report. In addition, at least one combination of [Method 1-1] and [Method 1-2] above may be configured for the UE by the base station through higher layer signaling.

### Second Embodiment: Method of Calculating Pathloss Amount Difference Value by UE and Base Station

As an embodiment of the disclosure, a method of calculating a pathloss amount difference value by a UE and a base station is described. This embodiment may be operated in combination with other embodiments.

FIG. 13 illustrates an example of an operation of a UE and a base station operating as multiple TRPs including a TRP supporting only an uplink reception function according to an embodiment of the disclosure.

Referring to FIG. 13, a UE 1310 may operate while being connected to a base station operating as multiple TRPs as described above. In an embodiment, the UE may assume that each of the multiple TRPs supports both uplink reception and downlink transmission. The base station may operate a TRP 1305 supporting only an uplink reception function in addition to a conventional TRP 1300 capable of both uplink reception and downlink transmission. The UE may be aimed at energy saving gains that may be achieved by improving uplink coverage or saving downlink transmission power at the base station. The above TRP supporting only uplink reception may be named a UL-only TRP. The UE may assume that there is no downlink transmission from the UL-only TRP. As an assumption for the UL-only TRP, the base station and the UE may consider at least one combination of the following.
The UL-only TRP may operate as a UL-only TRP only for particular UEs. For example, the UL-only TRP actually has both an uplink reception and downlink transmission functions, but may support only an uplink reception function for particular UEs under a particular condition (e.g., the UE is notified of being connected to the UL-only TRP through at least one combination of particular higher layer signaling, MAC-CE, and L1 signaling). For example, the UL-only TRP may support downlink transmission to other UEs. When particular UEs exist on the boundary of a random cell coverage, the UL-only TRP may expand uplink coverage by additionally operating only a reception function of a TRP previously installed or newly installed near the corresponding location.
The UL-only TRP may be a TRP that does not support a downlink transmission function and supports only an uplink reception function to all the UEs. For example, the UL-only TRP is a TRP with relatively low production and installation costs, and may receive uplink transmission of a UE in addition to previously installed TRPs so as to enable the base station to obtain reception diversity.

The UE may receive a pathloss amount measurement reference signal from the TRP 1300 capable of uplink and downlink operations, but there is no downlink transmission from the UL-only TRP 1305. Therefore, when the UE 1310 performs uplink transmission to the UL-only TRP 1305, there may be a problem in that it is impossible to identify the pathloss amount between the UL-only TRP and the UE. In order to solve the above situation, the base station and the UE may consider at least one combination of the following methods to obtain pathloss amount information between the UL-only TRP and the UE.

### [Method 2-1]

FIG. 14 is a diagram illustrating a method of calculating and updating a pathloss amount difference value according to an embodiment of the disclosure.

Referring to FIG. 14, a UE 1400 may operate while being connected to a base station configured by a TRP (e.g., TRP1 1410) capable of uplink and downlink operations and a UL-only TRP (e.g., TRP2 1405) capable of performing only uplink reception. The UE 1400 and the base station may undergo a series of processes of exchanging a signal between the UE 1400 and the base station in order to obtain information on a pathloss amount between TRP2 1405 and the UE 1400.

### [Process 2-1] Uplink Transmission by UE

The UE 1400 may transmit an uplink signal to TRP1 1405 and TRP2 1410 (operation 1415). If the UE operates in FR1, the UE may be able to perform uplink signal transmission to TRP1 1405 and TRP2 1410 by using only single uplink transmission. If the UE operates in FR2, the UE may perform individual uplink transmission to TRP1 1405 and TRP2 1410 by applying different transmission beams to the TRPs. If the UE operates in FR2, when the transmission powers of individual uplink signals transmitted to TRP1 1405 and TRP2 1410 are determined, the UE may use the same transmission power parameter (operation 1420). For example, when the UE determines the transmission powers of two uplink signals, the UE may consider the same p0, alpha, and closed loop index, and the pathloss amount between TRP1 1405 and the UE. Therefore, even for the transmission power of an uplink signal transmitted by the UE to TRP2 1410, the UE may apply the pathloss amount between TRP1 1405 and the UE when determining the transmission power.

### [Process 2-2] Calculation of Pathloss Amount Difference by Base Station

Thereafter, TRP1 1405 and TRP2 1410 may receive respective uplink transmissions of the UE to calculate P1 1425 and P2 1430 that are reception powers at the respective TRPs. TRP2 1410 may transfer P2 to TRP1 1405 (operation 1435). TRP1 1405 having received P2 from TRP2 1410 may calculate d_P that is the difference between P1 and P2 (operation 1440). When TRP1 1405 calculates d_P (operation 1440), TRP1 1405 may consider at least one of a reception beam gain at TRP1 1405, a reception beam gain at TRP2 1410, respective transmission beam gains considered by the UE at the time of transmission to TRP1 1405 and TRP2 1410 in a case of FR2, and a maximum permissible exposure (MPE) value enabling determination of a reduced transmission power amount for each transmission beam.

### [Process 2-3] Transfer of Pathloss Amount Difference to UE

The base station may calculate d_P that is the difference between the pathloss amount between TRP1 1405 and the UE and the pathloss amount between TRP2 1410 and the UE and then notify the UE of the calculated value (operation 1445). The UE may obtain the value of d_P through the above process (operation 1450) and then, when performing uplink transmission to TRP2 1410, may determine uplink transmission power for TRP2 1410 by additionally applying the obtained d_P value to a pathloss amount which may be measured through a reference signal for pathloss amount measurement which may be received from TRP1 1405.

Through [Process 2-1] to [Process 2-3] above, the base station may calculate d_P that is a difference value between the pathloss amount between TRP1 and the UE and the pathloss amount between TRP2 and the UE by using reception power information of an uplink signal of the UE. In [Process 2-3] above, the base station may process at least one d_P value calculated by repeating [Process 2-1] and [Process 2-2] one or more times (e.g., taking an arithmetic mean thereof) and transfer the processed value to the UE.

In a case where the UE is not a UE fixed at a particular location such as customer premises equipment (CPE), the UE, such as a smartphone, a smartwatch, and a tablet, is not fixed in location and may have mobility, and thus d_P may be a value that changes over time. Therefore, it may be required that [Process 2-1] to [Process 2-3] above are configured or activated to be repeated for the UE periodically or semi-persistently, or aperiodically triggered for the UE. In order to identify a changing d_P value and transfer same to the UE, the following additional processes may be considered between the UE and the base station.

[Process 2-4] Uplink Transmission by UE after Acquisition of d_P

The UE may, after obtaining d_P from the base station, transmit an uplink signal to TRP1 1405 and TRP2 1410 (operation 1455). If the UE operates in FR1, the UE may be able to perform uplink signal transmission to TRP1 1405 and TRP2 1410 by using only single uplink transmission. If the UE operates in FR2, the UE may perform individual uplink transmission to TRP1 1405 and TRP2 1410 by applying different transmission beams to the TRPs. If the UE operates in FR2, when the transmission powers of individual uplink signals transmitted to TRP1 1405 and TRP2 1410 are determined, the UE may use the same transmission power parameter (operation 1460). For example, when the UE determines the transmission powers of two uplink signals, the UE may consider the same p0, alpha, and closed loop index, and the pathloss amount between TRP1 1405 and the UE. In addition, although the UE has obtained the value of d_P through [Process 2-3] above, the UE may perform transmission without applying d_P when determining uplink transmission power for TRP2 1410 so that the UE applies the same transmission power parameter to the two TRPs to enable the base station to calculate a difference value between the pathloss amount between TRP1 1405 and the UE and the pathloss amount between TRP2 1410 and the UE (operation 1460). Therefore, even for the transmission power of an uplink signal transmitted by the UE to TRP2 1410, the UE may apply only the pathloss amount between TRP1 1405 and the UE when determining the transmission power.

### [Process 2-5] Calculation of Pathloss Amount Difference by Base Station

Thereafter, TRP1 1405 and TRP2 1410 may receive respective uplink transmissions of the UE in [Process 2-4] above to calculate P1′ 1465 and P2′ 1470 that are reception powers at the respective TRPs. TRP2 1410 may transfer P2′ to TRP1 1405 (operation 1475). TRP1 1405 having received P2′ from TRP2 1410 may calculate d_P′ that is the difference between P1′ and P2′ (operation 1480). When TRP1 1405 calculates d_P′ (operation 1480), TRP1 1405 may consider at least one of a reception beam gain at TRP1 1405, a reception beam gain at TRP2 1410, respective transmission beam gains considered by the UE at the time of transmission to TRP1 1405 and TRP2 1410 in a case of FR2, and a maximum permissible exposure (MPE) value enabling determination of a reduced transmission power amount for each transmission beam.

### [Process 2-6] Transfer of Pathloss Amount Difference to UE

The base station may calculate d_P′ that is the difference between the pathloss amount between TRP1 1405 and the UE and the pathloss amount between TRP2 1410 and the UE and then notify the UE of the value (operation 1485). Through the above process, the UE may obtain the value of d_P′ updated compared to the previously obtained d_P value (operation 1490). Thereafter, when performing uplink transmission to TRP2 1410, the UE may determine uplink transmission power for TRP2 1410 by additionally applying the obtained d_P′ value to a pathloss amount which may be measured through a reference signal for pathloss amount measurement which may be received from TRP1 1405.

Thereafter, the UE and the base station may repeat [Process 2-4] to [Process 2-6] above to calculate and share an updated value of the value of d_P. In [Process 2-6] above, the base station may process at least one d_P value calculated by repeating [Process 2-4] and [Process 2-5] one or more times (e.g., taking an arithmetic mean thereof) and transfer the processed value to the UE.

If the UE performs uplink transmission occurring in [Process 2-1] and [Process 2-4] above, at least one SRS resource in an SRS resource set configured to have the higher layer signaling resourceType being periodic, semi-persistent, or aperiodic may be configured for the UE and the UE may perform [Process 2-1] and [Process 2-4] above, based on SRS transmission, and such the at least one SRS resource may all have the same transmission power parameter. If the UE operates in FR1, the UE may apply the same transmission power parameter (e.g., p0, alpha, closed loop index, and pathloss amount) to TRP1 1405 and TRP2 1410, based on one SRS resource in a corresponding SRS resource set. Even for uplink transmission to TRP2 1410, the UE may not apply a pathloss amount difference value when determining transmission power as described above. If the UE operates in FR2, the UE may apply the same transmission power parameter (e.g., p0, alpha, closed loop index, and pathloss amount) to TRP1 1405 and TRP2 1410, based on at least one SRS resource in an SRS resource set, and apply different transmission beams to the respective SRS resources. Similarly, even for uplink transmission to TRP2 1410, the UE may not apply a pathloss amount difference value when determining transmission power as described above.

The UE may perform uplink transmission occurring in [Process 2-1] and [Process 2-4] above through even an uplink channel and signal (e.g., PUCCH, PUSCH, or PRACH) other than an SRS.

When the UE performs uplink transmission occurring in [Process 2-1] and [Process 2-4] above, the UE is required to apply the same transmission power to uplink channels or signals transmitted to TRP1 1405 and TRP2 1410 in each process, but it may be possible to use different transmission power parameters between processes (e.g., a transmission power parameter used in [Process 2-1] and a transmission power parameter used in [Process 2-4]). For example, if the UE uses a first p0 value, a first alpha value, a first closed loop index, and a first pathloss amount to determine uplink transmission power and perform transmission to TRP1 1405 and TRP2 1410 in [Process 2-1], it may be possible for the UE to use a second p0 value, a second alpha value, a second closed loop index, and a second pathloss amount to determine uplink transmission power and perform transmission to TRP1 1405 and TRP2 1410 in [Process 2-4]. The first p0 value and the second p0 value may be identical to or different from each other, and a similar relation may be applied to other transmission power parameters.

In a case of [Method 2-1] above, the UE may receive the value of d_P from the base station through [Process 2-3] and [Process 2-6] above. In a case of [Method 2-1], the UE receives the value of d_P from the base station and thus may receive an incorrect value compared to receiving the value of d_P″, which may be considered in [Method 2-2] below, when the same quantization bit amount is considered. However, as described above, absence of a restriction that use of the same transmission power parameter is required at respective transmission time points, as shown in [Process 2-1] and [Process 2-4] above, may give flexibility to the base station in operating such uplink transmission.

### [Method 2-2]

FIG. 15 illustrates an example of a method of calculating and updating a pathloss amount difference value according to an embodiment of the disclosure.

Referring to FIG. 15, a UE 1500 may operate while being connected to a base station configured by a TRP (e.g., TRP1 1510) capable of uplink and downlink operations and a UL-only TRP (e.g., TRP2 1505) capable of performing only uplink reception. The UE 1500 and the base station may undergo a series of processes of exchanging a signal between the UE 1500 and the base station in order to obtain information on a pathloss amount between TRP2 1510 and the UE 1500.

### [Process 3-1] Uplink Transmission by UE

The UE 1500 may transmit an uplink signal to TRP1 1505 and TRP2 1510 (operation 1515). If the UE operates in FR1, the UE may be able to perform uplink signal transmission to TRP1 1505 and TRP2 1510 by using only single uplink transmission. If the UE operates in FR2, the UE may perform individual uplink transmission to TRP1 1505 and TRP2 1510 by applying different transmission beams to the TRPs. If the UE operates in FR2, when the transmission powers of individual uplink signals transmitted to TRP1 1505 and TRP2 1510 are determined, the UE may use the same transmission power parameter (operation 1520). For example, when the UE determines the transmission powers of two uplink signals, the UE may consider the same p0, alpha, and closed loop index, and the pathloss amount between TRP1 1505 and the UE. Therefore, even for the transmission power of an uplink signal transmitted by the UE to TRP2 1510, the UE may apply the pathloss amount between TRP1 1505 and the UE when determining the transmission power.

### [Process 3-2] Calculation of Pathloss Amount Difference by Base Station

Thereafter, TRP1 1505 and TRP2 1510 may receive respective uplink transmissions of the UE to calculate P1 1525 and P2 1530 that are reception powers at the respective TRPs. TRP2 1510 may transfer P2 to TRP1 1505 (operation 1535). TRP1 1505 having received P2 from TRP2 1510 may calculate d_P that is the difference between P1 and P2 (operation 1540). When TRP1 1505 calculates d_P (operation 1540), TRP1 1505 may consider at least one of a reception beam gain at TRP1 1505, a reception beam gain at TRP2 1510, respective transmission beam gains considered by the UE at the time of transmission to TRP1 1505 and TRP2 1510 in a case of FR2, and a maximum permissible exposure (MPE) value enabling determination of a reduced transmission power amount for each transmission beam.

### [Process 3-3] Transfer of Pathloss Amount Difference to UE

The base station may calculate d_P that is the difference between the pathloss amount between TRP1 1505 and the UE and the pathloss amount between TRP2 1510 and the UE and then notify the UE of the value (operation 1545). The UE may obtain the value of d_P through the above process (operation 1550) and then, when performing uplink transmission to TRP2 1510, may determine uplink transmission power for TRP2 1510 by additionally applying the d_P value to a pathloss amount which may be measured through a reference signal for pathloss amount measurement which may be received from TRP1 1505.

Through [Process 3-1] to [Process 3-3] above, the base station may calculate d_P that is a difference value between the pathloss amount between TRP1 and the UE and the pathloss amount between TRP2 and the UE by using reception power information of an uplink signal of the UE. In [Process 3-3] above, the base station may process at least one d_P value calculated by repeating [Process 3-1] and [Process 3-2] one or more times (e.g., taking an arithmetic mean thereof) and transfer the processed value to the UE. In addition, in [Process 3-3] above, notifying the UE of the value of d_P by the base station may be performed by the base station one time at the initial time, and thereafter, when the UE and the base station repeat [Process 3-1] and [Process 3-2], the base station may selectively perform [Process 3-3] above.

In a case where the UE is not a UE fixed at a particular location such as customer premises equipment (CPE), the UE, such as a smartphone, a smartwatch, and a tablet, is not fixed in location and may have mobility, and thus d_P may be a value that changes over time. Therefore, it may be required that [Process 3-1] to [Process 3-3] above are configured or activated to be repeated for the UE periodically or semi-persistently, or aperiodically triggered for the UE. While [Process 2-4] to [Process 2-6] above correspond to a method of updating and sharing the value of d_P by the UE and the base station, [Process 3-4] to [Process 3-6] below may correspond to a method of calculating, by the UE and the base station, the change amount of the d_P value obtained through [Process 3-1] to [Process 3-3] above in consideration of the d_P value as an initial value, and sharing the change amount therebetween. In order to identify the change amount of the d_P value and transfer same to the UE as described above, the following additional processes may be considered between the UE and the base station.

[Process 3-4] Uplink Transmission by UE after Acquisition of d_P

The UE may, after obtaining d_P from the base station, transmit an uplink signal to TRP2 1510 (operation 1555). The UE may use p0, alpha, and a closed loop index among the transmission power parameters used in [Process 3-1] above, and in a case of a pathloss amount, apply the d_P value obtained in [Process 3-3] above to the pathloss amount between TRP1 1505 and the UE and use the obtained value (operation 1560). If the UE operates in FR2, the UE may use the same or different transmission beams in [Process 3-1] above and [Process 3-4] here. If the UE may use the same transmission beam in [Process 3-1] above and [Process 3-4] here, the base station does not need to compensate for the difference of a transmission beam gain value caused by the change of a transmission beam by the UE at the time of calculation of the change amount of d_P in a subsequent process. Otherwise (e.g., if the UE may use the different transmission beams in [Process 3-1] above and [Process 3-4] here), the base station may compensate for the difference of each transmission beam gain value in a subsequent process to increase the accuracy of calculation of the change amount of the d_P value.

### [Process 3-5] Calculation of Pathloss Amount Difference by Base Station

Thereafter, TRP2 1510 may receive uplink transmission of the UE in [Process 3-4] above to calculate P2″ 1565 that is reception power. TRP2 1510 may compare a value (e.g., P2−d_P) obtained by subtracting the d_P value from P2 calculated in [Process 3-2] above with the value of P2″. P2 above is a reception power value calculated based on a transmission power parameter not considering the pathloss amount difference value, and P2″ is a reception power value calculated by additionally applying the pathloss amount difference value to the same transmission power parameter as that at the time of P2 calculation above. Therefore, comparing the value obtained by subtracting the d_P value from P2 with P2″ may be performed for the same purpose (or by the same method) as estimating the change amount of the d_P value. Through the above method, TRP2 1510 may calculate the value of d_P″ that is the change amount of the d_P value (operation 1570). When TRP2 1510 calculates d_P″ (operation 1570), TRP2 1510 may consider at least one of a reception beam gain at TRP2 1510, each transmission beam gain considered by the UE at the time of transmission to TRP2 1510 in a case of FR2, and a maximum permissible exposure (MPE) value enabling determination of a reduced transmission power amount for each transmission beam. Thereafter, TRP2 1510 may consider d_P″ to update the previously calculated value of d_P (operation 1571, e.g., d_P=d_P−d_P″). Then, TRP2 1510 may transfer the value of d_P″ to TRP1 1505 (operation 1575).

### [Process 3-6] Transfer of Pathloss Amount Difference to UE

The base station may calculate d_P″ which is the change amount of d_P that is the difference between the pathloss amount between TRP1 1505 and the UE and the pathloss amount between TRP2 1510 and the UE and then notify the UE of the value (operation 1580). The UE may, through the above process, apply the change amount of the d_P value to the previously calculated value of d_P to obtain a d_P value updated compared to the previous value (operation 1585) and then, when performing uplink transmission to TRP2 10, may determine uplink transmission power for TRP2 1510 by additionally applying the d_P value that is the pathloss amount difference and the d_P″ value that is the change amount of the d_P value to a pathloss amount which may be measured through a reference signal for pathloss amount measurement which may be received from TRP1 1505.

Thereafter, the UE and the base station may repeat [Process 3-4] to [Process 3-6] above to calculate and share an updated value of the value of d_P. In [Process 3-6] above, the base station may process at least one d_P″ value calculated by repeating [Process 3-4] and [Process 3-5] one or more times (e.g., taking an arithmetic mean thereof) and transfer the processed value to the UE. In addition, TRP2 1510 may, in [Process 3-5] above, process at least one d_P″ value calculated by repeating [Process 3-4] and [Process 3-5] one or more times (e.g., taking an arithmetic mean thereof) and use the processed value to update the d_P value.

If the UE performs uplink transmission occurring in [Process 3-1] above, at least one SRS resource in an SRS resource set configured to have the higher layer signaling resourceType being periodic, semi-persistent, or aperiodic may be configured for the UE and the UE may perform same, based on SRS transmission. The at least one SRS resource may all have the same transmission power parameter. If the UE operates in FR1, the UE may apply the same transmission power parameter (e.g., p0, alpha, closed loop index, and pathloss amount) to TRP1 1505 and TRP2 1510, based on one SRS resource in a corresponding SRS resource set, and even for uplink transmission to TRP2 1510, the UE may not apply a pathloss amount difference value when determining transmission power as described above. If the UE operates in FR2, the UE may apply the same transmission power parameter (e.g., p0, alpha, closed loop index, and pathloss amount) to TRP1 1505 and TRP2 1510, based on at least one SRS resource in a corresponding SRS resource set, and apply different transmission beams to the respective SRS resources. Similarly to the above description, even for uplink transmission to TRP2 1510, the UE may not apply a pathloss amount difference value when determining transmission power.

If the UE performs uplink transmission occurring in [Process 3-4] above, at least one SRS resource in an SRS resource set configured to have the higher layer signaling resourceType being periodic, semi-persistent, or aperiodic may be configured for the UE and the UE may perform same, based on SRS transmission, and such the at least one SRS resource may all have the same transmission power parameter.

If the UE performs both uplink transmission in [Process 3-1] above and uplink transmission in [Process 3-4] above, based on an SRS resource in an SRS resource set configured to have resourceType being periodic or semi-persistent, the UE may assume that the period of uplink transmission for [Process 3-1] above is equal to or longer than that of uplink transmission for [Process 3-4] above. For example, if the period of uplink transmission for [Process 3-1] above is 10 slots and the period of uplink transmission for [Process 3-4] above is 2 slots, the UE may not consider a restriction that the transmission parameters at respective transmission time points of uplink transmissions for [Process 3-1] above need to be identical. In addition, if transmissions to TRP1 1505 and TRP2 1510 are individually performed at respective transmission time points of uplink transmissions for [Process 3-1] above as described above, the UE may consider the transmission parameters at the time of the transmissions to the two TRPs to be same. In addition, in a case of uplink transmission for [Process 3-4] above, the UE may use a transmission power parameter used in the transmission period of the latest uplink transmission for [Process 3-1] above performed before the uplink transmission. For example, if uplink transmission for [Process 3-1] above has been performed in slot n and a first transmission power parameter set has been used at the time, the UE may use the first transmission power parameter set when uplink transmission for [Process 3-4] above is performed, before slot n+10, that is the next period, from the corresponding slot (e.g., slot n). In addition, the UE may also apply the above pathloss amount difference value at the time of uplink transmission for [Process 3-4] above as described above. This is because, in [Process 3-4] above, since TRP2 1510 considers a P2 value that is reception power calculated through previous uplink transmission when calculating d_P″, a restriction that the transmission parameters at the time of two uplink transmissions need to be identical is required so that calculation of more correct d_P″ value is possible.

The UE may perform uplink transmission occurring in [Process 3-1] and [Process 3-4] above through even an uplink channel and signal (e.g., PUCCH, PUSCH, or PRACH) other than an SRS.

In a case of [Method 2-2] above, the UE may receive the value of d_P from the base station through [Process 3-3] above one time at the initial time, and may be notified of the value of d_P″ from the base station through [Process 3-6] above. In a case of [Method 2-2] above, since different uplink transmissions for [Process 3-1] and [Process 3-4] above may be required to be configured for the UE by the base station, signaling overhead may be added. However, when the same quantization bit amount is considered, there is an advantage in that the UE may receive a more correct value for a pathloss amount difference value through receiving the value of d_P″ compared to receiving the value of d_P from the base station.

Through [Method 2-1] and [Method 2-2] above, the UE may use a modified transmission power calculation equation as below when uplink transmission power for a UL-only TRP is determined.

For example, when determining PUCCH transmission power for a UL-only TRP supporting only an uplink reception operation, the UE may modify Equation 2 above to Equation 11 and use same. PL_{off,b,f,c} (q_{d}*) in Equation 11 below may be considered or determined as a d_P value described above that is a pathloss amount difference, and q_{d} may imply that the pathloss amount difference corresponds to at least one pathloss amount measurement reference signal. The UE may consider or determine q_{d}*=q_{d} if q_{d} corresponds to one pathloss amount measurement reference signal.

$${P}_{PUCCH , b , f , c} ( i , {q}_{u} , {q}_{d} , l ) = min \{ \begin{matrix}{P}_{CMAX , f , c} ( i ) , \\ {P}_{{0}_{PUCCH} , b , f , c} ( {q}_{u} ) + 10 {log}_{10} ( {2}^{μ} * {M}_{RB , b , f , c}^{PUCCH} ( i ) ) + {PL}_{b , f , c} ( {q}_{d} ) + \\ {PL}_{off , b , f , c} ( {q}_{d}^{*} ) + {Δ}_{{F}_{PUCCH}} ( F ) + {Δ}_{TF , b , f , c} ( i ) + {f}_{b , f , c} ( i , l )\end{matrix} \} [ dBm ] \qquad [ Equation 11 ]$$

example, when determining PUSCH transmission power for a UL-only TRP supporting only an uplink reception operation, the UE may modify Equation 4 above to Equation 12 or Equation 13 and use same. The UE may consider or determine PL_{off,b,f,c}(q_{d}*) in Equation 12 or Equation 13 below as a d_P value described above that is a pathloss amount difference, and q_{d} may imply that the pathloss amount difference corresponds to at least one pathloss amount measurement reference signal. The UE may consider or determine q_{d}*=q_{d} if q_{d}* corresponds to one pathloss amount measurement reference signal. Equation 12 or Equation 13 may be distinguished according to whether the value of PL_{off,b,f,c}(q_{d}) that is a pathloss amount difference is directly applied to a pathloss amount.

$${P}_{PUSCH , b , f , c} ( i , j , {q}_{d} , l ) = min \{ \begin{matrix}{P}_{CMAX , f , c} ( i ) , \\ {P}_{{0}_{PUSCH} , b , f , c} ( j ) + 10 {log}_{10} ( {2}^{μ} * {M}_{RB , b , f , c}^{PUSCH} ( i ) ) + {α}_{b , f , c} ( j ) \cdot \\ ( {PL}_{b , f , c} ( {q}_{d} ) + {PL}_{off , b , f , c} ( {q}_{d}^{*} ) ) + {Δ}_{TF , b , f , c} ( i ) + {f}_{b , f , c} ( i , l )\end{matrix} \} [ dBm ] \qquad [ Equation 22 ]$$

$${P}_{PUSCH , b , f , c} ( i , j , {q}_{d} , l ) = min \{ \begin{matrix}{P}_{CMAX , f , c} ( i ) , \\ {P}_{{0}_{PUSCH} , b , f , c} ( j ) + 10 {log}_{10} ( {2}^{μ} * {M}_{RB , b , f , c}^{PUSCH} ( i ) ) + {α}_{b , f , c} ( j ) \cdot \\ {PL}_{b , f , c} ( {q}_{d} ) + {PL}_{off , b , f , c} ( {q}_{d}^{*} ) + {Δ}_{TF , b , f , c} ( i ) + {f}_{b , f , c} ( i , l )\end{matrix} \} [ dBm ] \qquad uation 33 ]$$

example, when determining PUSCH transmission power for a UL-only TRP supporting only an uplink reception operation, the UE may modify Equation 7 above to Equation 14 or Equation 15 below and use same. PL_{off,b,f,c}(q_{d}) in Equation 14 or Equation 15 below may be considered or determined as a d_P value described above that is a pathloss amount difference, and q_{d} may imply that the pathloss amount difference corresponds to at least one pathloss amount measurement reference signal. The UE may consider or determine q_{d}*=q_{d} if q_{d} corresponds to one pathloss amount measurement reference signal. Equation 14 or Equation 15 may be distinguished according to whether the value of PL_{off,b,f,c}(q_{d}) that is a pathloss amount difference is directly applied to a pathloss amount.

$${P}_{SRS , b , f , c} ( i , {q}_{s} , l ) = min \{ \begin{matrix}{P}_{CMAX , f , c} ( i ) , \\ {P}_{{0}_{SRS} , b , f , c} ( {q}_{s} ) + 10 {log}_{10} ( {2}^{μ} * {M}_{SRS , b , f , c} ( i ) ) + {α}_{SRS , b , f , c} ( {q}_{s} ) \cdot \\ ( {PL}_{b , f , c} ( {q}_{d} ) + {PL}_{off , b , f , c} ( {q}_{d}^{*} ) ) + {h}_{b , f , c} ( i , l )\end{matrix} \} [ dBm ] \qquad [ Equation 44 ]$$

$${P}_{SRS , b , f , c} ( i , {q}_{s} , l ) = min \{ \begin{matrix}{P}_{CMAX , f , c} ( i ) , \\ {P}_{{0}_{SRS} , b , f , c} ( {q}_{s} ) + 10 {log}_{10} ( {2}^{μ} * {M}_{SRS , b , f , c} ( i ) ) + {α}_{SRS , b , f , c} ( {q}_{s} ) \cdot \\ {PL}_{b , f , c} ( {q}_{d} ) + {PL}_{off , b , f , c} ( {q}_{d}^{*} ) + {h}_{b , f , c} ( i , l )\end{matrix} \} [ dBm ] \qquad uation 55 ]$$

UE may be notified of at least one combination of [Method 2-1] and [Method 2-2] above by the base station through at least one combination of higher layer signaling, MAC-CE signaling, or L1 signaling, or may expect that at least one combination of [Method 2-1] and [Method 2-2] above is fixedly defined in a specification. Additionally, if the UE is notified by the base station of at least one particular combination of methods through at least one combination of higher layer signaling, MAC-CE signaling, or L1 signaling, the UE may be unable to support at least another particular combination of methods. For example, the UE may expect that [Method 2-1] or [Method 2-2]above is fixedly defined in a specification with respect to a method of obtaining and updating a pathloss amount difference. For example, the UE may be notified by the base station of [Method 2-1] above through at least one combination of higher layer signaling, MAC-CE signaling, or L1 signaling. The UE may consider or determine that the UE has been notified by the base station that [Method 2-2] above is not supported.

The UE may report whether the UE is able to support at least one combination of [Method 2-1] and [Method 2-2] above to the base station as a UE capability. If the UE has reported, to the base station as a UE capability, whether the UE is able to at least one particular combination of methods, it may be considered or determined that the UE has reported that the UE is unable to support at least another particular combination of methods. For instance, the UE may report, to the base station, whether the UE is able to support [Method 2-1] or [Method 2-2] above. For example, the UE may report, to the base station, that the UE is able to support [Method 2-1] above, and a UE capability report may imply that the UE is unable to support [Method 2-2].

### Third Embodiment: Method of Updating Pathloss Amount Difference Value by UE and Base Station

As an embodiment of the disclosure, a method of updating a pathloss amount difference value by a UE and a base station is described. This embodiment may be operated in combination with other embodiments.

The UE may receive, from the base station in [Process 2-3] and [Process 2-6] in [Method 2-1] above and in [Process 3-3] in [Method 2-2] above, a d_P value that is a difference value between the pathloss amount between the UE and a TRP capable of both uplink and downlink operations and the pathloss amount between the UE and a UL-only TRP capable of only an uplink reception operation. In addition, the UE may receive a d_P″ value that is the change amount of the d_P from the base station in [Process 3-6] in [Method 2-2] above. The d_P value or d_P″ value may be a random integer in the unit of dB. For example, the UE may assume that the distance between the UE and the TRP capable of only an uplink reception operation is shorter than that between the UE and the TRP capable of both uplink and downlink operations. Under the above assumption, only a value of 0 or smaller may be possible as the d_P value, and an integer may be possible as the d_P″ value. The UE may consider at least one combination of the following items as a method of receiving a pathloss amount difference value or a change amount thereof from the base station.

### [Method 3-1]

A d_P value that is the pathloss amount difference value or a d_P″ value that is the change amount of the d_P value may be configured for the UE by the base station through higher layer signaling. At least one d_P value that is the pathloss amount difference value or at least one d_P″ value that is the change amount of the d_P value may be configured for the UE per bandwidth part or per cell. For example, four d_P values or d_P″ values corresponding to the maximum number of pathloss amount measurement reference signals trackable by the UE in a particular cell may be configured for the UE through higher layer signaling. The UE may receive a d_P value that is the pathloss amount difference value or a d_P″ value that is the change amount of the d_P value from the base station through only higher layer signaling through the above method, and thus if RRC reconfiguration is not performed for the UE, the UE is unable to change the configured value.

In a case where, as in [Method 3-1], a d_P value that is the pathloss amount difference value or a d_P″ value that is the change amount of the d_P value is configured for the UE through higher layer signaling, flexibility may not be ensured in that a pathloss amount difference value is semi-statically configured and fails to be dynamically changed between the UE and the base station. In addition, if the UE has mobility, a time interval for correcting a pathloss amount difference value may be very long. However, if the UE has a fixed location or very low mobility such as CPE or information exchange between TRPs is very low, the above method may be effective when determining transmission power at the time of uplink transmission to a UL-only TRP by saving additional dynamic signaling and reflecting the pathloss amount difference value.

### [Method 3-2]

A d_P value that is the pathloss amount difference value or a d_P″ value that is the change amount of the d_P value may be configured for the UE by the base station through higher layer signaling and then the UE may receive MAC-CE signaling from the base station to update the preconfigured value. At least one d_P value that is the pathloss amount difference value or at least one d_P″ value that is the change amount of the d_P value may be configured for the UE per bandwidth part or per cell. For example, four d_P values or d_P″ values corresponding to the maximum number of pathloss amount measurement reference signals trackable by the UE in a particular cell may be configured for the UE through higher layer signaling. The UE may consider at least one combination of the following items as information which may be included in MAC-CE signaling. However, the disclosure is not limited to the example below:
Serving cell ID field (e.g., 5 bits);
Uplink bandwidth part ID field (e.g., 2 bits);
Pathloss amount measurement reference signal ID field (e.g., 6 bits);
Pathloss amount measurement reference signal group field (e.g., 2 bits);
Activated pathloss amount measurement reference signal ID field (e.g., 2 bits);
Pathloss amount difference value (d_P) field (e.g., 5-8 bits);
Change amount (d_P″) field (e.g., 5-8 bits) of pathloss amount difference value; and/or
Joint TCI state or UL TCI state field (each field is 7 or 6 bits).

As an example of a combination of MAC-CE signaling configuration information, if one d_P value that is the pathloss amount difference value or one d_P″ value that is the change amount of the d_P value is configured for the UE through higher layer signaling per bandwidth part, the UE may expect that MAC-CE signaling includes at least one of the serving cell ID field, the uplink bandwidth part ID field, the pathloss amount difference value (d_P) field, or the change amount (d_P″) field of the pathloss amount difference value among the above pieces of information. The UE may receive the MAC-CE signaling to update the one d_P value that is the pathloss amount difference value or the one d_P″ value that is the change amount of the d_P value, which is configured in the bandwidth part.

As an example of a combination of MAC-CE signaling configuration information, if one d_P value that is the pathloss amount difference value or one d_P″ value that is the change amount of the d_P value is configured for the UE through higher layer signaling per activated pathloss amount measurement reference signal in a cell, the UE may expect that MAC-CE signaling includes at least one of the serving cell ID field, the uplink bandwidth part ID field, the activated pathloss amount measurement reference signal ID field, the pathloss amount difference value (d_P) field, or the change amount (d_P″) field of the pathloss amount difference value among the above pieces of information. The UE may receive the MAC-CE signaling to update the one d_P value that is the pathloss amount difference value or the one d_P″ value that is the change amount of the d_P value, which is configured for the particular activated pathloss amount measurement reference signal in the cell.

The UE and the base station may additionally define a field indicating the d_P value or d_P″ value in MAC-CE signaling that changes a pathloss amount measurement reference signal and, if the UE receives a MAC-CE, the UE may change the pathloss amount measurement reference signal and, simultaneously, receive an indication of a d_P value or d_P″ value corresponding to the value of the defined field.

After receiving a MAC-CE from the base station, the UE may, after 3 slots from PUCCH transmission including HARQ-ACK information for a PDSCH including the MAC-CE, update a d_P value that is a pathloss amount difference value or d_P″ that is the change amount of the d_P value, which is configured for the UE through higher layer signaling, to a value received through the MAC-CE signaling and apply the updated value when determining uplink transmission power.

In a case where, as in [Method 3-2], the UE updates a d_P value that is a pathloss amount difference value or a d_P″ value that is the change amount of the d_P value to a value received through MAC-CE signaling, the UE may relatively dynamically update the pathloss amount difference value in addition to the method of being semi-statically configured, and thus if the UE has mobility, the method may be useful to compensate for a pathloss amount when the UE determines transmission power. However, as described above, the UE and the base station need to define new MAC-CE signaling, the base station is required to be able to periodically measure a d_P value that is a pathloss amount difference or a d_P″ value that is the change amount of the pathloss amount difference value, and a delay time during information exchange between TRPs needs to be not long.

### [Method 3-3]

A d_P value that is the pathloss amount difference value or a d_P″ value that is the change amount of the d_P value may be configured for the UE by the base station through higher layer signaling and then the UE may receive an indication through DCI. At least one d_P value that is the pathloss amount difference value or at least one d_P″ value that is the change amount of the d_P value may be configured for the UE per bandwidth part or per cell. For example, four d_P values or d_P″ values corresponding to the maximum number of pathloss amount measurement reference signals trackable by the UE in a particular cell may be configured for the UE through higher layer signaling, and the UE may update one of the four d_P values to a value received through DCI.

The UE may define new UE group-common DCI, and may additionally define an RNTI applicable to the UE group-common DCI and the RNTI may be configured for the UE. Then, the UE may receive update information on a d_P value that is the pathloss amount difference value or a d_P″ value that is the change amount of the d_P value through the UE group-common DCI.

Update information on a d_P value that is the pathloss amount difference value or a d_P″ value that is the change amount of the d_P value may be indicated to the UE through a new field in conventional UE-specific DCI (e.g., DCI format 0_1, 0_2, 0_3, 1_1, 1_2, or 1_3).

If the UE updates, through DCI, a d_P value that is the pathloss amount difference value or a d_P″ value that is the change amount of the d_P value, the UE may use a method similar to TPC accumulation or absolute TPC described above. If the UE uses a method such as TPC accumulation described above when updating, through DCI, a d_P value that is the pathloss amount difference value or a d_P″ value that is the change amount of the d_P value, the UE may update the d_P value that is the pathloss amount difference value, which is configured through higher layer signaling, by additionally adding the d_P″ value that is the change amount of the d_P value through DCI. If the UE uses a method such as absolute TPC described above when updating, through DCI, a d_P value that is the pathloss amount difference value or a d_P″ value that is the change amount of the d_P value, the UE may replace the d_P value configured through higher layer signaling with the d_P value received through DCI.

In a case where the UE updates the d_P value or d_P″ value through DCI, the UE may fail to receive DCI, and thus the UE may define a HARQ-ACK transmission operation for DCI and report whether the DCI has been received to the base station to update the d_P value or d_P″ value. For example, the UE may, after 3 slots from PUCCH transmission including HARQ-ACK information for DCI, update a d_P value that is a pathloss amount difference value or d_P″ that is the change amount of the d_P value, which is configured for the UE through higher layer signaling, to a value received through the DCI and apply the updated value when determining uplink transmission power. For example, the UE may, after a particular time from the HARQ-ACK information, update a d_P value that is a pathloss amount difference value or d_P″ that is the change amount of the d_P value, which is configured for the UE through higher layer signaling, to a value received through the DCI and apply the updated value when determining uplink transmission power, and the particular time may be reported as a UE capability.

In a case where, as in [Method 3-3], the UE updates a d_P value that is a pathloss amount difference value or a d_P″ value that is the change amount of the d_P value by using a value received through DCI signaling, the UE may be able to dynamically update the pathloss amount difference value, based on DCI in addition to the method of being semi-statically configured. Therefore, if the UE has mobility, the method may be useful to compensate for a pathloss amount between a UL-only TRP and the UE when the UE determines transmission power. However, as described above, the UE and the base station may need to define an additional field in DCI, and the defining of the additional field may incur increase in DCI overhead. In addition, the base station is required to be able to periodically measure a d_P value that is a pathloss amount difference or a d_P″ value that is the change amount of the pathloss amount difference value, and a delay time during information exchange between TRPs needs to be not long.

### [Method 3-4]

A d_P value that is the pathloss amount difference value or a d_P″ value that is the change amount of the d_P value may be configured for the UE by the base station through higher layer signaling and then the UE may receive two or more CSI-RSs from the base station. Thereafter, the UE may implicitly receive the d_P value or d_P″ value through the difference in reception power between the received two or more CSI-RSs. At least one d_P value that is the pathloss amount difference value or at least one d_P″ value that is the change amount of the d_P value may be configured for the UE per bandwidth part or per cell. For example, four d_P values or d_P″ values corresponding to the maximum number of pathloss amount measurement reference signals trackable by the UE in a particular cell may be configured for the UE through higher layer signaling. In order to receive an updated value of one of the four d_P values from the base station, the UE may receive CSI-RSs assuming different transmission powers from the base station and use the difference in the reception power therebetween to implicitly identify the d_P value or d_P″ value. For the above operation, CSI-RS resources for updating d_P values that are the pathloss amount difference values or d_P″ values that are the change amounts of the d_P values, which are configured through higher layer signaling, may be configured for the UE according to the number of the d_P values or d_P″ values.

In a case where, as in [Method 3-4], the UE updates a d_P value that is the pathloss amount difference value or a d_P″ value that is the change amount of the d_P value by configuring different transmission powers of different CSI-RS resources and using the difference between the reception power values thereof, the UE may be able to dynamically update the pathloss amount difference value, based on DCI in addition to the method of being semi-statically configured. Therefore, if the UE has mobility, the method may be useful to compensate for a pathloss amount between a UL-only TRP and the UE when the UE determines transmission power, and if there is no interference signal, the method may exhibit high accuracy of information in that it is possible to transfer an unquantized d_P or d_P″ value to the UE through the difference in transmission power between CSI-RS resources. However, the UE needs to define CSI-RS resources having different transmission powers assumed to update the d_P or d_P″ value and having a transmission power difference therebetween that is changeable according to a d_P or d_P″ value calculated by the base station, and thus the overhead in the base station may be increased.

### [Method 3-5]

The UE may receive the d_P or d_P″ value from the base station through at least one combination of [Method 3-1] to [Method 3-4] above and update a pre-configured value. When a particular event defined in the base station occurs, the base station may transfer the d_P or d_P″ value to the UE so that the UE is notified to update a pre-configured or already activated value. The particular event possible in the base station may correspond to, for example, that if the d_P or d_P″ value calculated through at least one of [Method 2-1] or [Method 2-2] has been changed by a particular ratio or higher compared to a previously calculated d_P or d_P″ value (e.g., the value has been reduced or increased by 10% or higher), the base station may transfer the newly calculated d_P or d_P″ value to the UE so that the UE performs update to same. A timer may be configured for the UE by the base station. If the base station does not update, within a time defined through the timer, d_P that is a pathloss amount difference value or a d_P″ value that is the change amount thereof, the UE may perform at least one combination of the following items. However, the disclosure is not limited to the example below:
The UE may request update for the d_P or d_P″ value from the base station;
The UE may not apply a d_P or d_P″ value and perform uplink transmission to the base station;
The UE may apply a d_P value or d_P″ value initially received from the base station to perform uplink transmission to the base station;
The UE may determine a radio link failure situation and request reconfiguration of higher layer signaling from the base station.

The UE is notified by the base station of at least one combination of [Method 3-1] to [Method 3-5] above through at least one combination of higher layer signaling, MAC-CE signaling, or L1 signaling. Alternatively, the UE may expect that at least one combination of [Method 3-1] to [Method 3-5] above is fixedly defined in a specification. If the UE is notified by the base station of at least one particular combination of methods through at least one combination of higher layer signaling, MAC-CE signaling, or L1 signaling, this may imply that the UE is unable to support at least another particular combination of methods. For example, the UE may expect that [Method 3-2] above is fixedly defined in a specification with respect to a method of updating a pathloss amount difference value described above. For example, the UE may be notified by the base station of [Method 3-1] above through at least one combination of higher layer signaling, MAC-CE signaling, or L1 signaling, and the UE may consider or determine that [Method 3-2] above not being supported is notified by the base station.

The UE may report whether the UE is able to support at least one combination of [Method 3-1] to [Method 3-5] above to the base station as a UE capability. If the UE has reported, to the base station as a UE capability, whether the UE is able to at least one particular combination of methods, it may be considered or determined that the UE has reported that the UE is unable to support at least another particular combination of methods. For instance, the UE may report, to the base station, whether the UE is able to support [Method 3-1] or [Method 3-2] above. For example, the UE may report, to the base station, that the UE is able to support [Method 3-1] above, and a UE capability report may imply that the UE is unable to support [Method 3-2].

FIG. 16 illustrates ab example of an operation of a UE for controlling uplink transmission power according to an embodiment of the disclosure.

Referring to FIG. 16, in operation 1600, a UE may transmit a UE capability to a base station. UE capability signaling which may be reported may relate to at least one combination of a UE capability related to PUSCH, PUCCH, or SRS transmission and a transmission power parameter, a UE capability related to a unified TCI state operation, and a UE capability corresponding to [Method 2-1] and [Method 2-2] and [Method 3-1] to [Method 3-5] above. Omission of operation 1600 is also possible.

In operation 1605, the UE may receive higher layer signaling from the base station according to the reported UE capability. A higher layer parameter for at least one combination of higher layer signaling related to PUSCH, PUCCH, or SRS transmission and a transmission power parameter, higher layer signaling related to a unified TCI state operation, and higher layer signaling related to support of [Method 2-1] and [Method 2-2] and [Method 3-1] to [Method 3-5] above may be configured for the UE by the base station.

In operation 1610, the UE may transmit an uplink signal to the base station. The UE may perform a method of transmitting an uplink signal through at least one combination of [Method 2-1] and [Method 2-2] above.

In operation 1615, the UE may be notified by the base station of signaling indicating update of pathloss amount-related information. The UE may receive signaling indicating update of pathloss amount-related information from the base station by using a method in which at least one of [Method 3-1] to [Method 3-5] above is combined.

In operation 1620, the UE may perform uplink transmission to a UL-only TRP, based on the updated pathloss amount-related information.

The above-described flowchart illustrates an exemplary method that may be implemented according to the principle of the disclosure, and various changes may be made to the method shown in the flowchart herein. For example, although shown as a series of operations, various operations in each figure may overlap, occur in parallel, occur in a different order, or occur multiple times. In another example, an operation may be omitted or replaced with another operation.

FIG. 17 illustrates an example of an operation of a base station for controlling uplink transmission power according to an embodiment of the disclosure.

Referring to FIG. 17, in operation 1700, a base station may receive a UE capability from a UE. UE capability signaling which may be received by the base station may relate to at least one combination of a UE capability related to PUSCH, PUCCH, or SRS transmission and a transmission power parameter, a UE capability related to a unified TCI state operation, and a UE capability corresponding to [Method 2-1] and [Method 2-2] and [Method 3-1] to [Method 3-5] above. Omission of operation 1700 is also possible.

In operation 1705, the base station may transmit higher layer signaling to the UE according to the UE capability reported by the UE. The base station may configure, for the UE, a higher layer parameter for at least one combination of higher layer signaling related to PUSCH, PUCCH, or SRS transmission and a transmission power parameter, higher layer signaling related to a unified TCI state operation, and higher layer signaling related to support of [Method 2-1] and [Method 2-2] and [Method 3-1] to [Method 3-5] above.

In operation 1710, the base station may receive an uplink signal from the UE. The base station may expect that the UE is to perform a method of transmitting a corresponding uplink signal through at least one combination of [Method 2-1] and [Method 2-2] above.

In operation 1715, the base station may transmit, to the UE, signaling indicating update of pathloss amount-related information. The base station may transmit, to the UE, signaling indicating update of pathloss amount-related information by using a method in which at least one of [Method 3-1] to [Method 3-5] above is combined.

In operation 1720, the base station may expect that the UE is to perform uplink transmission to a UL-only TRP, based on the updated pathloss amount-related information. Then, the base station may receive an uplink for the UL-only TRP.

The above-described flowchart illustrates an exemplary method that may be implemented according to the principle of the disclosure, and various changes may be made to the method shown in the flowchart herein. For example, although shown as a series of operations, various operations in each figure may overlap, occur in parallel, occur in a different order, or occur multiple times. In another example, an operation may be omitted or replaced with another operation.

### Fourth Embodiment: Method of Uplink Scheduling Based on Pathloss Amount Difference Value

As an embodiment of the disclosure, a method of scheduling uplink transmission for a UL-only TRP by indicating a pathloss amount difference value to a UE is described. This embodiment may be operated in combination with other embodiments.

In the disclosure, a pathloss amount difference value may be named a pathloss offset, a PL offset, a pathloss amount offset, etc.

A pathloss amount difference value may be configured by a base station for the UE through higher layer signaling as described above. The UE is unable to receive a pathloss amount measurement reference signal from a UL-only TRP and thus is unable to directly measure a pathloss amount between the UE and the UL-only TRP. Therefore, the UE may indirectly calculate the pathloss amount from the UL-only TRP by applying the pathloss amount difference value to a pathloss amount value calculated based on a pathloss amount measurement reference signal received from a TRP capable of both uplink and downlink operations. The UE may receive uplink scheduling from the base station, and distinguish whether the uplink scheduling is for transmission to the UL-only TRP or transmission to a TRP capable of both uplink and downlink operations, according to information included in the uplink scheduling. The uplink scheduling may include information related to a pathloss amount difference value. A method of receiving, by the UE, uplink scheduling including information related to a pathloss amount difference value from the base station as described above may consider at least one combination of the following items. However, the disclosure is not limited to the example below.

### [Method 4-1]

One or more joint TCI states or UL TCI states may be configured for the UE by the base station through higher layer signaling. Pathloss amount difference value information may be configured for the UE in the one or more joint TCI states or UL TCI states as shown in Table 30 below.

TABLE 30
TCI-State ::= SEQUENCE {

| tci-StateId | TCI-StateId, | |
|---|---|---|
| qcl-Type1 | QCL-Info, | |
| qcl-Type2 | QCL-Info | OPTIONAL, -- Need R |

```
    ...,
    [[
```

| | |
|---|---|
| additionalPCI-r17 | AdditionalPCIIndex-r17 OPTIONAL, -- Need R |
| pathlossReferenceRS-Id-r17 | PathlossReferenceRS-Id-r17 OPTIONAL, -- Cond |

JointTCI1

| | |
|---|---|
| ul-powerControl-r17 | Uplink-powerControlId-r17 OPTIONAL -- |

Cond JointTCI
]]

| | |
|---|---|
| pathlossOffset | INTEGER (Xs..Xe) OPTIONAL -- Cond |

```
ULonlyNode
  }
  TCI-UL-State-r17 ::= SEQUENCE {
```

| tci-UL-StateId-r17 | | TCI-UL-StateId-r17, |
|---|---|---|
| servingCellId-r17 | | ServCellIndex OPTIONAL, -- Need R |
| bwp-Id-r17 | BWP-Id | OPTIONAL, -- Cond CSI- |

RSorSRS-Indicated
referenceSignal-r17 CHOICE {

| | |
|---|---|
| ssb-Index-r17 | SSB-Index, |
| csi-RS-Index-r17 | NZP-CSI-RS-ResourceId, |
| srs-r17 | SRS-ResourceId |

},

| | |
|---|---|
| additionalPCI-r17 | AdditionalPCIIndex-r17 OPTIONAL, -- Need R |
| ul-powerControl-r17 | Uplink-powerControlId-r17 OPTIONAL, -- |

Need R

| | |
|---|---|
| pathlossReferenceRS-Id-r17 | PathlossReferenceRS-Id-r17 OPTIONAL, -- Cond |

Mandatory

| | |
|---|---|
| pathlossOffset | INTEGER (Xs..Xe) OPTIONAL -- Cond |

ULonlyNode
}

In [Table 30] above, pathlossOffset may be configured for the UE as higher layer signaling relating to a pathloss amount difference value, and the value of pathlossOffset may be a possible integer from Xs to Xe.
For example, Xs and Xe may be 0 and 30, respectively (e.g., natural numbers including 0), and may be in a unit of 1 dB. Not considering a negative number as the value of pathlossOffset is possible because, in a case where the UE considers multiple UL-only TRPs, the UE assumes that the distance between each UL-only TRP and the UE is shorter than that between the UE and a TRP capable of uplink and downlink operation and thus when a UL-only TRP receives uplink transmission of the UE, the UE may assume a higher received signal quality.
For example, Xs and Xe may be −10 and 50, respectively (e.g., integers including a positive number and a negative number), and may be in a unit of 1 dB. The reason why considering even a negative number as the value of pathlossOffset is possible is that, in a case where the UE considers multiple UL-only TRPs, when considering even that the distances between some UL-only TRPs and the UE are longer than that between the UE and a TRP capable of uplink and downlink operation, even though the some UL-only TRPs receive uplink transmission of the UE at a low received signal quality, if multiple UL-only TRPs receive the same signal, diversity effect may be obtained.
For example, Xs and Xe may be 2 and 32, respectively, and may be in a unit of 2 dB. The range and unit of the above value may be employed from the range and unit of a differential RSRP value which the UE may report to the base station. When reporting L1-RSRP that is one of pieces of channel state information capable of indicating the strength of a received signal, the UE may quantize, into 7 bits, the largest value among a number of L1-RSRP values corresponding to a value configured for the UE through higher layer signaling so as to report a range from −140 dBm to 44 dBm in a unit of 1 dB. The UE may calculate one or more L1-RSRP values smaller than that to obtain differential RSRP expressible as a difference value from the largest value, and report same. The UE may quantize the differential RSRP value into 4 bits to report a range from 2 dB to 32 dB in a unit of 2 dB. A pathloss amount is obtained by calculating the difference between an RSRP value calculated by the UE and the transmission power value of a reference signal which may be received from the base station for calculation of the pathloss amount, and if a pathloss amount difference value is calculated, the range and unit of a differential RSRP value may be reused.

The UE may define ULonlyNode as a condition that the pathlossOffset may be configured in a joint TCI state or UL TCI state by the base station. The condition ULonlyNode may indicate that the UE operates in a cell including a UL-only TRP, which may imply the case where particular higher layer signaling is configured. For example, if particular higher layer signaling is configured, the pathlossOffset may be optionally configured for the UE. The name of the condition ULonlyNode described above merely corresponds to an example and may be expressed by other names. If the pathlossOffset is not configured in a joint TCI state or UL TCI state for the UE, the UE may consider or determine 0 as a pathloss amount difference value.

One or more TCI states among joint TCI states or UL TCI states configured as shown in Table 30 above may be indicated to the UE by the base station through a TCI state field in DCI. If the UE has received a joint TCI state or UL TCI state in which the pathlossOffset is configured, and the UE has received scheduling from the base station to perform uplink transmission by applying a joint TCI state or UL TCI state in which pathlossOffset is configured, the UE may consider or determine the uplink transmission as transmission to a UL-only TRP. When calculating the transmission power of uplink transmission, the UE may calculate the pathloss amount between the UE and a UL-only TRP by additionally applying a pathloss amount difference value indicated through a pathlossOffset value configured in a joint TCI state or UL TCI state in which pathlossOffset is configured, to a pathloss amount measured through a pathloss amount measurement reference signal (e.g., pathlossReferenceRS-Id-r17 in Table 30 above) configured in a joint TCI state or UL TCI state in which pathlossOffset is configured. In this case, the UE may assume that the UE has received the pathloss amount measurement reference signal (e.g., pathlossReferenceRS-Id-r17 in Table 30 above) from a TRP capable of both uplink and downlink operation.

When [Method 4-1] above is used, a different pathloss amount difference value for each TCI state may be configured for the UE by the base station. Therefore, the UE may use different TCI states so that, even if the same pathloss amount reference signal is configured in the respective TCI states, the UE may calculate different pathloss amounts by using different pathloss amount difference values configured in the respective TCI states. Through the above method, if one or more UL-only TRPs are installed in a network to which the UE is connected, the UE may easily use multiple pathloss amount difference values. However, if the UE uses the method, the number of pathloss amount difference values required to be managed by the UE and the base station is increased and update of the pathloss amount difference values needs to be supported for each TCI state, and thus large signaling overhead may be consumed.

### [Method 4-2]

One or more joint TCI states or UL TCI states may be configured for the UE by the base station through higher layer signaling. One or more pathloss amount difference values may be configured for the UE in the higher layer signaling BWP-UplinkDedicated relating to an uplink bandwidth part. Each pathloss amount difference value may be connected to a group of one or more pathloss amount measurement reference signals. In addition, higher layer signaling indicating whether to additionally apply a pathloss amount difference value to a pathloss amount measured through a pathloss amount measurement reference signal configurable through higher layer signaling may be configured in a joint TCI state or UL TCI state for the UE. Table 31 below is an example capable of expressing the method, and a connection between a pathloss amount difference value and a group of pathloss amount measurement reference signals may not be limited to Table 31.

```
TABLE 31
    BWP-UplinkDedicated ::= SEQUENCE {
    ...
      pathlossReferenceRSToAddModList-r17 SEQUENCE
  (SIZE (1..maxNrofPathlossReferenceRSs-r17)) OF PathlossReferenceRS-r17
      OPTIONAL, -- Need N
      pathlossReferenceRSToReleaseList-r17 SEQUENCE
  (SIZE (1..maxNrofPathlossReferenceRSs-r17)) OF PathlossReferenceRS-Id-r17
      OPTIONAL -- Need N
```

| | | | |
|---|---|---|---|
| pathlossOffsetList | SEQUENCE | (SIZE | (1.. |

| | | |
|---|---|---|
| maxNrofPathlossReferenceRSGroup-r19)) | OF | PathlossReferenceRSGroup-r19 |

```
      OPTIONAL —- Need R
    }
    PathlossReferenceRSGroup ::= SEQUENCE {
```

| | |
|---|---|
| PathlossReferenceRSGroupId | INTEGER |

(1..maxNrofPathlossReferenceRSGroup-r19))

| | |
|---|---|
| pathlossOffset | INTEGER (Xs..Xe) |

| | |
|---|---|
| pathlossReferenceRSList SEQUENCE | (SIZE |

```
(1..maxNrofPathlossReferenceRSsPerGroup-r19)) OF PathlossReferenceRS-Id-r17
    }
    TCI-State ::= SEQUENCE {
```

| tci-StateId | TCI-StateId, | |
|---|---|---|
| qcl-Type1 | QCL-Info, | |
| qcl-Type2 | QCL-Info | OPTIONAL, -- Need R |

```
      ...,
      [[
```

| | |
|---|---|
| additionalPCI-r17 | AdditionalPCIIndex-r17 OPTIONAL, -- Need R |
| pathlossReferenceRS-Id-r17 | PathlossReferenceRS-Id-r17 OPTIONAL, -- Cond |

JointTCI1

| | | |
|---|---|---|
| ul-powerControl-r17 | Uplink-powerControlId-r17 | OPTIONAL -- |

Cond JointTCI
]]

| | |
|---|---|
| enablePathlossOffset | ENUMARATE{enabled} OPTIONAL -- Cond |

```
ULonlyNode1
  }
  TCI-UL-State-r17 ::= SEQUENCE {
```

| | |
|---|---|
| tci-UL-StateId-r17 | TCI-UL-StateId-r17, |
| servingCellId-r17 | ServCellIndex OPTIONAL, -- Need R |

| | | |
|---|---|---|
| bwp-Id-r17 | BWP-Id | OPTIONAL, -- Cond CSI- |

RSorSRS-Indicated
referenceSignal-r17 CHOICE {

| | |
|---|---|
| ssb-Index-r17 | SSB-Index, |
| csi-RS-Index-r17 | NZP-CSI-RS-ResourceId, |
| srs-r17 | SRS-ResourceId |

},

| additionalPCI-r17 | AdditionalPCIIndex-r17 OPTIONAL, -- Need R | |
|---|---|---|
| ul-powerControl-r17 | Uplink-powerControlId-r17 | OPTIONAL, -- |

Need R

| | |
|---|---|
| pathlossReferenceRS-Id-r17 | PathlossReferenceRS-Id-r17 OPTIONAL, -- Cond |

Mandatory

| | |
|---|---|
| enablePathlossOffset | ENUMARATE{enabled} OPTIONAL -- Cond |

ULonlyNode1
}

In Table 31 above, multiple values of higher layer signaling pathlossReferenceRSGroup-r19 may be configured for the UE in BWP-UplinkDedicated corresponding to an uplink bandwidth part. The UE may configure pathlossOffsetList through the multiple values of pathlossReferenceRS Group-r19. Each value of pathlossReferenceRS Group may include pathlossReferenceRSGroupId which may represent an ID of pathlossReferenceRS Group, pathlossOffset which may indicate a pathloss amount difference value applicable to one or more pathloss amount measurement reference signals included in pathlossReferenceRSGroup, and pathlosReferenceRSList which may indicate a list of one or more pathloss amount measurement reference signals included in pathlossReferenceRSGroup. In this case, the UE may consider the following items with respect to the higher layer signaling pathlossOffset described above. However, the disclosure is not limited to the example below.
pathlossOffset may be configured for the UE as higher layer signaling relating to a pathloss amount difference value, and the value of pathlossOffset may be a possible integer from Xs to Xe.
For example, Xs and Xe may be 0 and 30, respectively (e.g., a natural number including 0), and may be in a unit of 1 dB. As described above, not considering a negative number as the value of pathlossOffset is possible because, in a case where the UE considers multiple UL-only TRPs, the UE assumes that the distance between each UL-only TRP and the UE is shorter than that between the UE and a TRP capable of uplink and downlink operation and thus when a UL-only TRP receives uplink transmission of the UE, the UE may assume a higher received signal quality.
For example, Xs and Xe may be −10 and 50, respectively (e.g., integers including a positive number and a negative number), and may be in a unit of 1 dB. As described above, the reason why considering even a negative number as the value of pathlossOffset is possible is that, in a case where the UE considers multiple UL-only TRPs, when considering even that the distances between some UL-only TRPs and the UE are longer than that between the UE and a TRP capable of uplink and downlink operation, even though the some UL-only TRPs receive uplink transmission of the UE at a low received signal quality, if multiple UL-only TRPs receive the same signal, diversity effect may be obtained.
For example, Xs and Xe may be 2 and 32, respectively, and may be in a unit of 2 dB. The range and unit of the Xs and Xe values may be employed from the range and unit of a differential RSRP value which the UE may report to the base station. When reporting L1-RSRP that is one of pieces of channel state information capable of indicating the strength of a received signal, the UE may quantize, into 7 bits, the largest value among a number of L1-RSRP values corresponding to a value configured for the UE through higher layer signaling so as to report a range from −140 dBm to 44 dBm in a unit of 1 dB. The UE may calculate one or more L1-RSRP values smaller than that to obtain differential RSRP expressible as a difference value from the largest value, and report same and, in this case, may quantize the differential RSRP value into 4 bits to report the range of the value from 2 dB to 32 dB in a unit of 2 dB. A pathloss amount may be obtained by calculating the difference between an RSRP value calculated by the UE and the transmission power value of a reference signal which may be received from the base station for calculation of the pathloss amount. If a pathloss amount difference value is calculated, the UE may reuse the range and unit of a differential RSRP value.

In Table 31 above, the higher layer signaling enablePathlossOffset may be configured for the UE in a joint TCI state or UL TCI state. enablePathlossOffset may be configured for the UE by the base station under the condition called ULonlyNode1, and ULonlyNode1 may indicate a case where at least one value of the higher layer signaling pathlossReferenceRSGroup described above is configured, or a case where particular higher layer signaling having the meaning that the UE operates for multiple TRPs including a UL-only TRP is configured for the UE. The name of the condition ULonlyNode1 described above merely corresponds to an example and may be expressed by other names. In addition, the UE may consider, with respect to enablePathlossOffset above, a condition such as Need R rather than the condition such as ULonlyNode1 not existing. The higher layer signaling enablePathlossOffset may have a value of enabled, and if the higher layer signaling enablePathlossOffset is configured for the UE as enabled in a joint TCI state or UL TCI state as shown in Table 31 above, the UE may determine or calculate a final pathloss amount by additionally applying pathlossOffset configured in pathlossReferenceRSGroup including a pathloss amount measurement reference signal (e.g., pathlossReferenceRS-Id-r17) configured in the same joint TCI state or UL TCI state, to a pathloss amount measured through a pathloss amount measurement reference signal. The name of the condition ULonlyNode1 merely corresponds to an example and may be expressed by other names. If the enablePathlossOffset is not configured for the UE in a joint TCI state or UL TCI state, the UE may consider or determine a pathloss amount difference value as 0, or consider or determine not to apply the pathlossOffset configured in pathlossReferenceRSGroup to a pathloss amount measurement reference signal (e.g., pathlossReferenceRS-Id-r17) indicated through the TCI state. For example, a maximum of 64 pathloss amount measurement reference signals may be configured for the UE through higher layer signaling per cell, but the UE is able to track a maximum of 4 pathloss amount measurement reference signals among the maximum of 64 pathloss amount measurement reference signals, and thus a maximum of four values of pathlossReferenceRSGroup described above may be possible.

When [Method 4-2] above is used, if one or more UL-only TRPs are installed in a network to which the UE is connected, the UE may easily use multiple pathloss amount difference values by using different values of pathlossReferenceRSGroup. In addition, it is also possible for the UE to update the pathloss amount difference values for each value of pathlossReferenceRSGroup and thus the management thereof may be easy. However, the UE and the base station need to newly configure the higher layer signaling pathlossReferenceRSGroup.

### [Method 4-3]

One or more joint TCI states or UL TCI states may be configured for the UE by the base station through higher layer signaling. One pathloss amount difference value may be configured for the UE in the higher layer signaling BWP-UplinkDedicated relating to an uplink bandwidth part. In this case, the UE may assume to always apply a pathloss amount difference value with respect to a particular TCI state according to a method of operating for multiple TRPs. For example, if the UE operates for multiple TRPs, based on the multi-DCI scheme, the UE may not apply the pathloss amount difference value with respect to a TCI state indicated through DCI transmitted to the UE in a control resource set configured to have the higher layer signaling coresetPoolIndex of 0, and may determine a final pathloss amount by applying, with respect to a TCI state indicated through DCI transmitted to the UE in a control resource set configured to have the higher layer signaling coresetPoolIndex of 1, the configured pathloss amount difference value to a pathloss amount calculated using pathlossReferenceRS-Id-r17 indicated through the TCI state. For example, if the UE operates for multiple TRPs, based on the single-DCI scheme, the UE may not apply the pathloss amount difference value with respect to a first TCI state among two TCI states indicated through DCI, and may determine a final pathloss amount by applying, with respect to the second TCI state, the configured pathloss amount difference value to a pathloss amount calculated using pathlossReferenceRS-Id-r17 indicated through the TCI state. Table 32 below may be an example capable of expressing the method and the disclosure may not be limited to Table 32.

TABLE 32

| BWP-UplinkDedicated ::= SEQUENCE { | |
|---|---|
| ... | |
| pathlossReferenceRSToAddModList-r17 SEQUENCE | |
| (SIZE (1..maxNrofPathlossReferenceRSs-r17)) OF | |
| PathlossReferenceRS-r17 | |
| OPTIONAL, -- Need N | |
| pathlossReferenceRSToReleaseList-r17 SEQUENCE | |
| (SIZE (1..maxNrofPathlossReferenceRSs-r17)) OF | |
| PathlossReferenceRS-Id-r17 | |
| OPTIONAL -- Need N | |
| pathlossOffset | INTEGER (Xs..Xe) OPTIONAL —- |
| | Cond |

ULonlyNode2
}

The UE may define ULonlyNode2 as a condition that the pathlossOffset may be configured by the base station in the higher layer signaling BWP-UplinkDedicated. The condition ULonlyNode2 may indicate that the UE operates in a cell including a UL-only TRP. In addition, the condition ULonlyNode2 may imply the case where particular higher layer signaling is configured. For example, if particular higher layer signaling is configured, the pathlossOffset may be optionally configured for the UE. The name of the condition ULonlyNode2 merely corresponds to an example and may be expressed by other names. In addition, the UE may consider, with respect to pathlossOffset above, a condition such as Need R rather than the condition such as ULonlyNode2 not existing. If the pathlossOffset is not configured in BWP-UplinkDedicated for the UE, the UE may consider or determine 0 as a pathloss amount difference value.

In this case, the UE may consider the following items with respect to the higher layer signaling pathlossOffset described above.
pathlossOffset may be configured for the UE as higher layer signaling relating to a pathloss amount difference value, and the value of pathlossOffset may be a possible integer from Xs to Xe.
For example, Xs and Xe may be 0 and 30, respectively (e.g., natural numbers including 0), and may be in a unit of 1 dB. As described above, not considering a negative number as the value of pathlossOffset is possible because, in a case where the UE considers multiple UL-only TRPs, the UE assumes that the distance between each UL-only TRP and the UE is shorter than that between the UE and a TRP capable of uplink and downlink operation and thus when a UL-only TRP receives uplink transmission of the UE, the UE may assume a higher received signal quality.
For example, Xs and Xe may be −10 and 50, respectively (e.g., integers including a positive number and a negative number), and may be in a unit of 1 dB. As described above, the reason why considering even a negative number as the value of pathlossOffset is possible is that, in a case where the UE considers multiple UL-only TRPs, when considering even that the distances between some UL-only TRPs and the UE are longer than that between the UE and a TRP capable of uplink and downlink operation, even though the some UL-only TRPs receive uplink transmission of the UE at a low received signal quality, if multiple UL-only TRPs receive the same signal, diversity effect may be obtained.

For example, Xs and Xe may be 2 and 32, respectively, and may be in a unit of 2 dB. The range and unit of the Xs and Xe values may be employed from the range and unit of a differential RSRP value which the UE may report to the base station. When reporting L1-RSRP that is one of pieces of channel state information capable of indicating the strength of a received signal, the UE may quantize, into 7 bits, the largest value among a number of L1-RSRP values corresponding to a value configured for the UE through higher layer signaling so as to report a range from −140 dBm to 44 dBm in a unit of 1 dB. The UE may calculate one or more L1-RSRP values smaller than that to obtain differential RSRP expressible as a difference value from the largest value, and report same. The UE may quantize the differential RSRP value into 4 bits to report a range from 2 dB to 32 dB in a unit of 2 dB. A pathloss amount may be obtained by calculating the difference between an RSRP value calculated by the UE and the transmission power value of a reference signal which may be received from the base station for calculation of the pathloss amount. If a pathloss amount difference value is calculated, the UE may reuse the range and unit of a differential RSRP value.

When [Method 4-3] is used, the UE may reuse an existing TCI state structure because information related to a pathloss amount difference value is not included in a TCI state. However, in a case where [Method 4-3] above is used, if there are multiple TRPs capable of uplink and downlink operations in a cell to which the UE is connected and there are also multiple TRPs capable of only an uplink reception operation, since the UE assumes, in [Method 4-3] above, to always apply a pathloss amount difference value with respect to a particular TCI state (e.g., the TCI state may be, in the multi-DCI-based multi-TRP operation, a TCI state indicated through DCI transmitted in a control resource set configured to have coresetPoolIndex of 1, and may be, in the single-DCI-based multi-TRP operation, a second TCI state indicated through DCI), the UE may be unable to, at the time of an uplink multi-TRP operation for the base station, perform dynamic switching between scheduling using two different TRPs capable of uplink and downlink operations and scheduling including at least one TRP capable of only an uplink reception operation. For example, the UE may assume to operate in a cell while being semi-statically connected to a TRP capable of an uplink reception operation. If one or more UL-only TRPs are installed in a network to which the UE is connected, the method of configuring one pathloss amount difference value as in [Method 4-3] above may not be appropriate.

### [Method 4-4]

One pathloss amount difference value may be configured for the UE by the base station through higher layer signaling. A configuration for a pathloss amount difference value may be different for each bandwidth part, or may be different for each cell and thus the same value may be configured for all bandwidth parts in a corresponding cell. If a pathloss amount difference value is configured, the UE may expect that a new field indicating whether to apply the pathloss amount difference value is included in DCI. The UE may distinguish, through the new field in DCI from the base station, whether uplink transmission is uplink transmission to a UL-only TRP or uplink transmission to a TRP capable of both uplink and downlink operations. The new field may be 1 bit. If the value of the new field is 1, the UE may apply a pathloss amount difference value when determining a pathloss amount in the transmission power of uplink transmission, and consider or determine that the uplink transmission is for a UL-only TRP. If the value of the new field is 0, the UE may not apply a pathloss amount difference value for uplink transmission, and consider or determine that the uplink transmission is for a TRP capable of both uplink and downlink operation.

It is possible that one pathloss amount difference value is configured for the UE and the UE uses same, and thus in terms of managing pathloss amount difference values, signaling exchange between the UE and the base station may be relatively simplified. In addition, according to a characteristic of a unified TCI state, when a particular TCI state is indicated to the UE, the TCI state starts to be applied at a particular time and may be maintained and used until a new TCI state is indicated and applied. Therefore, it is possible for the UE to perform dynamic switching between uplink transmission for a UL-only TRP and uplink transmission for a TRP capable of both uplink and downlink operation, based on DCI through the above method without indication of a new TCI state. However, in a case where one pathloss amount difference value is considered, if more than one UL-only TRP is considered, a problem may occur.

One pathloss amount difference value may be configured for the UE by the base station through higher layer signaling. A configuration for a pathloss amount difference value may be different for each bandwidth part, or may be different for each cell and thus the same value may be configured for all bandwidth parts in a corresponding cell. If a pathloss amount difference value is configured, the UE may expect that a new field indicating whether to apply the pathloss amount difference value is included in DCI. The UE may distinguish, through a new field in DCI from the base station, whether uplink transmission is uplink transmission to a UL-only TRP or uplink transmission to a TRP capable of both uplink and downlink operations. The UE may identify an additional offset having a particular value to one pathloss amount difference value configured through higher layer signaling. The new field may be 2 bits. If the value of the new field is 00, the UE may apply a pathloss amount difference value configured through higher layer signaling when determining a pathloss amount in the transmission power of corresponding uplink transmission (e.g., the UE may consider that an additional offset is not applied to the pathloss amount difference value configured through higher layer signaling). If the value of the new field is 01, 10, or 11, the UE may assume that the UE may determine a final pathloss amount difference value from a pathloss amount difference value configured through higher layer signaling by considering an additional offset therefor. If the value of the new field is 01, 10, or 11, the UE may apply −3 dB, 1 dB, or 3 dB to each value of the new field. For example, the new field in DCI may be 2 bits. If the value of the new field is 00, the UE may not apply a pathloss amount difference value. If the value of the new field is 11, the UE may apply a pathloss amount difference value configured through higher layer signaling when determining a pathloss amount in the transmission power of uplink transmission (e.g., the UE may consider that an additional offset is not applied to the pathloss amount difference value configured through higher layer signaling). If the value of the new field is 01 or 10, the UE may assume that the UE may determine a final pathloss amount difference value from a pathloss amount difference value configured through higher layer signaling by considering an additional offset therefor. In addition, if the value of the new field is 01 or 10, the UE may apply −3 dB or 3 dB to each value of the new field.

The UE may use one pathloss amount difference value configured therefor and additionally compensate for the pathloss amount difference value through DCI, and thus if the UE has large mobility, the UE may use a relatively accurate pathloss amount difference value compared to the method of using only a value configured through higher layer signaling. However, there may be a shortcoming in that additional DCI overhead may be gradually increased in order to indicate an accurate pathloss amount difference value.

One or more pathloss amount difference values may be configured for the UE by the base station through higher layer signaling. A configuration for a pathloss amount difference value may be different for each bandwidth part, or may be different for each cell and thus the same value may be configured for all bandwidth parts in a corresponding cell. If a pathloss amount difference value is configured, the UE may expect that a new field indicating whether to apply the pathloss amount difference value is included in DCI. The UE may distinguish, through a new field in DCI from the base station, whether uplink transmission is uplink transmission to a UL-only TRP or uplink transmission to a TRP capable of both uplink and downlink operations. The new field may be expressed by a number of bits capable of expressing the number of configured pathloss amount difference values. The new field may transfer a particular pathloss amount difference value through each codepoint, and at least one of all the codepoints may not apply a pathloss amount difference value.

It is possible that multiple pathloss amount difference values are configured for the UE and the UE uses same, and thus in terms of managing pathloss amount difference values, signaling exchange between the UE and the base station may be relatively added compared to a situation where one pathloss amount is managed. However, in a case where the UE considers multiple pathloss amount difference values, if more than one UL-only TRP is considered, it may be advantageous.

### [Method 4-5]

The UE may consider a method in which at least one of [Method 4-1] to [Method 4-4] above is combined.

For example, the UE may consider a method in which [Method 4-2] above and [Method 4-3] above are combined.
As in [Method 4-2] above, multiple values of pathlossreferenceRSGroup may be configured for the UE through higher layer signaling and the UE may recognize a connection relationship between pathlossOffset capable of meaning a pathloss amount difference value and pathlossReferenceRSList configured by one or more pathloss amount measurement reference signals (e.g., PathlossReferenceRS-Id-r17) through pathlossreferenceRSGroup.
As in [Method 4-3] above, the UE may assume to apply a pathloss amount difference value with respect to a particular TCI state. For example, if the UE operates for multiple TRPs, based on the multi-DCI scheme, the UE may not apply the pathloss amount difference value with respect to a TCI state indicated through DCI transmitted to the UE in a control resource set configured to have the higher layer signaling coresetPoolIndex of 0, and may determine a final pathloss amount by applying, with respect to a TCI state indicated through DCI transmitted to the UE in a control resource set configured to have the higher layer signaling coresetPoolIndex of 1, the configured pathloss amount difference value to a pathloss amount calculated using pathlossReferenceRS-Id-r17 indicated through the TCI state. For example, if the UE operates for multiple TRPs, based on the single-DCI scheme, the UE may not apply the pathloss amount difference value with respect to a first TCI state among two TCI states indicated through DCI, and may determine a final pathloss amount by applying, with respect to the second TCI state, the configured pathloss amount difference value to a pathloss amount calculated using pathlossReferenceRS-Id-r17 indicated through the TCI state.
In this case, the UE may apply a different pathloss amount difference value with respect to even a particular TCI state considered in [Method 4-3] above according to a value of pathlossreferenceRSGroup in which a pathloss amount measurement reference signal indicated by the TCI state is included, through the connection relationship between pathlossOffset capable of meaning a pathloss amount difference value and pathlossReferenceRSList configured by one or more pathloss amount measurement reference signals (e.g., PathlossReferenceRS-Id-r17) considered in [Method 4-2] above. In addition, the UE may configure some of pathloss amount measurement reference signals not to be included in the pathlossreferenceRSGroup, and even when a particular TCI state considered in [Method 4-3] is indicated, may not apply a pathloss amount difference value according to some cases. For example, if the UE operates for multiple TRPs, based on the multi-DCI scheme and pathlossReferenceRS-Id-r17 in a TCI state indicated through DCI transmitted to the UE in a control resource set configured to have the higher layer signaling coresetPoolIndex of 1 is not included in any of the one or more configured values of pathlossreferenceRSGroup, pathlossReferenceRS-Id-r17 has no pathloss amount difference value connected thereto, and thus the UE may not apply a pathloss amount difference value with respect to even an uplink signal corresponding to the particular TCI state. For example, if the UE operates for multiple TRPs, based on the single-DCI scheme and pathlossReferenceRS-Id-r17 in a second TCI state indicated through DCI is not included in any of the one or more configured values of pathlossreferenceRSGroup, pathlossReferenceRS-Id-r17 has no pathloss amount difference value connected thereto, and thus the UE may not apply a pathloss amount difference value with respect to even an uplink signal corresponding to the particular TCI state.
When such a combined method is used, the UE may operate multiple pathloss amount difference values without changing a TCI state structure and thus easily receive scheduling in a cell where multiple UL-only TRPs are installed. Furthermore, there is no need to always apply a pathloss amount difference value with respect to a particular TCI state, and thus the UE may not be required to consider a restriction that scheduling for a UL-only TRP needs to be semi-statically included, whereby it may be advantageous to receive flexible scheduling.

For example, the UE may consider a method in which [Method 4-3] above and [Method 4-4] above are combined.
As in [Method 4-3] above, one pathloss amount difference value may be configured for the UE through higher layer signaling, and the UE may apply or not apply a pathloss amount with respect to a particular TCI state.
In this case, as in [Method 4-4] above, the UE may apply an additional offset to the pathloss amount difference value through a new field in DCI.
For example, the UE may operate for multiple TRPs, based on the multi-DCI scheme. At the time of uplink transmission to which a TCI state indicated through DCI transmitted to the UE in a control resource set configured to have the higher layer signaling coresetPoolIndex of 1 is applied, whether to apply a pathloss amount and which additional offset to be considered if the pathloss amount is applied may be indicated through a new field indicated in the same DCI to the UE to calculate the pathloss amount. For example, the UE may operate for multiple TRPs, based on the single-DCI scheme. At the time of uplink transmission to which a second TCI state indicated through DCI is applied, whether to apply a pathloss amount and which additional offset to be considered if the pathloss amount is applied may be indicated through a new field indicated in the same DCI to the UE to calculate the pathloss amount.

The UE may be notified of at least one combination of [Method 4-1] to [Method 4-5] above by the base station through at least one combination of higher layer signaling, MAC-CE signaling, or L1 signaling, or may expect that at least one combination of [Method 4-1] to [Method 4-5] above is fixedly defined in a specification. Additionally, if a UE is notified by a base station of one or more particular combinations of methods through at least one combination of higher layer signaling, MAC-CE signaling, or L1 signaling, it may imply that the UE is unable to support one or more other particular combinations of methods. For example, the UE may expect that [Method 4-2] above is fixedly defined in a specification with respect to a method of determination of uplink transmission power for a TRP capable of uplink and downlink operations or determination of uplink transmission power for a TRP capable of only an uplink reception operation through an indication of the pathloss amount difference value. For example, the UE may be notified by the base station of [Method 4-1] above through at least one combination of higher layer signaling, MAC-CE signaling, or L1 signaling. The UE may consider or determine that the UE has been notified by the base station that [Method 4-2] above is not supported.

The UE may report whether the UE is able to support at least one combination of [Method 4-1] to [Method 4-5] above to the base station as a UE capability. If the UE has reported, to the base station as a UE capability, whether the UE is able to at least one particular combination of methods, it may be considered or determined that the UE has reported that the UE is unable to support at least another particular combination of methods. For instance, the UE may report, to the base station, whether the UE is able to support [Method 4-1] or [Method 4-2] above. For instance, the UE may report, to the base station, that the UE is able to support [Method 4-1] above. In this case, a UE capability report may imply that the UE is unable to support [Method 4-2].

The UE may determine whether to apply a pathloss amount difference value by considering at least one combination of [Method 4-1] to [Method 4-5] above at the time of dynamic grant-based PUSCH transmission scheduled based on DCI, Type-2 configured grant-based PUSCH transmission activated through DCI, or Type-1 configured grant-based PUSCH transmission, PUCCH transmission, SRS transmission, or PRACH transmission which is configured through higher layer signaling.

FIG. 18 illustrates an example of an operation of a UE for determining an uplink transmission method according to an embodiment of the disclosure.

Referring to FIG. 18, in operation 1800, a UE may transmit a UE capability to a base station. UE capability signaling which may be reported may relate to at least one combination of a UE capability related to PUSCH, PUCCH, or SRS transmission and a transmission power parameter, a UE capability related to a unified TCI state operation, or a UE capability indicating whether to support [Method 2-1] and [Method 2-2], [Method 3-1] to [Method 3-5], and [Method 4-1] to [Method 4-5] above. Omission of operation 1800 is also possible.

In operation 1805, the UE may receive higher layer signaling from the base station according to the reported UE capability. A higher layer parameter for at least one combination of higher layer signaling related to PUSCH, PUCCH, or SRS transmission and a transmission power parameter, higher layer signaling related to a unified TCI state operation, or higher layer signaling related to support of [Method 2-1] and [Method 2-2], [Method 3-1] to [Method 3-5], and [Method 4-1] to [Method 4-5] above may be configured for the UE by the base station.

In operation 1810, the UE may receive uplink transmission scheduling information from the base station. In this case, the UE may receive information on a pathloss amount difference value through a method in which at least one of [Method 4-1] to [Method 4-5] above is combined. In addition, the UE may be notified, through at least one combination of higher layer signaling, MAC-CE signaling, or L1 signaling, of at least one of dynamic grant-based PUSCH transmission scheduled based on DCI, Type-2 configured grant-based PUSCH transmission activated through DCI, or Type-1 configured grant-based PUSCH transmission, periodic, semi-persistent, or aperiodic PUCCH transmission, periodic, semi-persistent, or aperiodic SRS transmission, or PRACH transmission which is configured through higher layer signaling.

In operation 1815, the UE may perform different uplink transmission operations according to a condition of the uplink transmission scheduling information received in operation 1810. If the uplink transmission scheduling information received by the UE in operation 1810 includes information relating to a pathloss amount difference value, the UE may perform a first uplink transmission operation (operation 1820). For example, the uplink transmission operation of the UE may be understood as an uplink transmission for a UL-only TRP. If the uplink transmission scheduling information received by the UE in operation 1810 does not include information relating to a pathloss amount difference value, the UE may perform a second uplink transmission operation (operation 1825). For example, the uplink transmission operation of the UE may be understood as an uplink transmission for a TRP capable of both uplink and downlink operation.

The above-described flowchart illustrates an exemplary method that may be implemented according to the principle of the disclosure, and various changes may be made to the method shown in the flowchart herein. For example, although shown as a series of operations, various operations in each figure may overlap, occur in parallel, occur in a different order, or occur multiple times. In another example, an operation may be omitted or replaced with another operation.

FIG. 19 illustrates an example of an operation of a base station for determining an uplink transmission method according to an embodiment of the disclosure.

Referring to FIG. 19, in operation 1900, a base station may receive a UE capability from a UE. UE capability signaling which may be reported may relate to at least one combination of a UE capability related to PUSCH, PUCCH, or SRS transmission and a transmission power parameter, a UE capability related to a unified TCI state operation, or a UE capability indicating whether to support [Method 2-1] and [Method 2-2], [Method 3-1] to [Method 3-5], and [Method 4-1] to [Method 4-5] above. Omission of operation 1900 is also possible.

In operation 1905, the base station may transmit higher layer signaling to the UE according to the UE capability reported by the UE. The base station may define, for the UE, a higher layer parameter for at least one combination of higher layer signaling related to PUSCH, PUCCH, or SRS transmission and a transmission power parameter, higher layer signaling related to a unified TCI state operation, or higher layer signaling related to support of [Method 2-1] and [Method 2-2], [Method 3-1] to [Method 3-5], and [Method 4-1] to [Method 4-5] above. Then, the base station may use one of defined higher layer parameters.

In operation 1910, the base station may transmit uplink transmission scheduling information to the UE. In this case, the base station may transmit, to the UE, information on a pathloss amount difference value through a method in which at least one of [Method 4-1] to [Method 4-5] above is combined. In addition, the base station may notify the UE, through at least one combination of higher layer signaling, MAC-CE signaling, or L1 signaling, of at least one of dynamic grant-based PUSCH transmission scheduled based on DCI, Type-2 configured grant-based PUSCH transmission activated through DCI, or Type-1 configured grant-based PUSCH transmission, periodic, semi-persistent, or aperiodic PUCCH transmission, periodic, semi-persistent, or aperiodic SRS transmission, or PRACH transmission which is configured through higher layer signaling.

In operation 1915, the base station may perform different uplink transmission operations according to a condition of the uplink transmission scheduling information transmitted to the UE in operation 1910. If the uplink transmission scheduling information transmitted by the base station in operation 1910 includes information relating to a pathloss amount difference value, the base station may perform a first uplink reception operation (operation 1920). For example, the base station may understand a corresponding uplink transmission operation of the UE as an uplink reception at a UL-only TRP. If the uplink transmission scheduling information transmitted by the base station in operation 1910 does not include information relating to a pathloss amount difference value, the base station may perform a second uplink reception operation (operation 1925). For example, the base station may understand a corresponding uplink transmission operation of the UE as an uplink reception at a TRP capable of both uplink and downlink operation.

The above-described flowchart illustrates an exemplary method that may be implemented according to the principle of the disclosure, and various changes may be made to the method shown in the flowchart herein. For example, although shown as a series of operations, various operations in each figure may overlap, occur in parallel, occur in a different order, or occur multiple times. In another example, an operation may be omitted or replaced with another operation.

### Fifth Embodiment: Method of Selecting Pathloss Amount Reference Signal

As an embodiment of the disclosure, a method of selecting a pathloss amount reference signal by a UE and a base station is described. This embodiment may be operated in combination with other embodiments.

The UE may receive DCI format 1_0 from the base station, and the DCI format may include at least one of the following fields.
Identifier for DCI formats: The identifier for DCI formats field is 1 bit and may always have a value of 1 and indicate a downlink DCI format.
Frequency domain resource assignment: This field may indicate frequency resource allocation information of a PDSCH which may be scheduled through DCI format 1_0. If a CRC of DCI format 1_0 is scrambled with a C-RNTI and all the values of the frequency domain resource assignment field are 1, the UE may consider and determine that DCI format 1_0 is used as a PDCCH order starting a random access process of the UE, and the remaining fields in DCI format 1_0 may include at least one of the following fields.
Random Access Preamble index: This random access preamble index field may be 6 bits and indicate a value of the higher layer signaling ra-PreambleIndex.
UL/SUL indicator: This UL/SUL indicator field may be 1 bit. If all the values of the random access preamble index field are not 0 and supplementaryUplink is configured for the UE in the higher layer signaling ServingCellConfig, the UL/SUL indicator field may indicate an uplink carrier on which a PRACH is to be transmitted. If the value of the UL/SUL indicator field is 0, the UE may transmit a PRACH to non-supplementary uplink (NUL), and if the value is 1, the UE may transmit a PRACH to supplementary uplink (SUL). If all the values of the random access preamble index field are 0 or the supplementaryUplink is not configured for the UE, the UL/SUL indicator field may be reserved.
SS/PBCH index: This SS/PBCH index field may be 6 bits. If all the values of the random access preamble index field are not 0, the SS/PBCH index field may indicate an SSB which may determine a RACH transmission occasion at the time of PRACH transmission. If all the values of the random access preamble index field are 0, the SS/PBCH index field may be reserved.
PRACH Mask index: This PRACH mask index field may be 4 bits. If all the values of the random access preamble index field are not 0, the PRACH mask index field may indicate a RACH transmission occasion connected to an SSB indicated by the SS/PBCH index field for PRACH transmission. If all the values of the random access preamble index field are 0, the PRACH mask index field may be reserved.
Cell indicator: This cell indicator field may indicate the index of a cell to which the UE is to transmit a PRACH when the higher layer signaling EarlyUlSyncConfig is configured for the UE. The index of a cell may be expressed by the number of bits (e.g., ┌log₂(C+1)┐ble of expressing the number C of candidate cells configured through the higher layer signaling EarlyUlSyncConfig. If the higher layer signaling EarlyUlSyncConfig is not configured, the cell indicator field may be 0 bits. If the cell indicator field is 0, the UE may consider or determine that the field indicates a current serving cell. If the cell indicator field has a value other than 0, the UE may consider or determine that the value of the cell indicator field is mapped to the index of a candidate cell configured through the higher layer signaling EarlyUlSyncConfig in ascending order.
PRACH association indicator: This PRACH association indicator field may be 0 or 1 bit.
   If the higher layer signaling tag-Id2 is configured for the UE, and the higher layer signaling coresetPoolIndex is not configured or coresetPoolIndex is configured as 0 with respect to at least one control resource set, and the higher layer signaling coresetPoolIndex is configured as 1 with respect to at least another control resource set,
      If the higher layer signaling SSB-MTC-AdditionalPCI is configured for the UE (e.g., the UE is connected to a base station operating as multi-DCI-based multiple TRPs in an inter-cell environment), the PRACH association indicator field may indicate a physical cell ID (PCI) connected to a PRACH transmission. If the PRACH association indicator field is 0, the UE may consider or determine that the PRACH association indicator field indicates a current serving cell. If the PRACH association indicator field is 1, the UE may interpret that the field indicates an activated additional PCI.
      If the higher layer signaling SSB-MTC-AdditionalPCI is not configured for the UE (e.g., the UE is connected to a base station operating as multi-DCI-based multiple TRPs in an intra-cell environment), the PRACH association indicator field may indicate a pathloss amount measurement reference signal connected to a PRACH transmission. If the PRACH association indicator field is 0, a downlink reference signal in a QCL relation with a DMRS of a PDCCH order may be indicated to the UE through the PRACH association indicator field as a pathloss amount measurement reference signal of a PRACH transmission. If the PRACH association indicator field is 1, an SSB indicated by an SS/PBCH index field in a DCI format may be indicated to the UE as a pathloss amount measurement reference signal of a PRACH transmission.
   Otherwise, the corresponding field may be considered or determined as 0 bits.
PRACH retransmission indicator: This PRACH retransmission indicator field may be 0 or 1 bit.
   If the higher layer signaling EarlyUlSyncConfig is configured for the UE, the PRACH retransmission indicator field may be 1 bits. If a cell indicated by a cell indicator in a DCI format is a candidate cell, the PRACH retransmission indicator field may indicate whether the PRACH transmission is an initial transmission or a retransmission. If a cell indicated by a cell indicator in the DCI format is a current serving cell, the UE may consider or determine that the PRACH retransmission indicator field has been reserved.
   Otherwise, the corresponding field may be 0 bits.
Reserved bits: A particular length of bits is reserved and the reserved bits may be determined as follows.
   If the higher layer signaling EarlyUlSyncConfig is not configured for the UE, and the UE operates in a cell based on shared frequency channel access in FR1 or a DCI format is monitored in a common search space in a cell in FR2-2, the length of reserved bits may be 12 bits.
   If the higher layer signaling EarlyUlSyncConfig is configured for the UE, and the UE operates in a cell based on shared frequency channel access in FR1 or a DCI format is monitored in a common search space in a cell in FR2-2, the length of reserved bits may be 11-┌log₂(C+1)┐
   If the higher layer signaling EarlyUlSyncConfig is configured for the UE, and the UE operates in a cell not based on shared frequency channel access in FR1, operates in a cell in FR2-1, or a DCI format is monitored in a UE-specific search space in a cell in FR2-2, the length of reserved bits may be 9-┌log₂(C+1)┐
   Otherwise, the length of the reserved bits may be 10 bits.

According to the configuration of each field in DCI format 1_0 described above, the UE may consider a case where DCI format 10 operates as a PDCCH order. For example, if all the values of the FDRA field in DCI format 1_0 are 1, the UE may consider that DCI format 1_0 operates as a PDCCH order triggering PRACH transmission.

As described above, if the UE receives a PDCCH order, the UE may determine, according to a particular condition, whether to transmit a PRACH to a TRP identical to a TRP having transmitted the PDCCH order or transmit a PRACH to a TRP different from a TRP having transmitted the PDCCH order. For example, the particular condition may indicate that the higher layer signaling tag-Id2 is configured for the UE and two different values of coresetPoolIndex are configured. For example, the UE may consider or determine that the UE is connected to a base station operating as multi-DCI-based multiple TRPs and using two timing advance values. In this case, the UE may determine a TRP to which the UE is to transmit a PRACH, through a PRACH association indicator which may exist in the PDCCH order and may have a 1 bit length.
In this case, if the higher layer signaling SSB-MTC-AdditionalPCI is configured for the UE, the UE may assume that the UE is connected to a base station operating as multi-DCI-based multiple TRPs in an inter-cell environment. In this case, a PRACH association indicator field may indicate a physical cell ID (PCI) connected to PRACH transmission. If the PRACH association indicator field is 0, the UE may consider or determine that the PRACH association indicator field indicates a current serving cell. Considering or determining that the field indicates a current serving cell may indicate that the PRACH transmission from the UE is for a TRP corresponding to the PCI of the current serving cell. In addition, if the PRACH association indicator field is 1, the UE may consider or determine that the PRACH association indicator field indicates an activated additional PCI. Considering or determining that the PRACH association indicator field indicates an activated additional PCI may indicate that the PRACH transmission from the UE is for a TRP corresponding the activated additional PCI different from the PCI of the current serving cell.
In this case, if the higher layer signaling SSB-MTC-AdditionalPCI is not configured for the UE, the UE may assume that the UE is connected to a base station operating as multi-DCI-based multiple TRPs in an intra-cell environment. A PRACH association indicator field may indicate a pathloss amount measurement reference signal connected to PRACH transmission. If the PRACH association indicator field is 0, a downlink reference signal in a QCL relation with a DMRS of a PDCCH order may be indicated to the UE through the PRACH association indicator field as a pathloss amount measurement reference signal of a PRACH transmission. For example, the UE may transmit a PRACH to a TRP having transmitted the PDCCH order. If the PRACH association indicator field is 1, an SSB indicated by an SS/PBCH index field in a DCI format may be indicated to the UE as a pathloss amount measurement reference signal of a PRACH transmission. For example, the UE may transmit a PRACH to a TRP different from a TRP having transmitted the PDCCH order. In this case, the UE may assume that the SSB indicated by the SS/PBCH index field in the PDCCH order has been received from a TRP to which the UE is to transmit a PRACH.

The UE may calculate the PRACH transmission power P_{PRACH,b,f,c}(i) in activated uplink bandwidth part b, carrier frequency f, cell c, and the i-th PRACH transmission unit (occasion) considering a downlink pathloss amount measurement reference signal in cell c through Equation 16 below.

$${P}_{PRACH , b , f , c} ( i ) = min \{ {P}_{CMAX , f , c} ( i ) , {P}_{{PRACH}_{target} , f , c} + {PL}_{b , f , c} + {PL}_{off , b , f , c} \} [ dBm ] . \qquad [ Equation 16 ]$$

P_{CMAX,f,c}(i): This is maximum transmission power usable by the UE in the i-th transmission unit, and may be determined by the power class of the UE, and parameters activated by the base station and various parameters embedded in the UE.
P_{PRACH}_{_{target}}_{,f,c}: This may indicate the target reception power of a PRACH which may be configured by the higher layer signaling PREAMBLE_RECEIVED_TARGET_POWER for activated uplink bandwidth part b, carrier frequency f, and cell c.
PL_{b,f,c}: This may be a value representing the pathloss amount between the UE and the base station in activated uplink bandwidth part b, carrier frequency f, and cell c, based on a downlink reference signal connected to a corresponding PRACH transmission among downlink reference signals defined in an activated downlink bandwidth part in cell c. The UE may calculate a pathloss amount value in a unit of dB unit by subtracting a higher-layer-filtered RSRP value from the transmission power (e.g., referenceSignalPower) of the downlink pathloss amount measurement reference signal. If the activated downlink bandwidth part is an initial downlink bandwidth part and a multiplexing pattern between an SSB and a control resource set is 2 or 3 or a PRACH transmission is for a TRP having a PCI different from that of a serving cell, the UE may calculate the pathloss amount value PL_{b,f,c}, based on an SSB connected to the PRACH transmission.
PL_{off,b,f,c}: This may indicate the difference value between the pathloss amount between the UE and a TRP capable of both uplink and downlink operations and the pathloss amount between a UL-only TRP and the UE if the UE is connected to a base station supporting the UL-only TRP.—If particular higher layer signaling which may have the meaning that the UE is connected to a base station supporting a UL-only TRP is configured for the UE, a value of 0 or other values may be possible as the parameter. Otherwise, the UE may consider or determine the value of the parameter as 0.

If a PRACH transmission has been started by the UE by receiving a PDCCH order for triggering a non-contention-based random access process and, when the PRACH transmission is for a serving cell, a downlink pathloss amount measurement reference signal is an SSB that is a downlink reference signal in a QCL relation with a DMRS in the PDCCH order or, when the PRACH transmission is for a TRP having a PCI different from that of the serving cell, a downlink pathloss amount measurement reference signal is an indicated SSB, the UE may assume that the referenceSignalPower is determined through the higher layer signaling ss-PBCH-BlockPower. If a periodic CSI-RS is configured for the UE as pathloss amount measurement reference signal, the UE may assume that the referenceSignalPower is determined through the higher layer signalings ss-PBCH-BlockPower and powerControlOffsetSS. powerControlOffsetSS may indicate the offset between SSB transmission power and CSI-RS transmission power. If powerControlOffsetSS is not configured for the UE, the UE may consider or determine the offset as 0 dB. If an activated TCI state for a control resource set in which a PDCCH order is transmitted includes two reference signals (e.g., the activated TCI state includes both qcl-Type1 and qcl-Type2), the UE may consider powerControlOffsetSS for a reference signal configured in qcl-Type2 when calculating the referenceSignalPower.

As described above, the UE may receive PRACH transmission triggering by receiving a PDCCH order from the base station. In particular, whether to transmit a PRACH to a TRP identical to or different from a TRP from which the PDCCH order has been received may be indicated to the UE by the base station under a particular condition. For example, if the UE is connected to a base station supporting two timing advances in an intra-cell environment and operating as multi-DCI-based multiple TRPs (e.g., the higher layer signaling tag-Id2 is configured for the UE and two different values of coresetPoolIndex are configured for the UE), the base station may be able to indicate a TRP toward which transmission is directed, to the UE through a PRACH association indicator field in a PDCCH order. In a case of an intra-cell environment (e.g., the higher layer signaling SSB-MTC-AdditionalPCI is not configured for the UE), a pathloss amount measurement reference signal at the time of determination of PRACH transmission power may be indicated to the UE through the PRACH association indicator field.

In relation to the PRACH transmission triggering to a particular TRP, a timing advance value between the UE and each TRP may be easily obtained by the base station. In particular, if the UE operates while being connected to a cell supporting a UL-only TRP (e.g., particular higher layer signaling having the meaning that the UE operates for a UL-only TRP is configured for the UE or a pathloss amount difference value is configured for the UE), since the UL-only TRP is relatively closer to the UE compared to a TRP capable of both uplink and downlink operation and the coverage areas supported by the respective TRPs are different, supporting the two timing advance values in a cell environment including a UL-only TRP may be advantageous for both the UE and the base station. In a case where the UE operates while being connected to a cell supporting a UL-only TRP, if only one timing advance value is configured for the UE by the base station, the UE may perform transmission at an uplink transmission timing for a TRP which supports both uplink and downlink and may exist relatively far away from the UE. In this case, uplink transmission of the UE may relatively early arrive at a UL-only TRP existing relatively close to the UE. However, there may be a possibility that the uplink transmission may overlap with uplink transmission in a previous slot having arrived at the UL-only TRP according to the difference between the distance between the UL-only TRP and the UE and the distance between the UE and the TRP capable of both uplink and downlink operation. Therefore, introducing and using two timing advances in a cell environment including a UL-only TRP may be advantageous in terms of system performance and operation.

Meanwhile, if the UE operates while being connected to a cell supporting a UL-only TRP (e.g., particular higher layer signaling having the meaning that the UE operates for a UL-only TRP is configured for the UE or a pathloss amount difference value is configured for the UE), since the UE is unable to receive a PDCCH from the UL-only TRP, a single-DCI-based multi-TRP operation cable of managing scheduling for at least one TRP through one PDCCH may be more natural than a multi-DCI-based multi-TRP operation of receiving an individual PDCCH for each TRP and managing scheduling of each TRP by a corresponding PDCCH.

Therefore, if the UE operates while being connected to a cell supporting a UL-only TRP (e.g., particular higher layer signaling having the meaning that the UE operates for a UL-only TRP is configured for the UE or a pathloss amount difference value is configured for the UE), when the UE satisfies at least one combination of conditions, two timing advance values may be configured for the UE. tag-Id2 which may indicate which of two timing advance values is applied may be configured in a UL TCI state, and the UE may determine a timing advance value to be applied to a corresponding uplink transmission according to which UL TCI state is indicated. In addition, when the UE satisfies at least one combination of conditions, it may be possible to transmit a PRACH to a TRP identical to or different from a TRP having transmitted the PDCCH order, through a PRACH association indicator field in the PDCCH order.
(Condition 1) The higher layer signaling tag-Id2 is configured for the UE.
(Condition 2) The higher layer signaling coresetPoolIndex is not configured or coresetPoolIndex is configured as 0 for the UE with respect to at least one control resource set, and the higher layer signaling coresetPoolIndex is configured as 1 with respect to at least another control resource set.
(Condition 3) Two different values of coresetPoolIndex are configured for the UE.
(Condition 4) coresetPoolIndex is not configured or is configured as 0 for the UE.
(Condition 5) Two joint TCI states, two DL TCI states, or two UL TCI states are activated for the UE with respect to at least one of codepoints of a TCI state field in DCI.
(Condition 6) The UE operates while being connected to a cell supporting a UL-only TRP (e.g., particular higher layer signaling having the meaning that the UE operates for a UL-only TRP is configured for the UE or a pathloss amount difference value is configured for the UE).

In addition, if the UE operates while being connected to a cell supporting a UL-only TRP (e.g., particular higher layer signaling having the meaning that the UE operates for a UL-only TRP is configured for the UE or a pathloss amount difference value is configured for the UE), the UE may receive a PDCCH order capable of triggering a PRACH transmission only from a TRP capable of both uplink and downlink operation and is unable to receive same from a UL-only TRP. Therefore, as described above, in a case of an intra-cell environment (e.g., the higher layer signaling SSB-MTC-AdditionalPCI is not configured for the UE), a pathloss amount measurement reference signal at the time of determination of the transmission power of a PRACH transmission may be indicated to the UE through a PRACH association indicator field in a PDCCH order. If the PRACH transmission is toward a UL-only TRP, since there is no downlink transmission from the UL-only TRP, a pathloss amount measurement reference signal may need to be determined in a different method. In addition, if a pathloss amount measurement reference signal is determined, the UE may determine a final pathloss amount at the time of PRACH transmission by reflecting the difference value between the pathloss amount between the UE and a TRP capable of both uplink and downlink operation and the pathloss amount between a UL-only TRP and the UE. The UE may determine a pathloss amount measurement reference signal for a PRACH transmitted to a UL-only TRP triggered through a PDCCH order, and use at least one combination of the following methods for determining a pathloss amount difference value corresponding to the pathloss amount measurement reference signal.

### [Method 5-1-1]

In determining a pathloss amount measurement reference signal for a PRACH transmitted to a UL-only TRP triggered through a PDCCH order, the UE may use an SSB indicated by an SS/PBCH index field in the PDCCH order. The UE may consider or determine that the SSB has been transmitted from a TRP capable of both uplink and downlink operation. For example, if the UE satisfies (Condition 1) and (Condition 6) above and additionally satisfies at least one combination of (Condition 2) to (Condition 5), 1 is indicated to the UE through a PRACH association indicator field in a PDCCH order, the UE may consider or determine that the PRACH transmission corresponds to a UL-only TRP. The UE may use an SSB indicated by an SS/PBCH index field in the same PDCCH order as a pathloss amount measurement reference signal for the PRACH transmission.

### [Method 5-1-2]

In determining a pathloss amount measurement reference signal for a PRACH transmitted to a UL-only TRP triggered through a PDCCH order, the UE may use a downlink reference signal that is QCLed with a DMRS in a PDCCH. If the UE satisfies (Condition 1) and (Condition 6) above and additionally satisfies at least one combination of (Condition 2) to (Condition 5), 1 is indicated to the UE through a PRACH association indicator field in a PDCCH order, the UE may consider or determine that the PRACH transmission corresponds to a UL-only TRP. The UE may use a downlink reference signal that is QCLed with a DMRS in a PDCCH as a pathloss amount measurement reference signal for PRACH transmission.

### [Method 5-1-3]

In determining a pathloss amount measurement reference signal for a PRACH transmitted to a UL-only TRP triggered through a PDCCH order, the UE may use a downlink reference signal indicatable through a new field in the PDCCH order. If the UE satisfies (Condition 1) and (Condition 6) above and additionally satisfies at least one combination of (Condition 2) to (Condition 5), 1 is indicated to the UE through a PRACH association indicator field in a PDCCH order, the UE may consider or determine that the PRACH transmission corresponds to a UL-only TRP. The UE may use a downlink reference signal indicatable through a new field in a PDCCH order as a pathloss amount measurement reference signal for PRACH transmission. For example, the new field for indicating a pathloss amount measurement reference signal, which is definable in the PDCCH order, is 2 bits and the UE may select one type among a maximum of four pathloss amount measurement reference signals activated in a cell.

### [Method 5-1-4]

In determining a pathloss amount measurement reference signal for a PRACH transmitted to a UL-only TRP triggered through a PDCCH order, the UE may use a downlink reference signal configured through higher layer signaling individually defined for a corresponding purpose. If the UE satisfies (Condition 1) and (Condition 6) above and additionally satisfies at least one combination of (Condition 2) to (Condition 5), 1 is indicated to the UE through a PRACH association indicator field in a PDCCH order, the UE may consider or determine that the PRACH transmission corresponds to a UL-only TRP. The UE may use a downlink reference signal configured through higher layer signaling individually defined for a corresponding purpose as a pathloss amount measurement reference signal for PRACH transmission.

### [Method 5-1-5]

In determining a pathloss amount measurement reference signal for a PRACH transmitted to a UL-only TRP triggered through a PDCCH order, the UE may use a downlink reference signal configured as a source RS of a joint TCI state or DL TCI state currently having been applied after being indicated to the UE. If the UE satisfies (Condition 1) and (Condition 6) above and additionally satisfies at least one combination of (Condition 2) to (Condition 5), 1 is indicated to the UE through a PRACH association indicator field in a PDCCH order, the UE may consider or determine that the PRACH transmission corresponds to a UL-only TRP, and the UE may use a downlink reference signal configured as a source RS of a joint TCI state or DL TCI state currently having been applied after being indicated to the UE as a pathloss amount measurement reference signal for the PRACH transmission. If two resource RSs are configured in the joint TCI state or DL TCI state (e.g., there are two source RSs configured in the higher layer signalings qcl-Type1 and qcl-Type2 in the joint TCI state or DL TCI state, respectively), the UE may determine a source RS configured in qcl-Type2 as the pathloss amount measurement reference signal.

### [Method 5-1-6]

In determining a pathloss amount measurement reference signal for a PRACH transmitted to a UL-only TRP triggered through a PDCCH order, the UE may use a pathloss amount measurement reference signal in a joint TCI state or UL TCI state currently having been applied after being indicated to the UE and corresponding to the UL-only TRP. If the UE satisfies (Condition 1) and (Condition 6) above and additionally satisfies at least one combination of (Condition 2) to (Condition 5), 1 is indicated to the UE through a PRACH association indicator field in a PDCCH order, the UE may consider or determine that the PRACH transmission corresponds to a UL-only TRP. The UE may use a pathloss amount measurement reference signal in a joint TCI state or UL TCI state currently having been applied after being indicated to the UE and corresponding to a UL-only TRP as a pathloss amount measurement reference signal for PRACH transmission.

In addition to [Method 5-1-1] to [Method 5-1-6] above, the UE may determine a pathloss amount difference value to be applied to a pathloss amount calculated through a pathloss amount measurement reference signal for a PRACH transmission indicated through a PDCCH order, through at least one combination of the following items. In this case, a case where the UE applies a pathloss amount difference value may indicate a case where the UE satisfies (Condition 1) and (Condition 6) above and additionally satisfies at least one combination of (Condition 2) to (Condition 5) and 1 is indicated to the UE through a PRACH association indicator field in a PDCCH order.
[Method 5-2-1] One pathloss amount difference value may be configured for the UE through higher layer signaling and the UE may apply the configured value.
[Method 5-2-2] At least one pathloss amount difference value may be configured for the UE through higher layer signaling and one of the configured at least one value may be indicated to the UE through a new field in a PDCCH order. For example, two or four pathloss amount difference values may be configured for the UE, and one of the configured pathloss amount difference values may be indicated to the UE through a new field configured by 1 or 2 bits in a PDCCH order. Reserved bits in DCI format 1_0 above may be used as the number of bits required for the new field.
[Method 5-2-3] With respect to a pathloss amount difference value, a connection relation between a particular pathloss amount and each SSB indicatable by an SS/PBCH index field in the PDCCH order may be configured for the UE through higher layer signaling. Accordingly, the UE may automatically apply a pathloss amount difference value connected through higher layer signaling to an SSB indicated by an SS/PBCH index field in the PDCCH order.
[Method 5-2-4] If the UE determines a pathloss amount measurement reference signal for determination of PRACH transmission power through [Method 5-5] or [Method 5-6] above, the signal may be configured for the UE in a joint TCI state, DL TCI state, or UL TCI state or may be indicated to the UE through a joint TCI state, DL TCI state, or UL TCI state. Then, the UE may apply a pathloss amount connected through higher layer signaling to a pathloss amount measurement reference signal configured in the joint TCI state, DL TCI state, or UL TCI state.

In addition to [Method 5-1-1] to [Method 5-1-6] above and [Method 5-2-1] to [Method 5-2-4] above, when the UE performs a PRACH transmission indicated through a PDCCH order, if the UE operates in FR2, the UE may use a method in which at least one of the following items is combined, to determine a PRACH transmission beam direction.
[Method 5-3-1] The UE may transmit a PRACH in the same beam direction as that of a source RS corresponding to QCL-TypeD configured in a TCI state corresponding to a UL-only TRP among joint TCI states or UL TCI states having been applied after being indicated to the UE.
[Method 5-3-2] The UE may transmit a PRACH in the transmission beam direction of a particular SRS resource notified of by the base station or a first SRS resource in an SRS resource set configured to have the higher layer signaling usage as beam management. The UE may transmit one or more SRS resources in an SRS resource set having a beam management usage in different beam directions, respectively. Therefore, the base station may determine which SRS resource has been received well at a UL-only TRP, and may notify the UE of which SRS resource corresponding to a transmission beam direction which is appropriate between the UL-only TRP and the UE.
[Method 5-3-3]A transmission beam direction may correspond to UE implementation. The UE may determine a transmission beam direction without particular restrictions.

The UE may be notified by the base station of at least one combination of [Method 5-1-1] to [Method 5-1-6] above, [Method 5-2-1] to [Method 5-2-4], and/or [Method 5-3-1] to [Method 5-3-3] above through at least one combination of higher layer signaling, MAC-CE signaling, or L1 signaling. Alternatively, the UE may expect that at least one combination of [Method 5-1-1] to [Method 5-1-6] above, [Method 5-2-1] to [Method 5-2-4], and/or [Method 5-3-1] to [Method 5-3-3] above is fixedly defined in a specification. Additionally, if the UE is notified by the base station of at least one particular combination of methods through at least one combination of higher layer signaling, MAC-CE signaling, or L1 signaling, this may imply that the UE is unable to support at least another particular combination of methods. For example, the UE may expect that [Method 5-1-1], [Method 5-2-1], and [Method 5-3-1] above are fixedly defined in a specification with respect to the method of determining a pathloss amount measurement reference signal and a pathloss amount difference value at the time of PRACH transmission. For example, the UE may be notified by the base station of [Method 5-1-1], [Method 5-2-1], and [Method 5-3-1] above through at least one combination of higher layer signaling, MAC-CE signaling, or L1 signaling. The UE may consider or determine that the UE has been notified by the base station that [Method 5-1-2], [Method 5-2-2], and [Method 5-3-2] above are not supported.

The UE may report, to the base station as UE capability, whether the UE is able to support at least one combination of [Method 5-1-1] to [Method 5-1-6] above, [Method 5-2-1] to [Method 5-2-4], and/or [Method 5-3-1] to [Method 5-3-3] above. If the UE has reported, to the base station as a UE capability, whether the UE is able to at least one particular combination of methods, it may be considered or determined that the UE has reported that the UE is unable to support at least another particular combination of methods. For instance, the UE may report, to the base station, whether the UE is able to support [Method 5-1-1], [Method 5-2-1], and [Method 5-3-1] above. For instance, the UE may report, to the base station, that the UE is able to support [Method 5-1-1], [Method 5-2-1], and [Method 5-3-1] above. In this case, a UE capability report may imply that the UE is unable to support [Method 5-1-2], [Method 5-2-2], and [Method 5-3-2].

FIG. 20 illustrates an example of an operation of a UE for selecting a pathloss amount reference signal at the time of PRACH transmission according to an embodiment of the disclosure.

Referring to FIG. 20, in operation 2000, a UE may transmit a UE capability to a base station. UE capability signaling which may be reported may relate to at least one combination of a UE capability related to PUSCH, PUCCH, or SRS transmission and a transmission power parameter, a UE capability related to a unified TCI state operation, a UE capability related to a two timing advance operation, a UE capability related to a multi-TRP operation, or a UE capability indicating whether to support [Method 2-1] and [Method 2-2], [Method 3-1] to [Method 3-5], [Method 4-1] to [Method 4-5], and [Method 5-1-1] to [Method 5-1-6], [Method 5-2-1] to [Method 5-2-4], and/or [Method 5-3-1] to [Method 5-3-3] above. Omission of operation 2000 is also possible.

In operation 2005, the UE may receive higher layer signaling from the base station according to the reported UE capability. The UE may define a higher layer parameter for at least one combination of higher layer signaling related to PUSCH, PUCCH, or SRS transmission and a transmission power parameter, higher layer signaling related to a unified TCI state operation, a UE capability related to a two timing advance operation, a UE capability related to a multi-TRP operation, or higher layer signaling related to support of [Method 2-1] and [Method 2-2], [Method 3-1] to [Method 3-5], [Method 4-1] to [Method 4-5], and [Method 5-1-1] to [Method 5-1-6], [Method 5-2-1] to [Method 5-2-4], and/or [Method 5-3-1] to [Method 5-3-3] above, which are received from the base station. Then, the base station may use one of defined higher layer parameters.

In operation 2010, the UE may receive a PDCCH order from the base station. A PRACH transmission may be triggered for the UE by the base station through the PDCCH order, and the UE may determine a TRP to which a PRACH is to be transmitted, through a PRACH association indicator field.

In operation 2015, the UE may determine a pathloss amount measurement reference signal for a PRACH transmission. The UE may determine a pathloss amount measurement reference signal by using a method in which at least one of [Method 5-1-1] to [Method 5-1-6] above is combined.

In operation 2020, the UE may determine a pathloss amount difference in addition to the pathloss amount measurement reference signal for the PRACH transmission. The UE may determine a pathloss amount measurement reference signal by using a method in which at least one of [Method 5-2-1] to [Method 5-2-4] above is combined.

In operation 2025, the UE may transmit a PRACH to a particular TRP. The UE may determine the transmission beam of a PRACH and transmit the PRACH to a particular TRP by using a method in which at least one of [Method 5-3-1] to [Method 5-3-3] above is combined.

The above-described flowchart illustrates an exemplary method that may be implemented according to the principle of the disclosure, and various changes may be made to the method shown in the flowchart herein. For example, although shown as a series of operations, various operations in each figure may overlap, occur in parallel, occur in a different order, or occur multiple times. In another example, an operation may be omitted or replaced with another operation.

FIG. 21 illustrates an example of an operation of a base station for selecting a pathloss amount reference signal at the time of PRACH transmission according to an embodiment of the disclosure.

Referring to FIG. 21, in operation 2100, a base station may receive a UE capability from a UE. UE capability signaling which may be reported may relate to at least one combination of a UE capability related to PUSCH, PUCCH, or SRS transmission and a transmission power parameter, a UE capability related to a unified TCI state operation, a UE capability related to a two timing advance operation, a UE capability related to a multi-TRP operation, or a UE capability indicating whether to support [Method 2-1] and [Method 2-2], [Method 3-1] to [Method 3-5], [Method 4-1] to [Method 4-5], and [Method 5-1-1] to [Method 5-1-6], [Method 5-2-1] to [Method 5-2-4], and/or [Method 5-3-1] to [Method 5-3-3] above. Omission of operation 2100 is also possible.

In operation 2105, the base station may transmit higher layer signaling to the UE according to the UE capability reported by the UE. The base station may define, for the UE, a higher layer parameter for at least one combination of higher layer signaling related to PUSCH, PUCCH, or SRS transmission and a transmission power parameter, higher layer signaling related to a unified TCI state operation, a UE capability related to a two timing advance operation, a UE capability related to a multi-TRP operation, or higher layer signaling related to support of [Method 2-1] and [Method 2-2], [Method 3-1] to [Method 3-5], [Method 4-1] to [Method 4-5], and [Method 5-1-1] to [Method 5-1-6], [Method 5-2-1] to [Method 5-2-4], and/or [Method 5-3-1] to [Method 5-3-3] above. Then, the base station may use one of defined higher layer parameters.

In operation 2110, the base station may transmit a PDCCH order to the UE. The base station may trigger a PRACH transmission for the UE through the PDCCH order. The UE may determine a TRP to which a PRACH is to be triggered to be transmitted, through a PRACH association indicator field.

In operation 2115, the base station may assume, when receiving a PRACH from the UE, a downlink reference signal which the UE has determined as a pathloss amount measurement reference signal. The base station may assume that the UE has determined a pathloss amount measurement reference signal by using a method in which at least one of [Method 5-1-1] to [Method 5-1-6] above is combined.

In operation 2120, the base station may assume, when receiving the PRACH from the UE, whether the UE has determined a pathloss amount difference in addition to the pathloss amount measurement reference signal having been determined by the UE. The base station may assume that the UE has determined a pathloss amount measurement reference signal by using a method in which at least one of [Method 5-2-1] to [Method 5-2-4] above is combined.

In operation 2125, the base station may receive the PRACH from the UE at a particular TRP. The base station may assume that the UE has determined the transmission beam of a PRACH and has transmitted the PRACH to a particular TRP by using a method in which at least one of [Method 5-3-1] to [Method 5-3-3] above is combined.

The above-described flowchart illustrates an exemplary method that may be implemented according to the principle of the disclosure, and various changes may be made to the method shown in the flowchart herein. For example, although shown as a series of operations, various operations in each figure may overlap, occur in parallel, occur in a different order, or occur multiple times. In another example, an operation may be omitted or replaced with another operation.

FIG. 22 illustrates an example of a structure of a UE in a wireless communication system according to an embodiment of the disclosure.

Referring to FIG. 22, the UE may include a transceiver, which refers to a UE receiver 2200 and a UE transmitter 2210 as a whole, a memory (not illustrated), and a UE processor 2205 (or UE controller or processor). The UE transceiver 2200 and 2210, the memory, and the UE processor 2205 may operate according to the above-described communication methods of the UE. Components of the UE are not limited to the above-described example. For example, the UE may include a larger or smaller number of components than the above-described components. Furthermore, the UE processor 2205, the UE transmitter 2200, the UE receiver 2210, and the memory may be implemented in the form of a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the UE processor 2205, and transmit signals output from the UE processor 2205 through the radio channel.

The memory may store programs and data necessary for operations of the UE. In addition, the memory may store control information or data included in signals transmitted/received by the UE. The memory may include storage media such as a ROM, a RAM, a hard disk, a CD-ROM, and a DVD, or a combination of storage media. In addition, the UE may include multiple memories, and the memories may store instructions for performing the above-described communication methods.

Furthermore, the UE processor 2205 may control a series of processes such that the UE can operate according to the above-described embodiments. For example, the UE processor 2205 may control components of the UE to receive DCI configured in two layers so as to simultaneously receive multiple PDSCHs. The UE processor 2205 may include multiple processors, and the UE processor 1905 may perform operations of controlling the components of the UE by executing programs stored in the memory.

FIG. 23 illustrates an example of a structure of a base station in a wireless communication system according to an embodiment of the disclosure.

Referring to FIG. 23, the base station may include a transceiver, which refers to a base station receiver 2300 and a base station transmitter % n as a whole, a memory (not illustrated), and a base station processor 2305 (or base station controller or processor). The base station transceiver 2300 and 2310, the memory, and the base station processor 2305 may operate according to the above-described communication methods of the base station. However, components of the base station are not limited to the above-described example. For example, the base station may include a larger or smaller number of components than the above-described components. Furthermore, the transceiver 2300 and 2310, the memory, and the base station processor 2305 may be implemented in the form of a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the base station processor 2305, and transmit signals output from the base station processor 2305 through the radio channel.

The memory may store programs and data necessary for operations of the base station. In addition, the memory may store control information or data included in signals transmitted/received by the base station. The memory may include storage media such as a ROM, a RAM, a hard disk, a CD-ROM, and a DVD, or a combination of storage media. In addition, the base station may include multiple memories, and the memories may store instructions for performing the above-described communication methods.

The base station processor 2305 may control a series of processes such that the base station can operate according to the above-described embodiments of the disclosure. For example, the base station processor 2305 may control components of the base station to configure DCI configured in two layers including allocation information regarding multiple PDSCHs and to transmit the same. The base station processor 2305 may include multiple processors, and the base station processor 2305 may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

In addition, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps of each method are performed, and the order relationship between the steps may be changed or the steps may be performed in parallel.

In the drawings in which methods of the disclosure are described, the order of the description does not always correspond to the order in which steps of each method are performed, and the order relationship between the steps may be changed or the steps may be performed in parallel.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

What is claimed is:

1. A method performed by a terminal in a wireless communication system, the method comprising:
receiving, from a first base station, downlink control information (DCI) indicating an application of a pathloss (PL) offset; and
transmitting, to a second base station, a physical random access channel (PRACH) based on the DCI,
wherein the second base station corresponds to a transmission and reception point (TRP) supporting only an uplink (UL) reception.

2. The method of claim 1, wherein the PL offset is associated with one of a joint transmission configuration indication (TCI) state or an UL TCI state.

3. The method of claim 1, wherein the DCI includes a physical downlink control channel (PDCCH) order.

4. The method of claim 1, wherein the PL offset is a difference between a first PL and a second PL,
wherein the first PL includes a PL between the terminal and the first base station, and
wherein the second PL includes a PL between the terminal and the second base station.

5. The method of claim 1, further comprising:
receiving, from the first base station, configuration information on the PL offset by a high layer signaling.

6. A method performed by a first base station in a wireless communication system, the method comprising:
transmitting, to a terminal, downlink control information (DCI) indicating an application of a pathloss (PL) offset,
wherein a physical random access channel (PRACH) for a second base station is based on the DCI, and
wherein the second base station corresponds to a transmission and reception point (TRP) supporting only an uplink (UL) reception.

7. The method of claim 6, wherein the PL offset is associated with one of a joint transmission configuration indication (TCI) state or an UL TCI state.

8. The method of claim 6, wherein the DCI includes a physical downlink control channel (PDCCH) order.

9. The method of claim 6, wherein the PL offset is a difference between a first PL and a second PL,
wherein the first PL includes a PL between the terminal and the first base station, and
wherein the second PL includes a PL between the terminal and the second base station.

10. The method of claim 6, further comprising:
transmitting, to the terminal, configuration information on the PL offset by a high layer signaling.

11. A terminal in a wireless communication system, the terminal comprising:
a transceiver; and
at least one processor coupled with the transceiver and configured to:
receive, from a first base station, downlink control information (DCI) indicating an application of a pathloss (PL) offset, and
transmit, to a second base station, a physical random access channel (PRACH) based on the DCI,
wherein the second base station corresponds to a transmission and reception point (TRP) supporting only an uplink (UL) reception.

12. The terminal of claim 11, wherein the PL offset is associated with one of a joint transmission configuration indication (TCI) state or an UL TCI state.

13. The terminal of claim 11, wherein the DCI includes a physical downlink control channel (PDCCH) order.

14. The terminal of claim 11, wherein the PL offset is a difference between a first PL and a second PL,
wherein the first PL includes a PL between the terminal and the first base station, and
wherein the second PL includes a PL between the terminal and the second base station.

15. The terminal of claim 11, wherein at least one processor is further configured to:
receive, from the first base station, configuration information on the PL offset by a high layer signaling.

16. A first base station in a wireless communication system, the first base station comprising:
a transceiver; and
at least one processor coupled with the transceiver and configured to:
transmit, to a terminal, downlink control information (DCI) indicating an application of a pathloss (PL) offset,
wherein a physical random access channel (PRACH) for a second base station is based on the DCI, and
wherein the second base station corresponds to a transmission and reception point (TRP) supporting only an uplink (UL) reception.

17. The first base station of claim 16, wherein the PL offset is associated with one of a joint transmission configuration indication (TCI) state or an UL TCI state.

18. The first base station of claim 16, wherein the DCI includes a physical downlink control channel (PDCCH) order.

19. The first base station of claim 16, wherein the PL offset is a difference between a first PL and a second PL,
wherein the first PL includes a PL between the terminal and the first base station, and
wherein the second PL includes a PL between the terminal and the second base station.

20. The first base station of claim 16, wherein at least one processor is further configured to:
transmit, to the terminal, configuration information on the PL offset by a high layer signaling.
